(19) United States
(12) Patent Application Publication
(10) Pub. No.: US 2024/0057641 A1
(43) Pub. Date: Feb. 22, 2024

(54) Beverages Comprising Salts with Improved Taste

(71) Applicant: The Coca-Cola Company, Atlanta, GA (US)

(72) Inventors: Juvenal Higiro, Atlanta, GA (US); Indra Prakash, Alpharetta, GA (US); Yu Shi, Marietta, GA (US); Ben C. Williams, Alpharetta, GA (US); Linh Hoang, Atlanta, GA (US); Nina Jung, Atlanta, GA (US); Rashmi Tiwari, Atlanta, GA (US)

(21) Appl. No.: 18/474,901

(22) Filed: Sep. 26, 2023

Related U.S. Application Data
(63) Continuation of application No. PCT/US2022/027639, filed on May 4, 2022.
(60) Provisional application No. 63/183,730, filed on May 4, 2021.
(60) Provisional application No. 63/295,081, filed on Dec. 30, 2021.

(51) Int. Cl. A23L 2/56; A23L 2/54; A23L 2/60

(52) U.S. Cl. CPC A23L 2/56; A23L 2/54; A23L 2/60

(57) ABSTRACT

Diet beverages containing at least one sweetener and certain magnesium and/or calcium salts, particularly magnesium and/or calcium C2-C9 organic acid salts, and optionally one or more taste modifying substances are provided. Use of the salts and optional taste modifying substances improves one or more taste attributes of the beverage, thereby improving the flavor profile.

### CROSS REFERENCE TO RELATED APPLICATIONS

This application is a continuation of and claims priority to PCT Application No. PCT/US2022/027639, filed May 4, 2022, which claims priority to U.S. Provisional Patent Application No. 63/183,730 filed May 4, 2021 and U.S. Provisional Patent Application No. 63/295,081, filed Dec. 30, 2021. The contents of all of the foregoing applications are incorporated by reference herein.

### FIELD OF THE INVENTION

The present invention relates generally to beverages containing at least one sweetener and certain magnesium and/or calcium salts, optionally including one or more additional taste modifying substances. The present invention further extends to methods of improving the taste and flavor profile of beverages and methods of preparing beverages.

### BACKGROUND OF THE INVENTION

Natural caloric sugars, such as sucrose, fructose and glucose, are used to provide a pleasant taste to beverages. Sucrose imparts a taste preferred by consumers. Although sucrose provides superior sweetness characteristics, it is disadvantageously caloric.

Consumers increasingly prefer non-caloric or low caloric sweeteners have been introduced to satisfy consumer demand. However, non- and low-caloric sweeteners differ from natural caloric sugars in ways that frustrate consumers. On a taste basis, high potency sweeteners exhibit temporal profiles, maximal responses, flavor profiles, mouth feels, and/or adaptation behavior that differs from sugar. High potency sweeteners often exhibit delayed sweetness onset, lingering sweet aftertaste, bitter taste, metallic taste, astringent taste, cooling taste and/or licorice-like taste. Beverages sweetened with high potency sweeteners are often described as watery and exhibit less mouthfeel than sucrose-sweetened beverages.

U.S. Pat. No. 9,011,956 describes use of certain sweet taste improving additives to improve the taste of natural high potency sweeteners. The '056 patent describes that the sweet taste improving additives, including certain inorganic salts, provide more sugar-like tastes or characteristics to beverages sweetened with natural high potency sweeteners.

U.S. Pat. No. 10,602,758 describes sweetener compositions comprising a taste modulator component comprising various combinations of Na⁺, K⁺, Ca²⁺, and Mg²⁺ salts, primarily chloride salts. The '758 patent describes that Mg²⁺ and Ca²⁺ from MgCl₂ and CaCl₂ did not significantly affect the appearance time, sweetness linger, body/mouthfeel and sweetness desensitization of rebaudioside A in citric acid buffer when used individually at concentrations less than 12 mM, while higher levels (e.g., 20-100 mM) were found to exhibit a undesired salty flavor. Additionally, it has been found that use of MgCl₂ and CaCl₂ leads to corrosion of the conventional cans used to contain diet carbonated beverages.

WO 01/70049 describes that certain types of divalent and trivalent cation salts enhance the stability of neotame and aspartame in edible compositions, including cola-type soft drinks and syrups, in particular Mg²⁺ and Ca²⁺ phosphates, phosphites, sulphites, sulphates, hydroxides, chlorides.

There remains a need for diet beverages that utilize salts to modify the flavor and temporal profile that do not cause corrosion of the can. Consumer desire remains high for non-caloric or low-caloric beverages that taste like sucrose-sweetened beverages.

### SUMMARY OF THE INVENTION

In one aspect, the present invention provides a diet beverage comprising at least one non-sucrose sweetener and at least one salt having a cation selected from Ca²⁺ and/or Mg²⁺ and an anion selected from lactate, citrate, gluconate, lactate gluconate, anhydrous and hydrate forms thereof, and combinations thereof.

It has been found that the anion identity of Ca²⁺ and/or Mg²⁺-containing salts, their relative amounts, and the total concentration needed to obtain the most sucrose-like temporal and flavor profile depends on the particular type of beverage, e.g., beverage matrix and/or sweeteners used.

The at least one non sucrose sweetener can be any sweetener, preferably a high potency sweetener. Particularly desirable high potency sweeteners include steviol glycosides (e.g., rebaudiosides A, D, M, B, AM and N), mogrosides (mogroside V, Siamenoside, mogroside IV, mogroside Ille), protein sweeteners and variants thereof (thaumatin, brazzein, Amai protein, sweet truffle protein), sucralose, potassium acesulfame, aspartame, neotame, advantame, cylamate and saccharin. In embodiments where the beverage is a reduced-calorie beverage, sugar (sucrose) can also be used as a sweetener in combination with one or more high potency sweeteners.

In some embodiments, a single salt having a cation selected from Ca²⁺ and Mg²⁺ and an anion selected from lactate, citrate, gluconate, lactate gluconate, anhydrous and hydrate forms thereof provides a beverage with more sucrose-sweetened characteristics than the beverage in the absence of the salt. In other embodiments, two or more salts are needed to achieve a beverage with more sucrose-sweetened characteristics. In embodiments with two salts, the weight ratio of the Mg²⁺ cation-containing salt to the Ca²⁺ cation-containing salt can vary from about 5:1 to about 1:1.

The concentration of the at least one salt described herein can vary from about 100 ppm to about 1,000 ppm, or from about 0.1 mM to about 5 mM.

The beverages of the present invention can be any type of beverage, but are preferably carbonated soft drinks, e.g., lemon lime or orange flavored carbonated soft drinks.

In another aspect, the present invention provides a beverage comprising (a) a sweetening amount of at least one sweetener and (b) a taste modifying composition comprising at least one C2-C9 organic acid salt comprising at least one cation and at least one anion, wherein the cation is selected from Ca²⁺ and Mg²⁺, and the anion is an anion of the C2-C9 organic acid.

In certain embodiments, the C2-C9 organic acid is a monocarboxylic acid, preferably an alpha hydroxy acid.

In a particular embodiment, the anion is of Formula I:

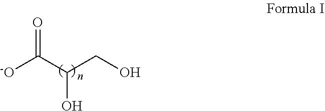

wherein n=1-7.

Exemplary anions of Formula I include gluconate; 2,3-dihydroxy propionate; and 2,3-dihydroxy butanoate.

In another embodiment, the anion is of Formula II:

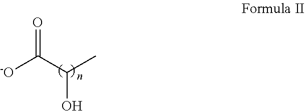

wherein n=0-7 and R═OH or H.

Exemplary anions of Formula II include lactate, acetate, propionate, butyrate, isobutyrate, valerate, isovalerate, and 2-methylbutanoate.

In another embodiment, the anion of Formula III:

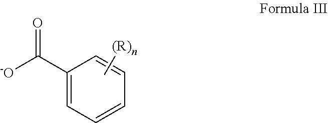

wherein R═OH, CH₃ or NH₂ and n=1-5.

Exemplary anions of Formula III include carboxylate anions of 2-hydroxybenzoic acid, 3-hydroxybenzoic acid, 4-hydroxybenzoic acid, 2,3-dihydroxybenzoic acid, 2,4-dihydroxybenzoic acid, 3,4-dihydroxybenzoic acid, 3,5-dihydroxybenzoic acid, 2,6-dihydroxybenzoic acid, 2,3,4-trihydroxybenzoic acid, 2,3,5-trihydroxybenzoic acid, 2,4,5-trihydrozybenzoic acid, 2,3,6-trihydroxybenzoic acid, 2,4,6-trihydroxybenzoic acid, 4-methoxysalicylic acid, 4-amino benzoic acid, and 3-amino benzoic acid.

In other embodiments, the C2-C9 organic acid is a dicarboxylic acid, preferably an alpha hydroxy acid. In one embodiment, the anion is of Formula IV:

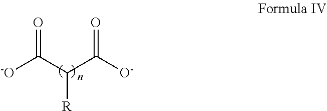

wherein n=1-7 and R═H or OH.

Exemplary anions of Formula IV include maleate, tartrate, tartronate, succinate, glutarate, adipate and malonate.

In another embodiment, the anion is of Formula V:

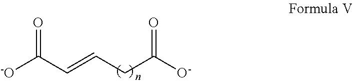

wherein n=0-5.

Exemplary anions of Formula V include fumarate and maleate.

In another embodiment, the C2-C9 organic acid salt is a tricarboxylic acid. In one embodiment, the anion is of Formula VI:

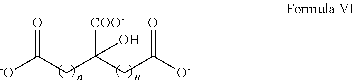

wherein n=0-6.

Exemplary anions of Formula VI is citrate and isocitrate.

The taste modifying composition can comprise a single C2-C9 organic acid salt, or two or more C2-C9 organic acid salts. In each C2-C9 organic acid salt, the anions can be the same or different.

The at least one C2-C9 organic acid salt is present in the beverage in a concentration from about 0.1 mM to about 5 mM, preferably from about 0.1 mM to about 3 mM, from about 0.1 mM to about 2 mM, or from 0.1 mM to about 1 mM.

The taste modifying composition can further comprise at least one amino acid, at least one dihydrochalcone, at least one medium chain fatty acid, and/or at least one FEMA GRAS compound selected from FEMA GRAS 4669, FEMA GRAS 4701 and FEMA GRAS 4965.

The at least one sweetener can be any sweetener, preferably high potency sweeteners, carbohydrate sweeteners (e.g., sucrose, HFCS, fructose, and glucose), rare sugar sweeteners (e.g., allulose, tagatose, and allose), sugar alcohols (e.g., erythritol, xylitol, and sorbitol), and combinations thereof.

Preferred sweeteners include rebaudioside M, rebaudioside A, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, allulose, erythritol and combinations thereof.

The at least one salt described herein modulates one or more taste attributes of the beverage to improve the flavor profile of the beverage. One of the advantages of the beverages described herein is that the Ca²⁺ and Mg²⁺ salts used cost less than a number of sweet taste improving additives (e.g., polyols such as erythritol) taught to modulate taste and flavor profiles of non-sucrose sweeteners. The taste modulator compositions described herein are superior modifiers to those described previously (e.g., U.S. Pat. No. 10,602,758), do not cause corrosion in cans, and impart stability to the sweetener.

Without wishing to be bound by theory, it is possible that the salts described herein aid in the perforation of the mucin layer, allowing rapid access of the sweetener to sweet taste receptors (leading to quick sweetness onset) and also rapid exit of the sweetener (leading to less sweetness linger). It is also known that Ca²⁺ and Mg²⁺ salts activate the calcium sensing receptor (CaSR) and may be involved in kokumi taste. A kokumi taste enhances one of the five basic tastes (sweet, salty, sour, bitter and umami), as well as enhancing marginal tastes (e.g., thickness, growth (mouth feel), continuity and harmony). It is possible that the Ca²⁺ and Mg²⁺ salts described herein activate the CaSR and provide kokumi taste. Ca²⁺ can also activate mechanoreceptors resulting in sugar like mouthfeel.

It appears that the identity of both the anion and the cation influences the modifying properties of the C2-C9 organic acid salt.

In some embodiments, the at least one C2-C9 organic acid salt improves the long-term stability a non-sucrose sweetener.

The beverage can be any beverage, e.g., carbonated, or non-carbonated. Reduced-calorie beverage and zero-calorie beverages are contemplated herein.

The beverages can further comprise citric acid and malic acid and/or tartaric acid as a replacement for citric acid, when present in the beverage matrix. In a particular embodiment, the weight ratio of the citric acid to malic and/or tartaric acid is from 4:1 to 3:2. In a more particular embodiment, the weight ratio of citric acid to malic acid is from 4:1 to 3:2. In another more particular embodiment, the weight ratio of citric acid to tartaric acid is from 4:1 to 3:2.

The beverages may further comprise at least one functional ingredient and/or additive.

In another aspect, the present invention provides a method of making a beverage taste more like a sucrose-sweetened beverage comprising (i) providing a beverage comprising at least one non-sucrose sweetener and (ii) adding at least one salt described herein to provide a beverage with one or more improved taste attributes compared to the beverage in the absence of the at least one salt described herein.

In another aspect, the present invention provides a method of improving the flavor profile of a beverage comprising (i) providing a beverage comprising at least one sweetener and (ii) adding a taste modifying composition comprising at least one C2-C9 organic acid salt described herein to provide a beverage with one or more improved taste attributes compared to the beverage in the absence of the taste modifying composition.

In another aspect, the present invention provides a method of preparing a beverage comprising (i) providing a beverage comprising at least one non-sucrose sweetener and (ii) at least one salt described herein to the beverage.

In another aspect, the present invention provides a method of preparing a beverage comprising (i) providing a beverage comprising at least one sweetener and (ii) adding a taste modifying composition comprising at least one C2-C9 organic acid salt to the beverage.

In another aspect, the present invention provides a method of improving the stability of a non-sucrose sweetener in a beverage comprising (i) providing a beverage comprising at least one non-sucrose sweetener described hereinabove and (ii) at least one C2-C9 organic acid salt described herein to the beverage.

### BRIEF DESCRIPTION OF THE DRAWINGS

FIG. 1 shows the sensory profiles of reb A-sweetened beverages of the prior art and beverages of the present invention (Example 1).

FIG. 2 shows the sensory profiles of reb M-sweetened beverages of the prior art and beverages of the present invention (Example 2).

FIG. 3 shows the sensory profile of various organic and inorganic salts in zero-calorie beverages sweetened with reb M (Example 3). Reb M control (black dash-dot), Na Gluconate 218.14 ppm (grey dash-dot), magnesium citrate 150.4 ppm (grey solid line), magnesium lactate 238.5 ppm (black solid line), magnesium chloride 203 ppm (grey dashes), calcium lactate+calcium gluconate 334 ppm (black long dashes), calcium chloride 141 ppm (grey dashes), calcium citrate 190 ppm (black dots), calcium lactate 308 ppm (short black dashes).

FIG. 4 shows the bitterness, bitter linger and saltiness of the same beverages as in FIG. 3. (Example 3).

FIG. 5 shows the sensory profile of zero-calorie beverages containing reb M and various concentrations of calcium lactate+calcium gluconate (Example 4).

FIG. 6 shows the sensory profile of mid-calorie beverages containing reb M and various concentrations of calcium lactate+calcium gluconate (Example 4).

FIG. 7 shows the impact of calcium lactate+calcium gluconate concentration in zero-calorie beverages with CAB-K matrices sweetened with rebaudioside M (Example 5).

FIG. 8 shows the sensory attributes of various C2-C9 organic acids salts in zero-calorie beverages sweetened with rebaudioside M in a CAB-K matrix (Example 6).

FIG. 9 shows the sensory attributes of beverages containing calcium C2-C9 organic acid salts with two different anions (lactate and gluconate) or three different anions (lactate, gluconate, and citrate) in zero-calorie CAB-K beverages sweetened with rebaudioside M (Example 7).

FIG. 10 shows the sensory attributes associated with citrate, lactate and gluconate salts of calcium in zero-calorie beverages with CAB-K matrix systems sweetened with rebaudioside M (Example 8) FIG. 11 shows the sensory attributes associated with lactate salts of calcium and magnesium in zero-calorie beverages with CAB-K matrix systems sweetened with rebaudioside M (Example 8).

FIG. 12 shows the sensory attributes of zero-calorie beverages with CAB-K matrix systems sweetened with rebaudioside M and containing calcium or magnesium citrate (Example 9).

FIG. 13 shows the sensory attributes of zero-calorie beverages with CAB-K matrix systems sweetened with rebaudioside M and containing calcium or magnesium chloride (Example 9).

FIG. 14 shows the sensory attributes of zero-calorie beverages with CAB-K matrix systems sweetened with rebaudioside M and containing calcium or magnesium lactate (Example 9).

FIG. 15 shows the sensory attributes of zero-calorie beverages with CAB-K matrix systems sweetened with rebaudioside M containing magnesium gluconate or calcium gluconate (Example 11).

FIG. 16 shows the sensory attributes of zero-calorie beverages with CAB-K matrix systems sweetened with rebaudioside M containing magnesium and calcium salts of citrate and lactate (Example 11).

FIG. 17 show the sensory profiles of gluconate and chloride salts of sodium in zero-calorie beverages with CAB-K buffer systems sweetened with rebaudioside M (Example 12).

FIG. 18 shows the sensory profiles of gluconate and chloride salts of potassium in zero-calorie beverages with CAB-K buffer systems sweetened with rebaudioside M (Example 12).

FIG. 19 shows the sensory profiles of gluconate and chloride salts of magnesium in zero-calorie beverages with CAB-K buffer systems sweetened with rebaudioside M (Example 12).

FIG. 20 shows the sensory profile of gluconate and chloride salts of calcium in zero-calorie beverages with CAB-K buffer systems sweetened with rebaudioside M (Example 12).

FIG. 21 shows the saltiness of gluconate and chloride salts of sodium, potassium, magnesium and calcium (Example 12).

FIG. 22 show the bitterness of gluconate and chloride salts of sodium, potassium, magnesium and calcium (Example 12).

FIG. 23 shows the sensory profile of chloride, citrate, lactate, and lactate+gluconate salts of calcium in zero-calorie beverages with CAB-K matrix systems sweetened with rebaudioside M (Example 13).

FIG. 24 shows the sensory attributes of various organic salts of calcium in zero-calorie beverages with CAB-K matrix systems sweetened with rebaudioside M (Example 14).

FIG. 25 shows the effect of tripotassium citrate in CAB-K buffer systems (Example 15).

FIG. 26 shows the effect of various salts on pH of beverages with CAB-K matrix systems sweetened with rebaudioside M (Example 16).

FIG. 27 shows sensory attributes of reduced calorie beverages containing organic salts, erythritol, allulose and tagatose (Example 17).

FIG. 28 shows the overall ranking of reduced-calorie beverages containing naringin dihydrochalone (NDC) and calcium lactate+calcium gluconate (Example 18).

FIG. 29 shows the overall ranking of zero-calorie, orange-flavored carbonated beverages sweetened with a mixture of Reb M80 and RA95, calcium lactate+calcium gluconate and phloretin (Example 19).

### DETAILED DESCRIPTION OF THE INVENTION

### I. Definitions

“C2-C9 organic acid salt,” as used herein, refers to the carboxylate salt of an acid having two to nine carbon atoms, hydrogen and oxygen.

“Beverage”, as used herein, refers to liquids suitable for human consumption.

“Diet beverage,” as used herein, refers to a beverage having from 0 to 60 calories per 8 oz. serving. Diet beverages include mid-calorie beverages, low-calorie beverages and zero-calorie beverages.

“Reduced-calorie beverage,” as used herein, refers to a beverage comprising a mixture of caloric sweeteners (e.g., sucrose) and one or more non-sucrose potency sweeteners. Reduced-calorie beverages include mid-calorie beverages and low-calorie beverages.

“Full-calorie beverage,” as used herein, refers to a beverage that has from 61 calories to about 120 calories per 8 oz serving. Full-calorie beverages are typically sweetened with caloric sweeteners, e.g., sucrose or fructose.

“Mid-calorie beverage,” as used herein, refers to a beverage that has from 41 to 60 calories per 8 oz. serving.

“Low-calorie beverage,” as used herein, refers to a beverage that has from 6 to 40 calories per 8 oz. serving.

“Zero-calorie beverage,” as used herein, refers to a beverage that has less than 5 calories per 8 oz. serving.

“Natural high potency sweetener” or “NHPS” as used herein, refers to any sweetener found naturally in nature and characteristically has a sweetness potency greater than sucrose, fructose, or glucose, yet has less calories. The natural high potency sweetener can be provided as a pure compound or, alternatively, as part of an extract.

“No salty taste”, as used herein, refers to an inability to detect salty flavor in a beverage. Methods of determining whether a beverage tastes salty are known in the art, e.g., J. Giguere, et al., “Abstract 18991: Salt Taste Detection and Recognition Thresholds—Reliability of a Rapid Sensory Analysis Method”, Circulation, Nov. 25, 2014, Vol 130, Issue suppl 2. The temporal stability of a rapid sensory analysis based on the 3-alternative forced-choice (3-AFC) method (ASTM E679) was tested with 30 adult volunteers. Detection Threshold (DT) and Recognition Threshold (RT) for salt were determined using a series of ascending concentrations.

“Synthetic high potency sweetener,” as used herein, refers to any composition which is not found naturally in nature and characteristically has a sweetness potency greater than sucrose, fructose, or glucose, yet has less calories.

“Total mogroside content”, as used herein, refers to the sum of the relative weight contributions of each mogroside in a sample.

“Total steviol glycoside content”, as used herein, refers to the sum of the relative weight contributions of each steviol glycoside in a sample.

### II. Beverages

In one aspect, the present invention provides diet beverages comprising at least one non-sucrose sweetener and at least one salt having a cation selected from Ca²⁺ and Mg²⁺ and certain anions in certain amounts.

In another aspect, the present invention provides beverages comprising at least one sweetener and a taste modifying composition comprising at least one C2-C9 organic acid salt, wherein the C2-C9 organic acid salt consists of one cation selected from Ca²⁺ and Mg²⁺, and at least one anion of the C2-C9 organic acid. An anion of the present invention is a carboxylate anion of the C2-C9 organic acid.

Diet beverages contain at least one non-sucrose sweetener, and therefore have less calories than typical, full-calorie, sucrose only sweetened beverages. In such beverages, non-sucrose sweeteners (e.g., high potency sweeteners) are present in a sweetening amount such that they lower the amount of sucrose required to achieve a desired level of sweetness, but often elicit non-sucrose sweetened characteristics, e.g., sweetness linger, bitterness, bitter aftertaste, metallic tastes, astringency, licorice taste, and poor mouthfeel. The salts and taste modulator compositions described have been found to significantly improve the objectionable taste attributes of the non-sucrose sweetener and provide an overall more sucrose-like sweetened sensory profile. Exemplary taste attribute modulations include decreasing or eliminating bitterness, decreasing or eliminating bitter linger, decreasing or eliminating sourness, decreasing or eliminating astringency, decreasing or eliminating saltiness, decreasing or eliminating metallic notes, improving mouthfeel, decreasing or eliminating sweetness linger, increasing sweetness onset and increasing sweetness intensity. Multiple taste attributes can be modulated simultaneously, such that the salt-containing beverage, overall, has more sucrose-sweetened characteristics compared to a corresponding beverage without the salt(s). Methods of quantifying improvement in sucrose-sweetened characteristics are known in the art and include taste testing and histogram mapping with isosweet sucrose-sweetened beverage controls.

The taste modulator compositions described herein contain C2-C9 organic acid salts that are superior modifiers to those described previously (e.g., U.S. Pat. No. 10,602,758) and, beneficially, do not cause corrosion in cans. Additionally, the C2-C9 organic acid salts of the present invention provide improved long-term stability of the non-sucrose sweetener.

A. Sweetener

The sweetener is present in the beverages described herein in a sweetening amount. Non-sucrose sweeteners include high potency sweeteners, rare sugars, carbohydrates, and sugar alcohols.

The high potency sweetener can be any known high potency sweetener, including natural and synthetic high potency sweeteners.

Non-limiting examples of natural high potency sweeteners include stevia sweetener and steviol glycoside sweeteners, such as rebaudioside M, rebaudioside D, rebaudioside A, rebaudioside AM, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides, and combinations thereof.

Steviol glycoside sweeteners can be provided in pure form or as part of a mixture. The steviol glycoside mixture sweetener typically has a total steviol glycoside content of about 95% by weight or greater on a dry basis. The remaining 5% comprises other non-steviol glycoside compounds, e.g. by-products from extraction or purification processes. In some embodiments, the steviol glycoside blend sweetener has a total steviol glycoside content of about 96% or greater, about 97% or greater, about 98% or greater or about 99% or greater.

In certain embodiments, a steviol glycoside mixture comprises at least about 5% of a particular steviol glycoside by weight on a dry basis, such as, for example, at least about 10%, at least about 20%, at least about 30%, at least about 40%, at least about 50%, at least about 60%, at least about 70%, at least about 80%, at least about 90%, at least about 95% or at least about 97%.

The steviol glycoside mixture may comprise at least about 50% rebaudioside A by weight on a dry basis, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The steviol glycoside mixture may comprise from 70% to about 99% rebaudioside A by weight on a dry basis, such as, for example, from about 70% to about 95%, from about 70% to about 90%, from about 80% to about 99%, from about 80% to about 95%, from about 80% to about 90%, from about 90% to about 99% or from about 90% to about 95% by weight.

The steviol glycoside mixture may comprise at least about 50% rebaudioside M by weight on a dry basis, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The steviol glycoside mixture may comprise from about 70% to about 99% rebaudioside M by weight on a dry basis, such as, for example, from about 70% to about 95%, from about 70% to about 90%, from about 80% to about 99%, from about 80% to about 95%, from about 80% to about 90%, from about 90% to about 99% or from about 90% to about 95% by weight.

The steviol glycoside mixture may comprise at least about 50% rebaudioside D by weight on a dry basis, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The steviol glycoside mixture may comprise from about 70% to about 99% rebaudioside D by weight on a dry basis, such as, for example, from about 70% to about 95%, from about 70% to about 90%, from about 80% to about 99%, from about 80% to about 95%, from about 80% to about 90%, from about 90% to about 99% or from about 90% to about 95%.

The steviol glycoside mixture may comprise at least about 50% rebaudioside AM by weight on a dry basis, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The steviol glycoside mixture may comprise from about 70% to about 99% rebaudioside AM by weight on a dry basis, such as, for example, from about 70% to about 95%, from about 70% to about 90%, from about 80% to about 99%, from about 80% to about 95%, from about 80% to about 90%, from about 90% to about 99% or from about 90% to about 95%.

In other embodiments, the steviol glycoside mixture is A95, a specific blend of rebaudiosides D, M, A, N, O and, optionally, E, described in WO 2017/059414. A95 comprises rebaudiosides D, M, A, N, O and, optionally, E, wherein the total steviol glycoside content is about 95% or greater by weight, wherein rebaudioside D accounts for from about 55% to about 70% of the total steviol glycoside content by weight, rebaudioside M accounts for from about 18% to about 30% total steviol glycoside content by weight, rebaudioside A accounts for from about 0.5% to about 4% of the steviol glycoside content by weight, rebaudioside N accounts for from about 0.5% to about 5% of the steviol glycoside content by weight, rebaudioside O accounts for from about 0.5% to about 5% of the total steviol glycoside content by weight and, optionally, rebaudioside E accounts for from about 0.2% to about 2% total steviol glycoside content by weight.

The concentration of the steviol glycoside sweetener in the beverage can vary from about 25 ppm to about 600 ppm, such as, for example, from about 25 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm, or from about 500 ppm to about 600 ppm.

It should be noted that “sweetening amount” of rebaudioside M (when used as the sole non-sucrose sweetener) in a reduced-calorie beverage is preferably from about 100 ppm to about 300 ppm, such as, for example, from about 100 ppm to about 200 ppm, from about 100 ppm to about 150 ppm, from about 150 ppm to about 300 ppm, from about 150 ppm to about 200 ppm, or from about 200 ppm to about 300 ppm.

A “sweetening amount” of rebaudioside M in a zero-calorie beverage (when used as the sole non-sucrose sweetener) is preferably from about 400 to about 600 ppm.

Exemplary natural high potency sweeteners also includes Luo Han Guo and the related mogroside compounds, such as grosmogroside I, mogroside IA, mogroside IE, 11-oxomogroside IA, mogroside II, mogroside II A, mogroside II B, mogroside II E, 7-oxomogroside II E, mogroside III, Mogroside IIIe, 11-oxomogroside IIIE, 11-deoxymogroside III, mogroside IV, Mogroside IVA, 11-oxomogroside IV, 11-oxomogroside IVA, mogroside V, isomogroside V, 11-deoxymogroside V, 7-oxomogroside V, 11-oxomogroside V, isomogroside V, mogroside VI, mogrol, 11-oxomogrol, siamenoside I, isomers of siamenoside I (e.g. those disclosed in 20170119032; incorporated by reference in its entirety), 11-oxo-siamenoside I, 11-oxo-isomers of siamenoside I, (3β,9β,10α,11α,24R)-3-[(4-O-β-D-glucospyranosyl-6-O-β-D-glucopyranosyl]-25-hydroxyl-9-methyl-19-norlanost-5-en-24-yl-[2-O-β-D-glucopyranosyl-6-O-β-D-glucopyranosyl]-β-D-glucopyranoside); (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-3-D-glucopyranosyl-6-O-β-D-glucopyranosyl]-β-D-glucopyranoside); and (3β, 9β, 10α, 11α, 24R)-[(2-O-3-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside).

Mogroside sweeteners can be provided in pure form or as part of a mixture. In certain embodiments, a mogroside mixture comprises at least about 5% of a particular mogroside by weight on a dry basis, such as, for example, at least about 10%, at least about 20%, at least about 30%, at least about 40%, at least about 50%, at least about 60%, at least about 70%, at least about 80%, at least about 90%, at least about 95% or at least about 97%.

The mogroside mixture may comprise at least about 50% siamenoside I by weight on a dry basis, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The mogroside mixture may comprise at least about 50% mogroside V by weight on a dry basis, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The concentration of the mogroside sweetener or mogroside mixture sweetener can vary from about 25 ppm to about 600 ppm, such as, for example, from about 25 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm or from about 500 ppm to about 600 ppm.

Other exemplary natural high potency sweeteners include Amai proteins, monatin and its salts (monatin SS, RR, RS, SR), curculin, glycyrrhizic acid and its salts, thaumatin (and variants thereof, e.g., thaumatin I and thaumatin 1l), monellin (and variants thereof), miraculin, mabinlin, brazzein (and variants thereof), sweet truffle protein (and variants thereof), hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

Sweet truffle protein refers to the sweet proteins recently identified from fungal proteins, e.g., M. terfezoides gleba, also called “Myd polypeptides” according to US Patent Application No. 2021/0401013, incorporated herein by reference.

Non-limiting examples of synthetic high potency sweeteners include sucralose, potassium acesulfame, aspartame, alitame, saccharin, neohesperidin dihydrochalcone synthetic derivatives, cyclamate, neotame, dulcin, suosan, cyclamate, saccharin, advantame, and salts thereof.

The concentration of the high potency sweetener can vary from about 1 ppm to about 900 ppm, such as, for example, from about 1 ppm to about 800 ppm, from about 1 ppm to about 700 ppm, from about 1 ppm to about 600 ppm, from about 1 ppm to about 500 ppm, from about 1 ppm to about 400 ppm, about 1 ppm to about 300 ppm, from about 1 ppm to about 200 ppm, from about 1 ppm to about 100 ppm, from about 1 ppm to about 50 ppm, from about 1 ppm to about 25 ppm, from about 1 ppm to about 15 ppm or about 1 ppm to about 10 ppm.

Exemplary rare sugar sweeteners include, but are not limited to, allulose (D-psicose), L-ribose, D-tagatose, L-glucose, L-fucose, L-arabinose, D-turanose, D-leubiose (D-leucose), and combinations thereof.

The amount of rare sugar sweetener in the beverage depends on the identity of the rare sugar and the permitted regulatory limit. In one embodiment, a beverage comprises a rare sugar in an amount from about 0.1 wt % to 12 wt %, from about 0.1 wt % to about 5 wt %, from about 0.1 wt % to about 2.5 wt %, about 0.1 wt % to about 2 wt %, or about 0.1 wt % to about 1 wt %.

Suitable carbohydrate sweeteners include, but are not limited to, sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose, high fructose corn syrup and combinations thereof.

It has been found that inclusion of tagatose further improves the taste attributes, particularly decreasing bitterness and improving sugar-like taste, compared to a corresponding beverage with just the C2-C9 organic acid salt.

The amount of the carbohydrate sweetener in the beverage can vary from about 1 wt % to about 10 wt %, such as, for example, from about 4 wt % to about 10 wt %, about 5 wt % to about 10 wt %, about 6 wt % to about 10 wt %, about 7 wt % to about 10 wt %, about 8 wt % to about 10 wt % or about 9 wt % to about 10 wt %. In certain embodiments, the carbohydrate sweetener is present in an amount from about 1 wt % to about 3 wt %.

Other suitable sweeteners include allulose, allose, sucrose, fructose, glucose, propylene glycol, glycerol, erythritol, arabinitol, maltitol, lactitol, sorbitol, mannitol, xylitol, tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose isomaltulose, erythrose, deoxyribose, gulose, idose, talose, erythrulose, xylulose, allulose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dihydroxyacetone), aldotriose (glyceraldehyde), nigero-oligosaccharides, fructooligosaccharides (kestose, nystose and the like), maltotetraose, inaltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffmose, rhamnose, ribose, isomerized, liquid sugars such as high fructose corn/starch syrup (“HFCS/HFSS,” e.g., HFCS55, HFCS42, or HFCS90), coupling sugars, soybean oligosaccharides, glucose syrup and combinations thereof. It is understood that D- or L-configurations can be used when applicable.

Exemplary sugar alcohol sweeteners include, but are not limited to, sorbitol, mannitol, lactitol, maltitol, xylitol, erythritol and combinations thereof.

The at least one sugar alcohol can be present in an amount from about 0.1 wt % to about 3.5 wt %, such as, for example, from about 0.5 wt % to about 3.5 wt %, from about 0.5 wt % to about 3.0 wt %, from about 0.5 wt % to about 2.5 wt %, from about 0.5 wt % to about 2.0 wt %, from about 0.5 wt % to about 1.5 wt %, from about 0.5 wt % to about 1.0 wt %, from about 1.0 wt % to about 3.5 wt %, from about 1.0 wt % to about 3.0 wt %, from about 1.0 wt % to about 2.5 wt %, from about 1.0 wt % to about 2.0 wt %, from about 1.0 wt % to about 1.5 wt %, from about 1.5 wt % to about 3.5 wt %, from about 1.5 wt % to about 3.0 wt %, from about 1.5 wt % to about 2.5 wt %, from about 1.5 wt % to about 2.0 wt %, from about 2.0 wt % to about 3.5 wt %, from about 2.0 wt % to about 3.0 wt %, from about 2.0 wt % to about 2.5 wt %, from about 2.5 wt % to about 3.5 wt %, from about 2.5 wt % to about 3.0 wt % or from about 3.0 wt % to about 3.5 wt %.

In certain embodiments, the at least one non-sucrose sweetener comprises a mixture of two or more types of sweeteners discussed herein above. Particularly preferable combinations include:
(a) rebaudioside M, rebaudioside D, and optionally tagatose, allulose and/or erythritol;
(b) rebaudioside M, rebaudioside A, and optionally tagatose, allulose and/or erythritol;
(c) rebaudioside M, mogroside V, and optionally tagatose, allulose and/or erythritol;
(d) rebaudioside M, siamenoside 1, and optionally tagatose, allulose and/or erythritol;
(e) rebaudioside M, tagatose, and optionally allulose and/or erythritol;
(f) acesulfame K, sucralose, and optionally tagatose, allulose and/or erythritol;
(g) acesulfame K, aspartame, and optionally tagatose, allulose and/or erythritol;
(h) aspartame, acesulfame K, erythritol, and optionally tagatose, allulose and/or erythritol;
(i) sucralose, acesulfame K, erythritol, and optionally allulose and/or erythritol;
(j) acesulfame K, sucralose, cyclamate, and optionally tagatose, allulose and/or erythritol;
(k) acefulfame K, sucralose, saccharin, and optionally tagatose, allulose and/or erythritol;
(l) aspartame, cyclamate, and optionally tagatose, allulose and/or erythritol;
(m) aspartame, saccharin, and optionally tagatose, allulose and/or erythritol;
(n) acesulfame K, neotame, and optionally tagatose, allulose and/or erythritol;
(o) acesulfame K, neotame, advantame, and optionally tagatose, allulose and/or erythritol;
(p) sucralose, cyclamate, and optionally tagatose, allulose and/or erythritol;
(q) sucralose, saccharin, and optionally tagatose, allulose and/or erythritol; and
(r) sucralose, neotame, advantame, and optionally tagatose, allulose and/or erythritol.

B. Taste Modifying Composition

a. Salts

The beverages of the present invention comprise at least one salt having cations selected from Ca²⁺ and/or Mg²⁺.

In one aspect, the anion component of each salt can be selected from gluconate (C₆H₁₁O₇⁻¹), citrate (C₆H₅O₇⁻³), hydrogen citrate (C₆H₆O₇⁻²), dihydrogen citrate (C₆H₇O₇⁻¹), malate (C₄H₆O₅⁻²), hydrogen malate (C₄H₇O₅⁻¹), maleate (C₄H₂O₄⁻²), hydrogen maleate (C₄H₃O₄⁻¹), fumarate (C₄H₂O₄⁻²), hydrogen fumarate (C₄H₃O₄⁻¹), succinate (C₄H₄O₄⁻²), hydrogen succinate (C₄H₅O₄⁻¹), glutarate (C₅H₆O₄⁻²), hydrogen glutarate (C₅H₇O₄⁻¹), adipate C₆H₈O₄⁻²), hydrogen adipate C₆H₉O₄⁻¹), lactate (C₃H₅O₃⁻¹), tartrate (C₄H₄O₆⁻²), bitartrate (C₄H₅O₆⁻¹), phosphate (PO₄⁻³), monohydrogen phosphate (HPO₄⁻²), dihydrogen phosphate (H₂PO₄⁻), fluoride (F⁻), sulfate (SO₄⁻²), bisulfate (HSO₄⁻¹), nitrate (NO₃⁻), carbonate (CO₃⁻²), bicarbonate (HCO₃⁻), glycerate (C₃H₅O₄⁻¹), glycolate (C₂H₃O₃⁻¹), or combinations thereof.

In particular embodiments, the at least one salt is selected from magnesium lactate, magnesium citrate, calcium citrate, calcium lactate, calcium gluconate, and calcium lactate gluconate.

In more particular embodiments, the at least one salt is selected from magnesium lactate dihydrate, trimagnesium dicitrate anhydrous, tricalcium dicitrate tetrahydrate, calcium lactate pentahydrate, calcium gluconate monohydrate, dicalcium lactate gluconate monohydrate and combinations thereof.

In embodiments where the at least one salt comprises a Mg²⁺ cation-containing salt and a Ca²⁺ cation-containing salt, the weight ratio of the Mg²⁺ cation-containing salt to the Ca²⁺ cation-containing salt can be from about 5:1 to about 1:1, such as, for example, from about 4:1 to about 1:1, from about 3:1 to about 1:1 or from about 2:1 to about 1:1. In a particular embodiment the weight ratio is from about 3:1 to about 1:1.

In preferred embodiments, the present beverages do not use chloride salts (Cl⁻) of Ca²⁺ and Mg²⁺, i.e., the salts are not MgCl₂ and/or CaCl₂.

The concentration of the at least one salt in the beverage can vary. An exemplary concentration range is from about 100 ppm to about 1,000 ppm, such as, for example, from about 100 ppm to about 900 ppm, from about 100 ppm to about 800 ppm, from about 100 ppm to about 700 ppm, from about 100 ppm to about 600 ppm, from about 100 ppm to about 500 ppm, from about 100 ppm to about 400 ppm, from about 100 ppm to about 300 ppm, and from about 100 ppm to about 200 ppm.

The concentration of the at least one salt can also be described in millimolar (mM). The at least one salt described herein is preferably present in an amount from about 0.1 mM to about 5 mM, from about 0.1 mM to about 4 mM or from about 0.1 mM to about 3 mM. These ranges can also apply to individual salts described herein.

In some embodiments, the beverage does not comprise potassium salts or sodium salts of the anions identified above. In some embodiments, the beverage does not comprise KCl and/or NaCl.

b. Organic Acid Salt

In one aspect, beverages of the present invention comprise a taste modifying composition comprising at least one Ca²⁺ and/or Mg²⁺ C2-C9 organic acid salt. It has been found that certain Ca²⁺ and Mg²⁺ C2-C9 organic acid salts provide superior sensory properties compared to corresponding inorganic salts, e.g., chlorides. In particular, the organic C2-C9 organic acid salts provide less saltiness compared to the inorganic salts but an improvement in at least one of the following: sweetness intensity (increase), sweetness onset (increase), sweet temporal profile (increase), bitterness (decrease), bitter linger (decrease) sugar-like mouthfeel (increase), body (increase), overall rounded sucrose-like taste and overall flavor profile (increases). Additionally, the at least one C2-C9 organic acid salt provides improved stability of the non-sucrose sweetener over time.

The C2-C9 organic acid salt contains a cation selected from Ca²⁺ and Mg²⁺. It has been found that Ca²⁺ and Mg²⁺ salts of a given C2-C9 organic acid provide less saltiness, licorice, bitter and bitter linger compared to corresponding Na⁺ salts. In preferred embodiments, the beverages of the present invention do not contain Na⁺ salts of C2-C9 organic acids. It has also been found that, at least in certain embodiments, Ca²⁺ salts are preferred to Mg²⁺ salts as the latter results in more bitterness and saltiness. Each C2-C9 organic acid salt can contain more than one Ca²⁺ or Mg²⁺, e.g., tri-calcium dicitrate tetrahydrate.

The C2-C9 organic acid salt also contains at least one anion. As would be understood by a person of skill in the art, both Ca²⁺ and Mg²⁺ are divalent and therefore require a −2 charge to balance the charge of the salt. This can be accomplished using one −2 charged anion or two −1 charged anions.

As would be understood by a skilled person, common salt names are used herein. These common names are meant to include the scientific naming which provides proper valency for the salt. For example, a person of skill in the art will understand that “calcium citrate” refers to tricalcium dicitrate, “calcium lactate” refers to monocalcium dilactate, “calcium gluconate” refers to monocalcium digluconate”, etc. The salts can be used in their anhydrate or hydrate forms.

In some embodiments, the C2-C9 organic acid is a monocarboxylic acid. In certain embodiments, the C2-C9 organic acid is an alpha hydroxy monocarboxylic acid. In one such embodiment, the anion has a structure according to Formula I:

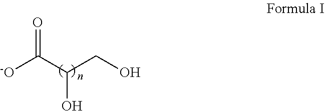

wherein n is 1-7.

In a particular embodiment, the anion is gluconate; 2,3-dihydroxy propionate; or 2,3-dihydroxy butanoate.

In another embodiment, the anion has a structure according to Formula II:

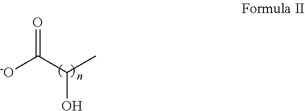

wherein n is 0-7 and R is OH or H.

In a particular embodiment, n is 1 and the anion is lactate. In other particular embodiments, n is 0-5. When n is 0, the anion is a short-chain fatty acid anion. Exemplary anions include acetate, propionate, butyrate, isobutyrate, valerate, isovalerate, and 2-methylbutanoate.

In another embodiment, the anion is a hydroxybenzoate of Formula III:

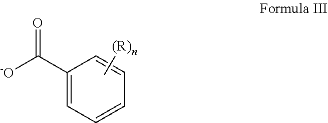

wherein R is OH, CH₃ or NH₂ and n is 1-5.

Exemplary anions include carboxylate anions of 2-hydroxybenzoic acid, 3-hydroxybenzoic acid, 4-hydroxybenzoic acid, 2,3-dihydroxybenzoic acid, 2,4-dihydroxybenzoic acid, 3,4-dihydroxybenzoic acid, 3,5-dihydroxybenzoic acid, 2,6-dihydroxybenzoic acid, 2,3,4-trihydroxybenzoic acid, 2,3,5-trihydroxybenzoic acid, 2,4,5-trihydrozybenzoic acid, 2,3,6-trihydroxybenzoic acid, 2,4,6-trihydroxybenzoic acid, 4-methoxysalicylic acid, 4-amino benzoic acid, and 3-amino benzoic acid.

In some embodiments, the C2-C9 organic acid is a dicarboxylic acid. In certain embodiments, the C2-C9 organic acid is an alpha hydroxy dicarboxylic acid. In one such embodiment, the anion has a structure according to Formula IV:

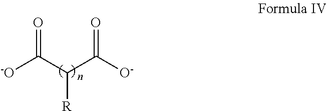

wherein n is 1-7 and R is H or OH.

Exemplary anions include maleate, tartrate, tartronate, succinate, glutarate, adipate and malonate.

In another embodiment, the anion is structure according to Formula V:

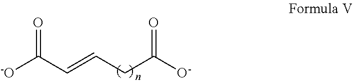

wherein n is 0-5. In a particular embodiment, the anion is selected from fumarate and maleate.

In some embodiments, the C2-C9 organic acid is a tricarboxylic acid. In one such embodiment, the anion has a structure according to Formula VI:

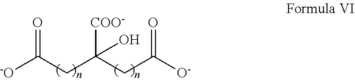

wherein n is 0-6.

In a particular embodiment, the anion is selected from citrate and isocitrate.

In one embodiment, the beverage comprises at least one non-sucrose sweetener and a taste modifying composition comprising two C2-C9 organic acid salts, each consisting of a cation selected from Ca²⁺ and Mg²⁺ and different anions. Such salts have improved sensory properties compared to a single cation/anion salt. In an exemplary embodiment, the two C2-C9 organic acid salts are calcium lactate and calcium gluconate, which is hypothesized to have the following interaction within the beverage:

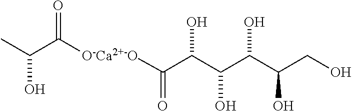

In other embodiments, the taste modifying composition comprises two C2-C9 organic acid salts, three C2-C9 organic acid salts, four C2-C9 organic acid salts, five C2-C9 organic acid salts, six C2-C9 organic acid salts, seven C2-C9 organic acid salts, eight C2-C9 organic acid salts, nine C2-C9 organic acid salts, or ten or more C2-C9 organic acid salts. In each of these embodiments, the cations can be the same (e.g., Ca²⁺ or Mg²⁺) or different (Ca²⁺ and Mg²⁺). Similarly, the anions of each of the salts can be the same (e.g. calcium citrate and magnesium citrate) or different (calcium citrate and calcium lactate). Therefore, by mixing and matching cations, anions and the number of salts, various combinations can be achieved.

In one embodiment, the beverage comprises at least one sweetener and a taste modifying composition comprising at least two C2-C9 organic acid salts, wherein the cation of each salt is selected from Ca²⁺ and Mg²⁺ and the anion of each salt is different. An example is calcium lactate and calcium gluconate. Such combinations of salts may have improved sensory properties compared to a single salt.

In one embodiment, the beverage comprises at least one sweetener and a taste modifying composition comprising at least three C2-C9 organic acid salts, wherein the cation of each salt is selected from Ca²⁺ and Mg²⁺ and the anions of each salt are different. Such combinations of salts have improved sensory properties compared to a single salt. In one such embodiment, the cation of each salt is the same. For example, three C2-C9 organic acid salts comprise calcium citrate, calcium lactate and calcium gluconate. In another exemplary embodiment, three C2-C9 organic acid salts comprise magnesium citrate, magnesium lactate and magnesium gluconate. In other embodiments, the salts can have a combination of Ca²⁺ and Mg²⁺ cations. For example, three C2-C9 organic acid salts comprise calcium citrate, magnesium lactate and calcium gluconate.

In certain embodiments, the C2-C9 organic acid anion is selected from the group consisting of gluconate; 2,3-dihydroxy propionate; 2,3-dihydroxy butanoate; lactate; acetate; propionate; butyrate; isobutyrate, valerate; isovalerate; 2-methylbutanoate; carboxylate anions of 2-hydroxybenzoic acid, 3-hydroxybenzoic acid, 4-hydroxybenzoic acid, 2,3-dihydroxybenzoic acid, 2,4-dihydroxybenzoic acid, 3,4-dihydroxybenzoic acid, 3,5-dihydroxybenzoic acid, 2,6-dihydroxybenzoic acid, 2,3,4-trihydroxybenzoic acid, 2,3,5-trihydroxybenzoic acid, 2,4,5-trihydrozybenzoic acid, 2,3,6-trihydroxybenzoic acid, 2,4,6-trihydroxybenzoic acid, 4-methoxysalicylic acid, 4-amino benzoic acid, and 3-amino benzoic acid; maleate; tartrate; tartronate; succinate; glutarate; adipate; malonate; fumarate; maleate; citrate; isocitrate and combinations thereof.

In preferred embodiments, the C2-C9 organic acid anions are one of the following combinations:
(a) gluconate and lactate;
(b) gluconate and citrate;
(c) gluconate and tartrate;
(d) gluconate and maleate;
(e) gluconate, lactate and citrate;
(f) gluconate, lactate and tartrate;
(g) gluconate, lactate and maleate;
(h) gluconate, citrate, tartrate;
(i) gluconate, citrate, maleate;
(j) gluconate, tartrate and maleate;
(k) gluconate, lactate, citrate, and maleate;
(l) gluconate, lactate, citrate, and tartrate;
(m) gluconate, lactate, citrate, tartrate and maleate;
(n) lactate and citrate;
(o) lactate and tartrate;
(p) lactate and maleate;
(q) lactate, citrate, and tartrate;
(r) lactate, citrate, and maleate;
(s) lactate, tartrate and maleate;
(t) lactate, citrate, tartrate, and maleate;
(u) tartrate and citrate;
(v) tartrate and maleate;
(w) maleate and citrate;
(x) maleate, citrate, and tartrate

The concentration of the at least one C2-C9 organic acid salt in the beverage can vary. A person of skill in the art will understand that the particular concentration of salt needed will vary depending on (a) the type of beverage, (b) the identity of the sweetener(s) in the beverage and their concentration, (c) the identity of the at least one C2-C9 organic acid salt, and (d) the presence or absence of any other taste modulating compounds. Preferred embodiments are discussed in more detail below. Nonetheless, an exemplary concentration range is from about 50 ppm to about 1,000 ppm, such as, for example, from about 50 ppm to about 900 ppm, from about 50 ppm to about 800 ppm, from about 50 ppm to about 700 ppm, from about 50 ppm to about 600 ppm, from about 50 ppm to about 500 ppm, from about 50 ppm to about 400 ppm, from about 50 ppm to about 300 ppm, and from about 50 ppm to about 200 ppm.

The concentration of the at least one C2-C9 organic acid salt in the beverage can also be described in millimolar (mM). The at least one salt described herein is preferably present in an amount from about 0.1 mM to about 5 mM, from about 0.1 mM to about 4 mM, from about 0.1 mM to about 3 mM, from about 0.1 mM to about 2 mM, from about 0.1 mM to about 1 mM, from about 0.5 mM to about 5 mM, from about 0.5 mM to about 4 mM, from about 0.5 mM to about 3 mM, from about 0.5 mM to about 2 mM, from about 0.5 mM to about 1 mM, from about 1 mM to about 5 mM, from about 1 mM to about 4 mM, from about 1 mM to about 3 mM, from about 1 mM to about 2 mM, from about 2 mM to about 5 mM, from about 2 mM to about 4 mM, from about 2 mM to about 3 mM, from about 3 mM to about 5 mM, or from about 3 mM to about 4 mM. These ranges can also apply to individual salts described herein.

It has been found that concentrations above 5 mM, and in some instances above 3 mM, result in unwanted saltiness.

In certain embodiments, the concentration of the at least one C2-C9 organic acid salt is from about 0.1 mM to about 3 mM, from about 1 mM to about 3 mM, or from about 1 mM to about 2 mM.

In embodiments wherein two C2-C9 organic acid salts are present, the weight ratio of a first C2-C9 organic acid salt to second C2-C9 organic acid salt can be from about 5:1 to about 1:1, such as, for example, from about 4:1 to about 1:1, from about 3:1 to about 1:1 or from about 2:1 to about 1:1. In a particular embodiment the weight ratio is from about 3:1 to about 1:1.

Potassium citrate is typically included in carbonated soft drinks as a buffering agent does not provide any mouthfeel effect at the typically utilized concentration, e.g., 300 ppm. In some embodiments, the beverage does not comprise potassium salts of C2-C9 organic acids and/or KCl.

c. Additional Taste Modifying Substances

The taste modifying composition can optionally include one or more additional taste modifying substances, e.g., at least one amino acid, at least one dihydrochalcone, and/or at least one medium chain fatty acid.

Exemplary amino acids include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid may be in the D- or L-configuration and in the mono-, di-, or tri-form of the same or different amino acids. Additionally, the amino acids may be α-, β-, γ- and/or δ-isomers if appropriate. Salt forms of the amino acids are also contemplated.

Preferred amino acids include glycine, alanine, proline, hydroxy proline and glutamine.

The concentration of the at least one amino acid in the beverage is from about 0.001 wt % to about 1 wt %.

Exemplary medium chain fatty acids have 6 to 12 carbon atoms. Exemplary medium chain fatty acids include C6 fatty acids (e.g., caproic acid and hexanoic acid), C8 fatty acids (caprylic acid and octanoic acid), C10 fatty acids (e.g., capric acid and decanoic acid) and C12 fatty acids (e.g., lauric acid and dodecanoic acid). Salt forms of the medium chain fatty acids are also contemplated.

The concentration of the at least one medium chain fatty acid in the beverage is from about 0.001 wt % to about 1 wt %.

Exemplary dihydrochalcones include, but are not limited to, phloretin, hesperetin dihydrochalcone, hesperetin dihydrochalcone 4-β-D-glucoside, neohesperidin dihydrochalcone, and naringin dihydrochalcone.

The concentration of the at least one amino acid, at least one medium chain fatty acid, or at least one dihydrochalcone in the beverage is from about 1 ppm to about 50 ppm, such as, for example, from about 1 ppm to about 45 ppm, from about 1 ppm to about 40 ppm, from about 1 ppm to about 35 ppm, from about 1 ppm to about 30 ppm, from about 1 ppm to about 25 ppm, from about 1 ppm to about 20 ppm, from about 1 ppm to about 15 ppm, from about 1 ppm to about 10 ppm, from about 1 ppm to about 5 ppm, or about 1 ppm to about 3 ppm.

The taste modifying composition can optionally include one or more of the following FEMA GRAS compounds: 4-amino-5,6-dimethyl-1H-thieno[2,3-d]pyrimidin-2-one (FEMA 4669); N-[3-[(4-amino-2,2-dioxo-1H-2,1,3-benzothiadiazin-5-yl)oxy]-2,2-dimethyl-propyl]propenamide (FEMA 4701); and FEMA 4965.

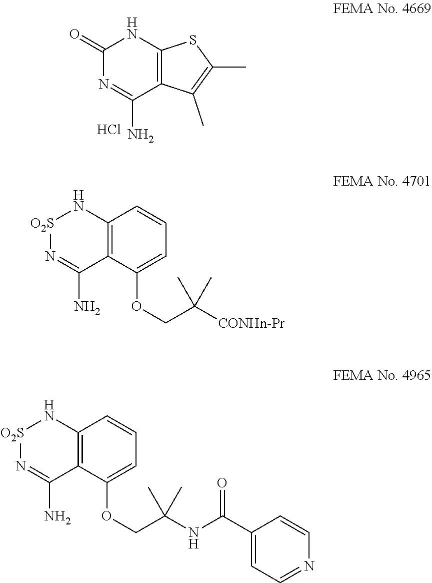

The concentration of the at least one FEMA GRAS compound is from about 1 ppm to about 50 ppm, such as, for example, from about 1 ppm to about 45 ppm, from about 1 ppm to about 40 ppm, from about 1 ppm to about 35 ppm, from about 1 ppm to about 30 ppm, from about 1 ppm to about 25 ppm, from about 1 ppm to about 20 ppm, from about 1 ppm to about 15 ppm, from about 1 ppm to about 10 ppm, from about 1 ppm to about 5 ppm, or about 1 ppm to about 3 ppm.

In certain embodiments, FEMA GRAS compound 4701 or FEMA GRAS compound 4965 are used as sweetness enhancers of the sweetener sucrose or HFCS. FEMA GRAS compound 4669 can be used as a sweetness enhancer of sucralose.

C. Beverage Formulations

A beverage of the present invention can be any type of known beverage, e.g., a full-calorie beverage, reduced calorie beverage or zero-calorie beverage.

In exemplary embodiments, the beverage is a carbonated beverage. Suitable carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer.

In other embodiments, the beverage is a non-carbonated beverage. Suitable non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

Beverages comprise a beverage matrix, i.e. the basic ingredient in which the ingredients are dissolved. In one embodiment, a beverage comprises water of beverage quality as the matrix, such as, for example deionized water, distilled water, reverse osmosis water, carbon-treated water, purified water, demineralized water and combinations thereof, can be used. Additional suitable beverage matrices include, but are not limited to phosphoric acid, phosphate buffer, citric acid, citrate buffer and carbon-treated water.

Many beverages typically contain citric acid as part of the beverage matrix. It has been found that the taste of a beverage containing at least one C2-C9 organic acid salt and citric acid (as part of the beverage matrix) can be further improved by replacing a portion of the citric acid with malic acid and/or tartaric acid. Accordingly, any of the above-describe beverage embodiments can further comprise malic acid and/or tartaric acid. In a particular embodiment, the weight ratio of the citric acid to malic and/or tartaric acid is from 4:1 to 3:2. In a more particular embodiment, the weight ratio of citric acid to malic acid is from 4:1 to 3:2. In another more particular embodiment, the weight ratio of citric acid to tartaric acid is from 4:1 to 3:2.

In one embodiment, the beverage is a cola beverage. A cola beverage matrix typically contains phosphoric acid.

A non-limiting example of the pH range of the beverage may be from about 1.8 to about 10. A further example includes a pH range from about 2 to about 5. In a particular embodiment, the pH of beverage can be from about 2.5 to about 4.2.

In a more particular embodiment, the pH of the beverage is from about 3.0 to about 3.5. It has been found that use of the C2-C9 organic acid salts described herein has a slightly basifying effect, increasing the pH from about 0.1 to about 0.3 pH units.

The titratable acidity of a beverage may, for example, range from about 0.01 to about 1.0% by weight of beverage.

In one embodiment, the sparkling beverage product has an acidity from about 0.01 to about 1.0% by weight of the beverage, such as, for example, from about 0.05% to about 0.25% by weight of beverage.

The carbonation of a sparkling beverage product has 0.1 to about 2% (w/w) of carbon dioxide or its equivalent, for example, from about 0.1 to about 1.0% (w/w).

The beverage can be caffeinated (i.e., it contains caffeine) or non-caffeinated.

The temperature of a beverage may, for example, range from about 4° C. to about 100° C., such as, for example, from about 4° C. to about 25° C.

In one embodiment, a beverage has a sucrose equivalence (SE) of about 1% (w/v), such as, for example, about 2%, about 3%, about 4%, about 5%, about 6%, about 7%, about 8%, about 9%, about 10%, about 11%, about 12%, about 13%, about 14% or any range between these values.

The amount of sucrose, and thus another measure of sweetness, in a reference solution may be described in degrees Brix (° Bx). One degree Brix is 1 gram of sucrose in 100 grams of solution and represents the strength of the solution as percentage by weight (% w/w) (strictly speaking, by mass). In embodiments where the beverages are sweetened with sugar, the beverage can be about 1 degree Brix, about 2 degrees Brix, about 3 degrees Brix, about 4 degrees Brix, about 5 degrees Brix, about 6 degrees Brix, about 7 degrees Brix, about 8 degrees Brix, about 9 degrees Brix, about 10 degrees Brix, about 11 degrees Brix, about 12 degrees Brix, about 13 degrees Brix, about 14 degrees Brix or any range between these values.

1. Reduced Calorie Beverages

In one embodiment, the diet beverage is a reduced calorie, orange-flavored carbonated beverage comprising (i) at least one caloric sweetener, (ii) at least one high potency sweetener and (iii) at least one salt having a cation selected from Ca²⁺ and Mg²⁺.

In a particular embodiment, the reduced calorie, orange-flavored carbonated beverage comprises (i) sugar, (ii) at least one high potency sweetener selected from acesulfame K, sucralose and a combination thereof, and (iii) at least one salt having a cation selected from Ca²⁺ and Mg²⁺ and an anion selected from lactate, citrate, gluconate, lactate gluconate, anhydrous and/or hydrate forms thereof, and combinations thereof. In a still more particular embodiment, the at least one salt is selected from magnesium lactate, magnesium citrate, calcium citrate, calcium lactate, calcium gluconate, calcium lactate gluconate, anhydrous and/or hydrate forms thereof, and combinations thereof. In a more particular embodiment, the weight ratio of the Mg²⁺ cation-containing salt to the Ca²⁺ cation-containing salt can be from about 5:1 to about 1:1, such as, for example, from about 4:1 to about 1:1, from about 3:1 to about 1:1 or from about 2:1 to about 1:1. In a particular embodiment, the weight ratio is about 3:1. In another particular embodiment, the concentration of the at least one salt is from about 600 ppm to about 1,000 ppm, such as, for example, about 600 ppm to about 900 ppm, from about 600 ppm to about 800 ppm or from about 600 ppm to about 700 ppm. In yet another particular embodiment, the weight ratio of the Mg²⁺ cation-containing salt to the Ca²⁺ cation-containing salt is from about 3:1 to about 1:1 and the concentration of the at least one salts having a cation selected from Ca²⁺ and Mg²⁺ is from about 600 ppm to about 1,000 ppm.

In still further particular embodiment, a reduced calorie, orange-flavored carbonated beverage comprises (i) sugar, (ii) a combination of acesulfame K and sucralose, (iii) a salt having a Mg²⁺ cation and an anion selected from lactate, citrate, gluconate, lactate gluconate, anhydrous and/or hydrate forms thereof, and (iv) a salt having a Ca²⁺ cation and anion selected from lactate, citrate, gluconate, lactate gluconate, anhydrous and/or hydrate forms thereof, wherein the weight ratio of the Mg²⁺ cation-containing salt to the Ca²⁺ cation-containing salt is from about 3:1 to about 1:1 and the combined concentration of salts (iii) and (iv) is from about 600 ppm to about 1,000 ppm.

In a further particular embodiment, a reduced calorie, orange-flavored carbonated beverage comprises (i) sugar, (ii) a combination of acesulfame K and sucralose, (iii) magnesium lactate (including anhydrous and/or hydrate forms thereof), and (iv) calcium citrate (including anhydrous and/or hydrate forms thereof), wherein the weight ratio of magnesium lactate (including anhydrous and/or hydrate forms thereof) to calcium citrate (including anhydrous and/or hydrate forms thereof) is from about 3:1 to about 1:1 and the combined concentration of magnesium citrate (including anhydrous and/or hydrate forms thereof) and calcium citrate (including anhydrous and/or hydrate forms thereof) is from about 700 ppm to about 1,000 ppm.

In one embodiment, the diet beverage is a reduced calorie, lemon lime-flavored carbonated beverage comprising (i) at least one caloric sweetener, (ii) at least one high potency sweetener and (iii) at least one salt having a cation selected from Ca²⁺ and Mg²⁺.

In a particular embodiment, the reduced calorie, orange-flavored carbonated beverage comprises (i) sugar, (ii) rebaudioside M, and (iii) at least one salt having a cation selected from Ca²⁺ and Mg²⁺ and an anion selected from lactate, citrate, gluconate, lactate gluconate, anhydrous and/or hydrate forms thereof, and combinations thereof. In a still more particular embodiment, the at least one salt is selected from magnesium lactate, magnesium citrate, calcium citrate, calcium lactate, calcium gluconate, calcium lactate gluconate, anhydrous and/or hydrate forms thereof, and combinations thereof. In a still more particular embodiment, the weight ratio of the Mg²⁺ cation-containing salt to the Ca²⁺ cation-containing salt can be from about 5:1 to about 1:1, such as, for example, from about 4:1 to about 1:1, from about 3:1 to about 1:1 or from about 2:1 to about 1:1. In a particular embodiment, the weight ratio is about 3:1. In another particular embodiment, the concentration of the at least one salt is from about 300 ppm to about 1,000 ppm, such as, for example, from about 300 ppm to about 900 ppm, from about 300 ppm to about 800 ppm, from about 300 ppm to about 700 ppm, from about 300 ppm to about 600 ppm, from about 300 ppm to about 500 ppm and from about 300 ppm to about 400 ppm. In yet another particular embodiment, the weight ratio of the Mg²⁺ cation-containing salt to the Ca²⁺ cation-containing salt is from about 3:1 to about 1:1 and the concentration of the at least one salts having a cation selected from Ca²⁺ and Mg²⁺ is from about 300 ppm to about 1,000 ppm, preferably from about 300 ppm to about 400 ppm.

In still further particular embodiment, a reduced calorie, lemon lime-flavored carbonated beverage comprises (i) sugar, (ii) rebaudioside M, (iii) a salt having a Mg²⁺ cation and an anion selected from lactate, citrate, gluconate, lactate gluconate, anhydrous and/or hydrate forms thereof, and (iv) a salt having a Ca²⁺ cation and an anion selected from lactate, citrate, gluconate, lactate gluconate, anhydrous and/or hydrate forms thereof, wherein the weight ratio of the Mg²⁺ cation-containing salt to the Ca²⁺ cation-containing salt is from about 3:1 to about 1:1 and the combined concentration of (iii) and (iv) is from about 300 ppm to about 1,000 ppm, more preferably from about 300 ppm to about 400 ppm.

In a further particular embodiment, a reduced calorie, lemon lime-flavored carbonated beverage comprises (i) sugar, (ii) rebaudioside M, (iii) magnesium lactate (including anhydrous and/or hydrate forms thereof), and (iv) calcium citrate (including anhydrous and/or hydrate forms thereof), wherein the weight ratio of magnesium lactate (including anhydrous and/or hydrate forms thereof) to calcium citrate (including anhydrous and/or hydrate forms thereof) is from about 3:1 to about 1:1 and the combined concentration magnesium lactate (including anhydrous and/or hydrate forms thereof) and calcium citrate (including anhydrous and/or hydrate forms thereof) is from about 300 ppm to about 1,000 ppm, more preferably from about 300 ppm to about 400 ppm.

In one embodiment, a reduced calorie beverage comprises a sweetening amount of sucrose, a sweetening amount of at least one non-sucrose sweetener described herein, and a taste modifying composition comprising at least one C2-C9 organic acid salt described herein, wherein the beverage is from about 4 to about 8° Bx. The taste modifying composition optionally includes one or more additional taste modifying substances.

In a more particular embodiment, a reduced calorie beverage comprises a sweetening amount of sucrose, a sweetening amount of at least one non-sucrose sweetener described herein, and a taste modifying composition comprising at least one C2-C9 organic acid salt described herein, wherein the beverage comprises from about 0.1 to about 3 mM of the at least one C2-C9 organic acid salt, more preferably from about 0.1 to about 2 mM of the at least one C2-C9 organic acid salt, and the beverage is from about 4 to about 8° Bx. The taste modifying composition optionally includes one or more additional taste modifying substances.

In a more particular embodiment, a reduced calorie beverage comprises a sweetening amount of sucrose; a sweetening amount of sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof, and a taste modifying composition comprising at least one C2-C9 organic acid salt described herein, wherein the beverage comprises from about 0.1 to about 3 mM of the at least one C2-C9 organic acid salt, more preferably from about 0.1 to about 2 mM of the at least one C2-C9 organic acid salt, and the beverage is from about 4 to about 8° Bx. The taste modifying composition optionally includes one or more additional taste modifying substances.

In another embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside 1, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from Formula I-VI described herein; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another more embodiment, a reduced calorie beverage comprises a sweetening amount of sucrose, a sweetening amount of a sweetener selected from the group consisting of rebaudioside M, rebaudioside A, rebaudioside AM, rebaudioside D, mogroside V, siamenoside 1, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof, and a taste modifying composition comprising at least one C2-C9 organic acid salt consisting of a cation selected from Ca²⁺ and Mg²⁺ and at least one anion according to Formula

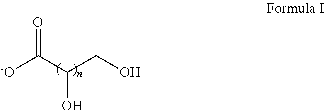

wherein n is 1-7;
the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion elected from the group consisting of gluconate, 2,3-dihydroxy propionate, and 2,3-dihydroxy butanoate; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula II:

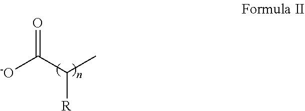

wherein n is 0-7 and R is OH or H;
the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof, and a taste modifying composition comprising at least one C2-C9 organic acid salt, wherein each C2-C9 organic acid salt consists of a cation selected from Ca²⁺ and Mg²⁺ and at least one lactate anion; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a still more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising two C2-C9 organic acid salts, wherein each C2-C9 organic acid salt consists of a cation selected from Ca²⁺ and Mg²⁺ and an anion selected from lactate and gluconate; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a still more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising calcium lactate and calcium gluconate, wherein the combined concentration of calcium lactate and calcium gluconate is from about 0.1 mM to about 3 mM, more preferably from about 0.1 mM to about 2 mM; and the beverage is from about 4 to about 8° Bx. The taste modifying composition optionally includes one or more additional taste modifying substances.

In a still more particular embodiment, a reduced calorie beverage comprises a sweetening amount of sucrose; from about 100 ppm to about 300 ppm rebaudioside M; and a taste modifying composition comprising calcium lactate and calcium gluconate, wherein the combined concentration of calcium lactate and calcium gluconate is from about 0.1 mM to about 3 mM, from about 0.5 mM to about 3.0 mM, or from about 0.5 mM to about 1.5 mM; and the beverage is from about 4 to about 8° Bx. The taste modifying composition optionally includes one or more additional taste modifying substances.

In another more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion that is a short-chain fatty acid anion; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of acetate, propionate, butyrate, isobutyrate, valerate, isovalerate, and 2-methylbutanoate; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula III:

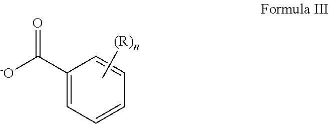

wherein R is OH, CH₃ or NH₂ and n is 1-5;
the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein the C2-C9 organic acid salt consists of a cation selected from Ca²⁺ and Mg²⁺ and at least one anion selected from a carboxylate anion of an acid selected from the group consisting of 2-hydroxybenzoic acid, 3-hydroxybenzoic acid, 4-hydroxybenzoic acid, 2,3-dihydroxybenzoic acid, 2,4-dihydroxybenzoic acid, 3,4-dihydroxybenzoic acid, 3,5-dihydroxybenzoic acid, 2,6-dihydroxybenzoic acid, 2,3,4-trihydroxybenzoic acid, 2,3,5-trihydroxybenzoic acid, 2,4,5-trihydrozybenzoic acid, 2,3,6-trihydroxybenzoic acid, 2,4,6-trihydroxybenzoic acid, 4-methoxysalicylic acid, 4-amino benzoic acid, and 3-amino benzoic acid; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula IV:

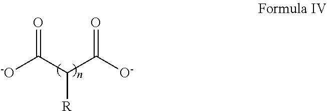

wherein n is 1-7 and R is H or OH;
the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of maleate, tartrate, tartronate, succinate, glutarate, adipate and malonate; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another embodiment, a reduced calorie beverage comprises a sweetening amount of sucrose, a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula V:

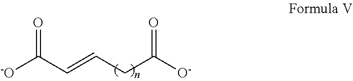

wherein n is 0-5;
the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from fumarate and maleate; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In another embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula VI:

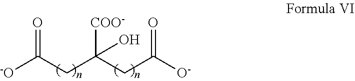

wherein n is 0-6;
the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from citrate and isocitrate; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

In a still more particular embodiment, a reduced calorie beverage comprises a sweetening amount of sucrose; a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion; each anion is selected from the group consisting of gluconate, 2, 3-dihydroxy propionate, 2,3-dihydroxy butanoate, lactate, acetate, propionate, butyrate, isobutyrate, valerate, isovalerate, 2-methylbutanoate; carboxylate anions of 2-hydroxybenzoic acid, 3-hydroxybenzoic acid, 4-hydroxybenzoic acid, 2,3-dihydroxybenzoic acid, 2,4-dihydroxybenzoic acid, 3,4-dihydroxybenzoic acid, 3,5-dihydroxybenzoic acid, 2,6-dihydroxybenzoic acid, 2,3,4-trihydroxybenzoic acid, 2,3,5-trihydroxybenzoic acid, 2,4,5-trihydrozybenzoic acid, 2,3,6-trihydroxybenzoic acid, 2,4,6-trihydroxybenzoic acid, 4-methoxysalicylic acid, 4-amino benzoic acid, and 3-amino benzoic acid; maleate, tartrate, tartronate, succinate, glutarate, adipate and malonate, fumarate, maleate, citrate, isocitrate, and combinations thereof; the beverage comprises from about 0.1 to about 3 mM of the at least one C2-C9 organic acid salt, more preferably from about 0.1 to about 2 mM of the at least one C2-C9 organic acid salt; and the beverage is from about 4 to about 8° Bx. The taste modifying composition optionally includes one or more additional taste modifying substances.

2. Zero-Calorie Beverages

In one embodiment, the diet beverage is a zero-calorie, orange-flavored carbonated beverage comprising (i) at least one high potency sweetener and (ii) at least one salt having a cation selected from Ca²⁺ and Mg²⁺.

In a particular embodiment, the zero-calorie, orange-flavored carbonated beverage comprises (i) at least one high potency sweetener selected from acesulfame K, aspartame and a combination thereof, and (ii) at least one salt having a cation selected from Ca²⁺ and Mg²⁺ and an anion selected from lactate, citrate, gluconate, lactate gluconate, anhydrous and/or hydrate forms thereof, and combinations thereof. In a still more particular embodiment, the at least one salt is selected from magnesium lactate, magnesium citrate, calcium citrate, calcium lactate, calcium gluconate, calcium lactate gluconate, anhydrous and/or hydrate forms thereof, and combinations thereof. In a still more particular embodiment, the weight ratio of the Mg²⁺ cation-containing salt to the Ca²⁺ cation-containing salt can be from about 5:1 to about 1:1, such as, for example, from about 4:1 to about 1:1, from about 3:1 to about 1:1 or from about 2:1 to about 1:1. In a particular embodiment, the weight ratio is about 3:1. In another particular embodiment, the concentration of the at least one salt is from about 300 ppm to about 1,000 ppm, such as, for example, about 300 ppm to about 900 ppm, from about 300 ppm to about 800 ppm, from about 300 ppm to about 700 ppm, from about 300 ppm to about 600 ppm, from about 300 ppm to about 500 ppm and about 300 ppm to about 400 ppm. In yet another particular embodiment, the weight ratio of the Mg²⁺ cation-containing salt to the Ca²⁺ cation-containing salt is from about 3:1 to about 1:1 and the concentration of the at least one salts having a cation selected from Ca²⁺ and Mg²⁺ is from about 300 ppm to about 1,000 ppm.

In still further particular embodiment, a zero-calorie, orange-flavored carbonated beverage comprises (i) a combination of acesulfame K and aspartame, (ii) a salt having a Mg²⁺ cation and an anion selected from lactate, citrate, gluconate, lactate gluconate, anhydrous and/or hydrate forms thereof, and (iii) a salt having a Ca²⁺ cation and an anion selected from lactate, citrate, gluconate, lactate gluconate, and anhydrous and/or hydrate forms thereof, wherein the weight ratio of the Mg²⁺ cation-containing salt to the Ca²⁺ cation-containing salt is from about 3:1 to about 1:1 and the combined concentration of (ii) and (iii) is from about 300 ppm to about 1,000 ppm, preferably from about 300 ppm to about 400 ppm.

In a further particular embodiment, a zero-calorie, orange-flavored carbonated beverage comprises (i) a combination of acesulfame K and aspartame, (ii) magnesium lactate (including anhydrous and/or hydrate forms thereof), and (iii) calcium citrate (including anhydrous and/or hydrate forms thereof), wherein the weight ratio of magnesium lactate (including anhydrous and/or hydrate forms thereof) to calcium citrate (including anhydrous and/or hydrate forms thereof) is from about 3:1 to about 1:1 and the combined concentration of magnesium lactate (including anhydrous and/or hydrate forms thereof) and calcium citrate (including anhydrous and/or hydrate forms thereof) is from about 300 ppm to about 1,000 ppm, more preferably from about 300 to about 400 ppm.

In another particular embodiment, a zero-calorie, orange-flavored carbonated beverage comprises (i) a combination of acesulfame K and aspartame, (ii) calcium lactate (including anhydrous and/or hydrate forms thereof), and (iii) calcium gluconate (including anhydrous and/or hydrate forms thereof), wherein the concentration of calcium lactate and calcium gluconate (including anhydrous and/or hydrate forms thereof) is from about 300 ppm to about 1,000 ppm, more preferably from about 300 ppm to about 400 ppm.

In one embodiment, the diet beverage is a zero-calorie, lemon lime-flavored carbonated beverage comprising (i) at least one high potency sweetener and (ii) at least one salt having a cation selected from Ca²⁺ and Mg²⁺.

In a particular embodiment the zero-calorie, lemon lime-flavored carbonated beverage comprises (i) at least one high potency sweetener selected from acesulfame K, aspartame and a combination thereof, and (ii) at least one salt having a cation selected from Ca²⁺ and Mg²⁺ and an anion selected from lactate, citrate, gluconate, lactate gluconate, anhydrous and/or hydrate forms thereof, and combinations thereof. In a still more particular embodiment, the at least one salt is selected from magnesium lactate, magnesium citrate, calcium citrate, calcium lactate, calcium gluconate, calcium lactate gluconate, anhydrous and/or hydrate forms thereof, and combinations thereof. The weight ratio of the Mg²⁺ cation-containing salt to the Ca²⁺ cation-containing salt can be from about 5:1 to about 1:1, such as, for example, from about 4:1 to about 1:1, from about 3:1 to about 1:1 or from about 2:1 to about 1:1. In a particular embodiment, the weight ratio is about 1:1. The concentration of the at least one salt is from about 300 ppm to about 1,000 ppm, such as, for example, about 300 ppm to about 900 ppm, from about 300 ppm to about 800 ppm, from about 300 ppm to about 700 ppm, from about 300 ppm to about 600 ppm, from about 300 ppm to about 500 ppm and about 300 ppm to about 400 ppm. In a particular embodiment, the weight ratio of the Mg²⁺ cation-containing salt to the Ca²⁺ cation-containing salt is from about 3:1 to about 1:1 and the concentration of the at least one salts having a cation selected from Ca²⁺ and Mg²⁺ is from about 300 ppm to about 1,000 ppm.

In a further particular embodiment, a zero-calorie, lemon lime-flavored carbonated beverage comprises (i) a combination of acesulfame K and aspartame, (ii) a salt having a Mg²⁺ cation and an anion selected from lactate, citrate, gluconate, lactate gluconate, anhydrous and/or hydrate forms thereof, and (iii) a salt having a Ca²⁺ cation and anion selected from lactate, citrate, gluconate, lactate gluconate, and anhydrous and/or hydrate forms thereof, wherein the weight ratio of the Mg²⁺ cation-containing salt to the Ca²⁺ cation-containing salt is from about 3:1 to about 1:1 and the combined concentration of (ii) and (iii) is from about 300 ppm to about 1,000 ppm, more preferably from about 300 ppm to about 400 ppm.

In a further particular embodiment, a zero-calorie, lemon lime-flavored carbonated beverage comprises (i) a combination of acesulfame K and aspartame, (ii) magnesium citrate (including anhydrous and/or hydrate forms thereof), and (iii) calcium citrate (including anhydrous and/or hydrate forms thereof), wherein the weight ratio of magnesium citrate (including anhydrous and/or hydrate forms thereof) to calcium citrate (including anhydrous and/or hydrate forms thereof) is from about 3:1 to about 1:1 and the combined concentration magnesium citrate (including anhydrous and/or hydrate forms thereof) and calcium citrate (including anhydrous and/or hydrate forms thereof) is from about 300 ppm to about 1,000 ppm, more preferably from about 300 ppm to about 400 ppm.

In another embodiment, a zero-calorie, lemon lime-flavored carbonated beverage comprises (i) a combination of acesulfame K and aspartame and (ii) at least one salt having a Ca²⁺ cation and anion selected from lactate, citrate, gluconate, lactate gluconate, and anhydrous and/or hydrate forms thereof, wherein the concentration of (ii) is from about 300 ppm to about 1,000 ppm, more preferably from about 300 ppm to about 400 ppm. In a particular embodiment, (ii) is a mixture of calcium lactate and calcium gluconate (including anhydrous and/or hydrate forms thereof).

In a yet further particular embodiment, a zero-calorie, lemon lime-flavored carbonated beverage comprises (i) rebaudioside M and (ii) a salt having a Ca²⁺ cation and anion selected from lactate, citrate, gluconate, lactate gluconate, and anhydrous and/or hydrate forms thereof, wherein the concentration of (ii) is from about 300 ppm to about 1,000 ppm, more preferably from about 300 ppm to about 400 ppm. In a particular embodiment, (ii) is calcium lactate (including anhydrous and/or hydrate forms thereof).

In one embodiment, a zero-calorie beverage comprises a sweetening amount of at least one non-sucrose sweetener described herein, and a taste modifying composition comprising at least one C2-C9 organic acid salt described herein, wherein the beverage has a sucrose equivalence of at least about 5%. The taste modifying composition optionally includes one or more additional taste modifying substances.

In a more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt described herein; wherein the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from Formula I-VI described herein; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another more embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof, and a taste modifying composition comprising at least one C2-C9 organic acid salt consisting of a cation selected from Ca²⁺ and Mg²⁺ and at least one anion according to Formula I:

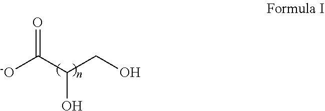

wherein n is 1-7;
the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another more particular embodiment, a zero-calorie beverage comprises a sweetening amount of a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of gluconate, 3-dihydroxy propionate, and 2,3-dihydroxy butanoate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising magnesium gluconate or calcium gluconate, wherein the magnesium gluconate or calcium gluconate is present in the beverage in a concentration of from about 0.1 mM to about 3 mM, more preferably from about 0.1 mM to about 2 mM; and the beverage has a sucrose equivalence of at least about 5%. The taste modifying composition optionally includes one or more additional taste modifying substances.

In an even more particular embodiment, a zero-calorie beverage comprises from about 400 ppm to about 600 ppm rebaudioside M; and a taste modifying composition magnesium gluconate or calcium gluconate, wherein the magnesium gluconate or calcium gluconate is present in the beverage in a concentration from about 0.1 mM to about 3 mM or from about 0.1 mM to about 2 mM; and the beverage has a sucrose equivalence of at least about 5%. The taste modifying composition optionally includes one or more additional taste modifying substances.

In another embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula II:

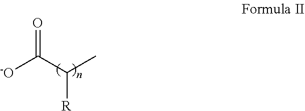

wherein n is 0-7 and R is OH or H;
the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one lactate anion; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising magnesium lactate or calcium lactate, wherein the magnesium lactate or calcium lactate is present in the beverage in a concentration from about 0.1 mM to about 3 mM or from about 0.1 mM to about 2 mM; and the beverage has a sucrose equivalence of at least about 5%. The taste modifying composition optionally includes one or more additional taste modifying substances.

In an even more particular embodiment, a zero-calorie beverage comprises from about 400 ppm to about 600 ppm rebaudioside M; and a taste modifying composition comprising magnesium lactate or calcium lactate, wherein the magnesium lactate or calcium lactate is present in the beverage in a concentration from about 1 to about 3 mM, or from about 0.1 to about 2 mM; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein at least one C2-C9 organic acid salt consists of a cation selected from Ca²⁺ and Mg²⁺ and two different anions: lactate and gluconate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising calcium lactate and calcium gluconate, wherein the combined concentration of calcium lactate and calcium gluconate in the beverage is from 0.1 mM to about 3 mM, or from about 0.1 mM to about 2 mM; and the beverage has a sucrose equivalence of at least about 5%. The taste modifying composition optionally includes one or more additional taste modifying substances.

In a still more particular embodiment, a zero-calorie beverage comprises from about 400 ppm to about 600 ppm rebaudioside M; and a taste modifying composition comprising calcium lactate and calcium gluconate, wherein the combined concentration of calcium lactate and calcium gluconate in the beverage is from about 0.1 mM to about 3 mM, or from about 0.1 mM to about 2 mM; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein at least one C2-C9 organic acid salt consists of a cation selected from Ca²⁺ and Mg²⁺ and two different anions: citrate and lactate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising calcium citrate and calcium lactate, wherein the combined concentration of calcium citrate and calcium lactate in the beverage is from 0.1 mM to about 3 mM, or from about 0.1 mM to about 2 mM; and the beverage has a sucrose equivalence of at least about 5%. The taste modifying composition optionally includes one or more additional taste modifying substances.

In a still more particular embodiment, a zero-calorie beverage comprises from about 25 ppm to about 600 ppm rebaudioside A and/or rebaudioside M; from about 100 to about 300 ppm sucralose; and a taste modifying composition comprising calcium lactate and calcium gluconate, wherein the combined concentration of calcium lactate and calcium gluconate in the beverage is from about 0.1 mM to about 3 mM, or from about 0.1 mM to about 2 mM; and the beverage has a sucrose equivalence of at least about 5%. The taste modifying composition optionally includes one or more additional taste modifying substances.

In another more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion that is a short-chain fatty acid anion; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of acetate, propionate, butyrate, isobutyrate, valerate, isovalerate, and 2-methylbutanoate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula III:

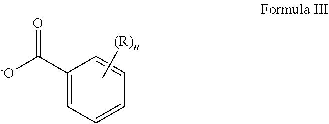

wherein R is OH, CH₃ or NH₂ and n is 1-5;
the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of a carboxylate anion of a hydroxybenzoic acid selected from the group consisting of 2-hydroxybenzoic acid, 3-hydroxybenzoic acid, 4-hydroxybenzoic acid, 2,3-dihydroxybenzoic acid, 2,4-dihydroxybenzoic acid, 2,5-dihydroxybenzoic acid, 2,6-dihydroxybenzoic acid, 3,4-dihydroxybenzoic acid, 3,5-dihydroxybenzoic acid, 2,3,4-trihydroxybenzoic acid, 2,4,6-trihydroxybenzoic acid, and 3,4,5-trihydroxybenzoic acid; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula IV:

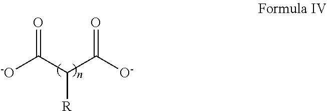

wherein n is 1-7 and R is H or OH;
the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of maleate, tartrate, tartronate, succinate, glutarate, adipate and malonate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula V:

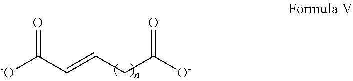

wherein n is 0-5;
the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from fumarate and maleate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt consisting of a cation selected from Ca²⁺ and Mg²⁺ and at least one anion according to Formula VI:

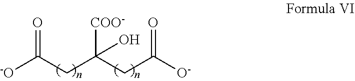

wherein n is 0-6;
the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from citrate and isocitrate; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising magnesium citrate or calcium citrate, wherein the magnesium citrate or calcium citrate is present in the beverage in a concentration of about 0.1 mM to about 3 mM; and the beverage has a sucrose equivalence of at least about 5%. The taste modifying composition optionally includes one or more additional taste modifying substances.

In an even more particular embodiment, a zero-calorie beverage comprises from about 400 ppm to about 600 ppm rebaudioside M; and a taste modifying composition comprising magnesium citrate or calcium citrate, wherein the magnesium citrate or calcium citrate is present in the beverage in a concentration from about 0.1 to about 3 mM or from about 0.1 to about 0.5 mM; and the beverage has a sucrose equivalence of at least about 5%. The taste modifying composition optionally includes one or more additional taste modifying substances.

In another more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising (i) magnesium citrate or calcium citrate and (ii) magnesium lactate or calcium lactate, wherein (i) and (ii) are present in the beverage in a total concentration of about 0.1 mM to about 3 mM; and the beverage has a sucrose equivalence of at least about 5%. The taste modifying composition optionally includes one or more additional taste modifying substances.

In an even more particular embodiment, a zero-calorie beverage comprises a sweetening amount of neotame and acesulfame K; and a taste modifying composition comprising (i) magnesium citrate or calcium citrate and (ii) magnesium lactate or calcium lactate, wherein (i) and (ii) are present in the beverage in a total concentration of about 0.1 mM to about 3 mM; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising at least one C2-C9 organic acid salt, wherein each C2-C9 organic acid salt consists of a cation selected from Ca²⁺ and Mg²⁺ and at least one anion selected from the group consisting of gluconate, 2, 3-dihydroxy propionate, 2,3-dihydroxy butanoate, lactate, acetate, propionate, butyrate, isobutyrate, valerate, isovalerate, 2-methylbutanoate; carboxylate anions of 2-hydroxybenzoic acid, 3-hydroxybenzoic acid, 4-hydroxybenzoic acid, 2,3-dihydroxybenzoic acid, 2,4-dihydroxybenzoic acid, 3,4-dihydroxybenzoic acid, 3,5-dihydroxybenzoic acid, 2,6-dihydroxybenzoic acid, 2,3,4-trihydroxybenzoic acid, 2,3,5-trihydroxybenzoic acid, 2,4,5-trihydrozybenzoic acid, 2,3,6-trihydroxybenzoic acid, 2,4,6-trihydroxybenzoic acid, 4-methoxysalicylic acid, 4-amino benzoic acid, and 3-amino benzoic acid; maleate, tartrate, tartronate, succinate, glutarate, adipate and malonate, fumarate, maleate, citrate, isocitrate, and combinations thereof; the beverage comprises from about 0.1 to about 3 mM of the at least one C2-C9 organic acid salt, more preferably from about 0.1 to about 2 mM of the at least one C2-C9 organic acid salt; and the beverage has a sucrose equivalence of at least about 5%. The taste modifying composition optionally includes one or more additional taste modifying substances.

In another more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising (i) magnesium lactate or calcium lactate, and (ii) magnesium citrate or calcium citrate; wherein (i) and (ii) are present in the beverage in a total concentration from about 0.1 mM to about 3 mM, more preferably from about 0.1 mM to about 2 mM; and the beverage has a sucrose equivalence of at least about 5%. The taste modifying composition optionally includes one or more additional taste modifying substances.

In another more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising (i) magnesium lactate or calcium lactate, and (ii) magnesium gluconate or calcium gluconate; wherein (i) and (ii) are present in the beverage in a total concentration from about 0.1 mM to about 3 mM, more preferably from about 0.1 mM to about 2 mM; and the beverage has a sucrose equivalence of at least about 5%. The taste modifying composition optionally includes one or more additional taste modifying substances.

In another more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising (i) magnesium gluconate or calcium gluconate, and (ii) magnesium citrate or calcium citrate; wherein (i) and (ii) are present in the beverage in a total concentration from about 0.1 mM to about 3 mM, more preferably from about 0.1 mM to about 2 mM; and the beverage has a sucrose equivalence of at least about 5%. The taste modifying composition optionally includes one or more additional taste modifying substances.

In a still more particular embodiment, a zero-calorie beverage comprises a sweetening amount of a sweetener selected from the group consisting of rebaudioside M, rebaudioside A, rebaudioside AM, rebaudioside D, mogroside V, siamenoside I, siratose, brazzein (and variants thereof), thaumatin (and variants thereof), monellin (and variants thereof), sweet truffle protein (and variants thereof), sucralose, aspartame, acesulfame K, saccharin, cyclamate, neotame, advantame, tagatose, erythritol, allulose, and combinations thereof; and a taste modifying composition comprising (i) magnesium lactate or calcium lactate, (ii) magnesium gluconate or calcium gluconate, and (iii) magnesium citrate or calcium citrate; wherein (i), (ii), and (iii) are present in the beverage in a total concentration from about 0.1 mM to about 3 mM, more preferably from about 0.1 mM to about 2 mM; and the beverage has a sucrose equivalence of at least about 5%. The taste modifying composition optionally includes one or more additional taste modifying substances.

In an even more particular embodiment, a zero-calorie beverage comprises from about 400 ppm to about 600 ppm rebaudioside M; and a taste modifying composition comprising (i) magnesium or calcium lactate, (ii) magnesium gluconate or calcium gluconate, and (iii) magnesium citrate or calcium citrate; wherein (i), (ii) and (iii) are present in the beverage in a total concentration from about 0.1 mM to about 3 mM, more preferably from about 0.1 mM to about 2 mM; and the beverage has a sucrose equivalence of at least about 5%. The taste modifying composition optionally includes one or more additional taste modifying substances.

As noted above, it has been found that the taste of a beverage containing at least one C2-C9 organic acid salt and citric acid (in the beverage matrix) can be further improved by replacing a portion of the citric acid with malic acid and/or tartaric acid. Accordingly, any of the above-describe beverage embodiments can further comprise citric acid and malic acid and/or tartaric acid. In a particular embodiment, the weight ratio of the citric acid to malic and/or tartaric acid is from 4:1 to 3:2. In a more particular embodiment, the weight ratio of citric acid to malic acid is from 4:1 to 3:2. In another more particular embodiment, the weight ratio of citric acid to tartaric acid is from 4:1 to 3:2.

3. Functional Ingredients

The beverages described herein optionally include at least one functional ingredient described herein below.

Exemplary functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponaria), the root of which was used historically as soap, as well as alfalfa, aloe, asparagus, grapes, chickpeas, Yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), Aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is reservatrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, MD), OmegaPure (from Omega Protein, Houston, TX), Marinol C-38 (from Lipid Nutrition, Channahon, IL), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is at least one vitamin. Suitable vitamins include, vitamin A, vitamin D, vitamin E, vitamin K, vitamin B1, vitamin B2, vitamin B3, vitamin B5, vitamin B6, vitamin B7, vitamin B9, vitamin B12, and vitamin C.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

In certain embodiments, the functional ingredient is glucosamine, optionally further comprising chondroitin sulfate.

In certain embodiments, the functional ingredient is at least one mineral. Minerals, in accordance with the teachings of this invention, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In one embodiment, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In a particular embodiment, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in one embodiment, the minerals may be in their ionic form, having either a positive or negative charge. In another embodiment, the minerals may be in their molecular form. For example, sulfur and phosphorous often are found naturally as sulfates, sulfides, and phosphates.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside Ill, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T. officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen-like effect of any degree. For example, a phytoestrogen may bind to estrogen receptors within the body and have a small estrogen-like effect.

Examples of suitable phytoestrogens for embodiments of this invention include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (Pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (—OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom I-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., β-sitosterol, campesterol, stigmasterol, brassicasterol, 22-dehydrobrassicasterol, and A5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the α and β isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

4. Additives

Exemplary additives include, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and combinations thereof.

In one embodiment, the composition further comprises one or more polyols. The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine.

Suitable polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in a consumable, such as, for example, a beverage.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, New Jersey, U.S.A.), and Sucramask™ (Creative Research Management, Stockton, California, U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like.

Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

### III. Methods

Methods of modulating one or more taste attributes of a beverage to improve the flavor profile are provided.

In one embodiment, a method of making a beverage taste more like a sucrose-sweetened beverage comprises (i) providing a beverage comprising at least one non-sucrose sweetener and (ii) adding at least one salt described herein to provide a beverage with one or more modified sucrose-sweetened beverage taste attributes compared to the beverage in the absence of the at least one salt described herein.

In one embodiment, a method of improving one or more taste attributes of a beverage comprises (i) providing a beverage comprising at least one sweetener and (ii) adding a taste modifying composition comprising at least one C2-C9 organic acid salt described herein to provide a beverage with one or more improved taste attributes compared to the beverage in the absence of the taste modifying composition. In exemplary embodiments, one or more of the following taste attributes are improved: sweetness intensity (increase), sweetness onset (increase), sweet temporal profile (increase), bitterness (decrease), bitter linger (decrease) sugar-like mouthfeel (increase), body (increase), overall rounded sucrose-like taste and overall flavor profile (increase). Any of the taste modifying compositions described herein can be used. The taste modifying composition optionally includes one or more additional taste modifying substances. The method can further include adding an acid mixture comprising citric acid and malic acid and/or tartaric acid. The weight ratio of the citric acid to malic acid and/or tartaric acid can be from about 4:1 to about 3:2.

In one embodiment, a method of preparing a beverage comprises (i) providing a beverage comprising at least one non-sucrose sweetener described hereinabove and (ii) adding at least one salt described herein to the beverage.

In another embodiment, a method of preparing a beverage comprises (i) providing a beverage comprising at least one sweetener described hereinabove and (ii) adding a taste modifying composition comprising at least one C2-C9 organic acid salt described herein to the beverage. Any of the taste modifying compositions described herein can be used. The taste modifying composition optionally includes one or more additional taste modifying substances. The method can further include adding an acid mixture comprising citric acid and malic acid and/or tartaric acid. The weight ratio of the citric acid to malic acid and/or tartaric acid can be from about 4:1 to about 3:2.

In another embodiment, a method of improving the stability of a non-sucrose sweetener in a beverage comprises (i) providing a beverage comprising at least one non-sucrose sweetener described hereinabove and (ii) adding at least one C2-C9 organic acid salt described herein to the beverage. The stability of the non-sucrose sweetener can be measured by determining the amount of non-sucrose sweetener present at a given time by HPLC. Beverages comprising the at least one C2-C9 organic acid salt demonstrate less non-sucrose sweetener loss at a given temperature (e.g., 30° C. or 40° C.) and time point (e.g., 2 weeks, 4 weeks, 6 weeks, 8 week, 10 weeks, 12 weeks or 14 weeks) compared to a corresponding beverage that does not contain the at least one C2-C9 organic acid salt. In a particular embodiment, the beverage comprising the at least one C2-C9 organic acid salt exhibits 10% less, 20% less, 30% less, 40% less, or 50% less non-sucrose sweetener loss over a given time period and temperature compared to a corresponding beverage that does not contain the at least one C2-C9 organic acid salt.

### EXAMPLES

### Example 1: Comparison of Inorganic and Organic Salts in Zero-Calorie Reb a Beverages

Example 7 of U.S. Pat. No. 10,602,758 describes zero-calorie beverages with citric acid/potassium citrate buffer systems (CAB-K) sweetened with 500 ppm rebaudioside A (REBA) and one of 3 mM MgCl₂, 3 mM CaCl₂ or 10 mM KCl, 3 mM MgCl₂ and 3 mM CaCl₂. The beverage with 10 mM KCl, 3 mM MgCl₂ and 3 mM Cl₂ is described as significantly higher in sweetness and mouthfeel than the other samples. U.S. Pat. No. 10,602,758 describes that the mixture of KCl, MgCl₂, and CaCl₂ provides “statistically significant supra-additivity of the taste attributes Sweetness Intensity and Mouthfeel, and supra-suppression in the taste attributes of Sweetness Linger and Sweetness Desensitization, relative the effects anticipated based on additivity.”

Example 10.2 of U.S. Pat. No. 10,602,758 describes a sensory analysis of binary combination of NaCl, KCl, MgCl₂, and CaCl₂ in beverages with CAB-K buffer systems sweetened with 500 ppm rebaudioside A. The discussion states that “each of the binary combinations . . . enhanced the [sweetness intensity] of the REBA formulations, increased [mouthfeel] to approximately equal to or exceeding that of 10% sucrose and reduced both the [sweetness linger] and [sweetness desensitization] of REBA, albeit with introduction of weak salty off taste . . . ”

The beverages described in Example 7 (the beverage containing 10 mM KCl, 3 mM MgCl₂ and 3 mM CaCl₂) and Example 10.2 (the beverage containing MgCl₂, and CaCl₂) of U.S. Pat. No. 10,602,758 were compared to beverages of the present invention. Beverages were prepared with the ingredients and amounts in the following tables:

TABLE 1A

| | | | | | Test 1 | Test 2 Reb | | | |
|---|---|---|---|---|---|---|---|---|---|
| | | | | | Reb A | A with Ca | | | |
| | | | | | Mg Citrate, | Citrate, | | | |
| Ingredients | Full | Reb A | Reb A | Reb A | Lactate, | Lactate, | | | |
| g/liter | Sugar | Control | Ex 7 | Ex 10.2 | Gluconate | Gluconate | ppm | mM | mOsm. |
| Tripotassium | 0.3 | 0.3 | 0.3 | 0.3 | 0.3 | 0.3 | 300 | 0.98 | 3.92 |
| Citrate | | | | | | | | | |
| Sodium | 0.185 | 0.185 | 0.185 | 0.185 | 0.185 | 0.185 | | | |
| Benzoate | | | | | | | | | |
| Citric acid | 1.5 | 1.5 | 1.5 | 1.5 | 1.5 | 1.5 | | | |
| Sucrose | 100 g | | | | | | | | |
| Reb M | | 0.5 | 0.5 | 0.5 | 0.5 | 0.5 | | | |
| KCl | | | 0.7467 | | | | 746.7 | 10 | 20 |
| MgCl₂ | | | 0.6067 | 2.54 | | | 606.7/2540 | 3/12.5 | 8.96/37.5 |
| Hexahydrate | | | | | | | | | |
| CaCl₂ | | | 0.333 | 1.385 | | | 333.3/1385 | 3/12.5 | 9/37.4 |
| Tri- | | | | | 0.45 | | 451 | 1 | 5 |
| magnesium | | | | | | | | | |
| citrate | | | | | | | | | |
| Mg Lactate | | | | | 0.202 | | 202 | 1 | 3 |
| dihydrate | | | | | | | | | |
| Mg | | | | | 0.653 | | 653 | 1 | 3 |
| (Gluconate)₂ | | | | | | | | | |
| Tri-calcium | | | | | | 0.4986 | 498 | 1 | 5 |
| citrate | | | | | | | | | |
| tetrahydrate | | | | | | | | | |
| Calcium | | | | | | 0.21822 | 218 | 1 | 3 |
| lactate | | | | | | | | | |
| pentahydrate | | | | | | | | | |
| Calcium | | | | | | 0.43 | 430 | 1 | 3 |
| gluconate | | | | | | | | | |
| monohydrate | | | | | | | | | |

TABLE 1B

| | Test 3 | | | | Test 7 | | | |
|---|---|---|---|---|---|---|---|---|
| | Reb A with | Test 5 | Test 6 | | Reb A | | | |
| | Ca | Reb A | Reb A | Test 6 Reb | with | | | |
| Ingredients | Lactate, | with Mg | with Ca | A with Ca | Ca | | | |
| g/liter | Gluconate | Lactate | Lactate | Gluconate | Citrate | ppm | mM | mOsm. |
| Tripotassium | 0.3 | 0.3 | 0.3 | 0.3 | 0.3 | 300 | 0.98 | 3.92 |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Sucrose | | | | | | | | |
| Reb M | 0.5 | 0.5 | 0.5 | 0.5 | 0.5 | | | |
| Calcium | 0.973 | | | | | 973 | 3 | 18 |
| lactate + | | | | | | | | |
| calcium | | | | | | | | |
| gluconate | | | | | | | | |
| Mg Lactate | | 0.60735 | | | | 607 | 3 | 9 |
| dihydrate | | | | | | | | |
| Calcium | | | 0.6545 | | | 656 | 3 | 9 |
| lactate | | | | | | | | |
| pentahydrate | | | | | | | | |
| Calcium | | | | 1.29 | | 1291 | 3 | 9 |
| gluconate | | | | | | | | |
| monohydrate | | | | | | | | |
| Tri-calcium | | | | | 1.495 | 1495 | 3 | 15 |
| citrate | | | | | | | | |
| tetrahydrate | | | | | | | | |

The ingredients were dissolved in filtered water to constitute a beverage. Final beverages were filled in 300 ml glass bottles they were cooled and served cold (4° C.). The beverages were evaluated blindly by seven panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, sugar like mouthfeel, saltiness, astringency and overall flavor) on a 10-point scale with 1 as low and 10 as high.

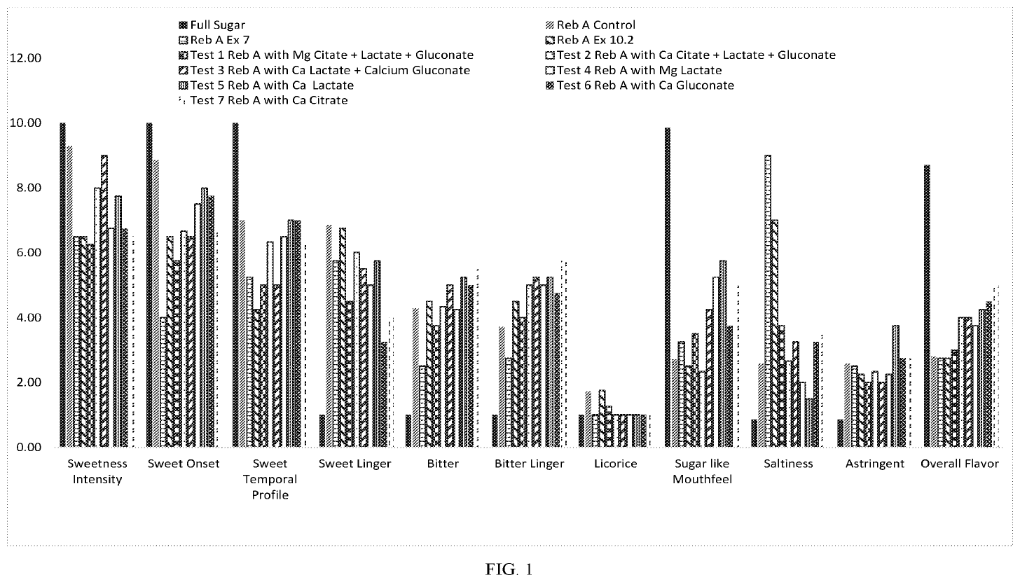

The results are shown in FIG. 1. The beverages of the present invention had better sweetness intensity, sweetness onset, sweet temporal profile, mouthfeel, overall liking and overall flavor compared to the beverages of U.S. Pat. No. 10,602,758. Additionally, the beverages of the present invention had less bitterness, less bitter linger, and less saltiness than the beverages of U.S. Pat. No. 10,602,758.

### Example 2: Comparison of Inorganic and Organic Salts in Zero-Calorie Reb M Beverages

The sensory profile of zero calorie beverages in CAB-K buffer sweetened with rebaudioside M and containing various C2-C9 organic acid salts of the present invention were compared to full sugar and reb M controls. Beverages according to Example 7 of U.S. Pat. No. 10,602,758 (the beverage containing 10 mM KCl, 3 mM MgCl₂ and 3 mM CaCl₂) and Example 10.2 of U.S. Pat. No. 10,602,758 (the beverage containing MgCl₂, and CaCl₂), but with 500 ppm rebaudioside M instead of rebaudioside A, were also tested.

Beverages were prepared with the ingredients and amounts in the following table:

TABLE 2A

| | | | | | Test 1 | Test 2 | | | |
|---|---|---|---|---|---|---|---|---|---|
| | | | | | Reb M | Reb M | | | |
| | | | | Reb | with Mg | with Ca | | | |
| | | | | M | Citrate, | Citrate, | | | |
| Ingredients | Full | Reb M | Reb M | Ex | Lactate, | Lactate, | | | |
| g/liter | Sugar | Control | Ex 7 | 10.2 | Gluconate | Gluconate | ppm | mM | mOsm. |
| Tripotassium | 0.3 | 0.3 | 0.3 | 0.3 | 0.3 | 0.3 | 300 | 0.9791 | 3.92 |
| Citrate | | | | | | | | | |
| Sodium | 0.185 | 0.185 | 0.185 | 0.185 | 0.185 | 0.185 | | | |
| Benzoate | | | | | | | | | |
| Citric acid | 1.5 | 1.5 | 1.5 | 1.5 | 1.5 | 1.5 | | | |
| Sucrose | 100 g | | | | | | | | |
| Reb M | | 0.5 | 0.5 | 0.5 | 0.5 | 0.5 | | | |
| KCl | | | 0.7467 | | | | 747 | 10 | 20 |
| MgCl₂ | | | 0.6067 | 2.54 | | | 607/2540 | 3/12.5 | 8.96/37.5 |
| Hexahydrate | | | | | | | | | |
| CaCl₂ | | | 0.333 | 1.385 | | | 333/1385 | 3/12.5 | 9/37.4 |
| Tri- | | | | | 0.45 | | 451 | 1 | 5 |
| magnesium | | | | | | | | | |
| citrate | | | | | | | | | |
| Mg Lactate | | | | | 0.202 | | 202 | 1 | 3 |
| dihydrate | | | | | | | | | |
| Mg | | | | | 0.653 | | 653 | 1 | 3 |
| (Gluconate)₂ | | | | | | | | | |
| Tri-calcium | | | | | | 0.4986 | 498 | 1 | 5 |
| citrate | | | | | | | | | |
| tetrahydrate | | | | | | | | | |
| Calcium | | | | | | 0.21822 | 218 | 1 | 3 |
| lactate | | | | | | | | | |
| pentahydrate | | | | | | | | | |
| Calcium | | | | | | 0.43 | 430 | 1 | 3 |
| gluconate | | | | | | | | | |
| monohydrate | | | | | | | | | |

TABLE 2B

| | Test 3 Reb | Test 5 | Test 6 | | Test 7 | | | |
|---|---|---|---|---|---|---|---|---|
| | M with Ca | Reb M | Reb M | Test 6 Reb | Reb M | | | |
| Ingredients | Lactate, | with Mg | with Ca | M with Ca | with Ca | | | |
| g/liter | Gluconate | Lactate | Lactate | Gluconate | Citrate | ppm | mM | mOsm. |
| Tripotassium | 0.3 | 0.3 | 0.3 | 0.3 | 0.3 | 300 | 0.9791 | 3.92 |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Sucrose | | | | | | | | |
| Reb M | 0.5 | 0.5 | 0.5 | 0.5 | 0.5 | | | |
| Calcium | 0.973 | | | | | 973 | 3 | 18 |
| lactate + | | | | | | | | |
| calcium | | | | | | | | |
| gluconate | | | | | | | | |
| Mg Lactate | | 0.60735 | | | | 607 | 3 | 9 |
| dihydrate | | | | | | | | |
| Calcium | | | 0.6545 | | | 655 | 3 | 9 |
| lactate | | | | | | | | |
| pentahydrate | | | | | | | | |
| Calcium | | | | 1.29 | | 1291 | 3 | 9 |
| gluconate | | | | | | | | |
| monohydrate | | | | | | | | |
| Tri-calcium | | | | | 1.495 | 1495 | 3 | 15 |
| citrate | | | | | | | | |
| tetrahydrate | | | | | | | | |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, mouthfeel-body syrupiness, mouthfeel body-viscosity, sugar like mouthfeel, astringency, sourness, saltiness, overall sugar like and overall flavor) on a 10-point scale with 1 as low and 10 as high.

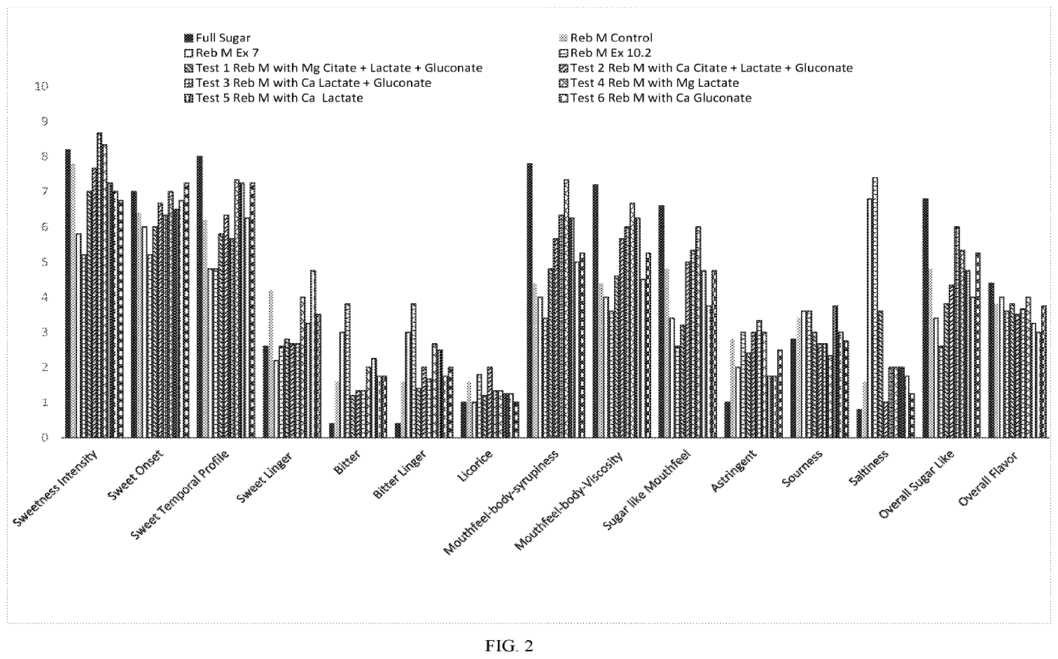

The results are shown in FIG. 2. The beverages of the present invention had better sweetness intensity, sweetness onset, sweet temporal profile, mouthfeel and overall sugar-like flavor compared to the rebaudioside M equivalents of U.S. Pat. No. 10,602,758. Additionally, the beverage of the present invention had less bitterness, less bitter linger, and less saltiness than the rebaudioside M equivalents of U.S. Pat. No. 10,602,758.

### Example 3: Effect of Individual Organic and Inorganic Salts on Taste Modulation in Zero Cal Reb M Beverages

The ability of single salts to improve the taste performance of beverages in zero-calorie rebaudioside M-sweetened beverages with CAB-K buffer systems was evaluated. Beverages were prepared with the ingredients and amounts in the following table.

TABLE 3

| | | | Mg | Mg | | | | |
|---|---|---|---|---|---|---|---|---|
| | 472 ppm | Na | Citrate | Lactate | Mg | | | |
| Ingredients | Reb M | Gluconate | 150 | 239 | Chloride | | | |
| g/liter | Control | 218 ppm | ppm | ppm | 203 ppm | ppm | mM | mOsm. |
| Tripotassium | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Reb M | 0.472 | 0.472 | 0.472 | 0.472 | 0.472 | | | |
| Na gluconate | | 0.21814 | | | | 218 | 1 | 2 |
| MgCl₂ | | | | | 0.203 | 203 | 1 | 3 |
| Hexahydrate | | | | | | | | |
| Tri-magnesium | | | 0.1504 | | | 151 | 0.33 | 1.7 |
| citrate | | | | | | | | |
| Mg Lactate | | | | 0.2385 | | 239 | 1.17 | 3.5 |
| dihydrate | | | | | | | | |
| Calcium lactate + | | | | | | 334 | 1 | 6 |
| calcium | | | | | | | | |
| gluconate | | | | | | | | |

TABLE 3B

| | Ca Lactate, | | | | | | |
|---|---|---|---|---|---|---|---|
| | Ca | | | | | | |
| Ingredients | Gluconate | Ca Chloride | Ca Citrate | Ca Lactate | | | |
| g/liter | 334 ppm | 141 ppm | 190 ppm | 308 ppm | ppm | mM | mOsm. |
| Tripotassium | 0.3/0.27 | 0.3/0.27 | 0.3/0.27 | 0.3/0.27 | 300/270 | 0.98/1 | 3.9/4.2 |
| Citrate/Sodium | | | | | | | |
| Citrate | | | | | | | |
| Sodium | 0.185 | 0.185 | 0.185 | 0.185 | | | |
| Benzoate | | | | | | | |
| Citric acid | 1.5 | 1.5 | 1.5 | 1.5 | | | |
| Reb M | 0.472 | 0.472 | 0.472 | 0.472 | | | |
| CaCl₂ | | 0.141 | | | 141 | 1.27 | 3 |
| Tri-calcium | | | 0.19 | | 190 | 0.38 | 1.91 |
| citrate | | | | | | | |
| tetrahydrate | | | | | | | |
| Calcium | | | | 0.308 | 308 | 1.4 | 4.2 |
| lactate | | | | | | | |
| pentahydrate | | | | | | | |
| Calcium | 0.334 | | | | 334 | 1 | 6 |
| lactate + | | | | | | | |
| calcium | | | | | | | |
| gluconate | | | | | | | |

The ingredients were dissolved in filtered water to constitute a beverage. Final beverages were filled in 300 ml glass bottles they were cooled and served cold (4° C.). The beverages were evaluated blindly by three expert panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attribute (sweet intensity, sweet onset, sweet temporal profile, sweet linger, bitter, bitter linger, licorice, mouthfeel, saltiness, astringent and overall flavor) on a 10-point scale with 1 as low and 10 as high.

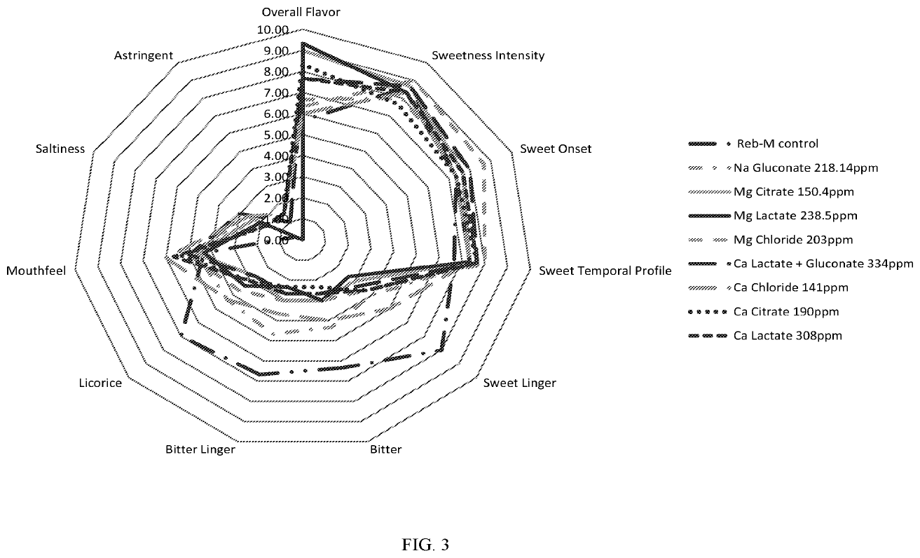

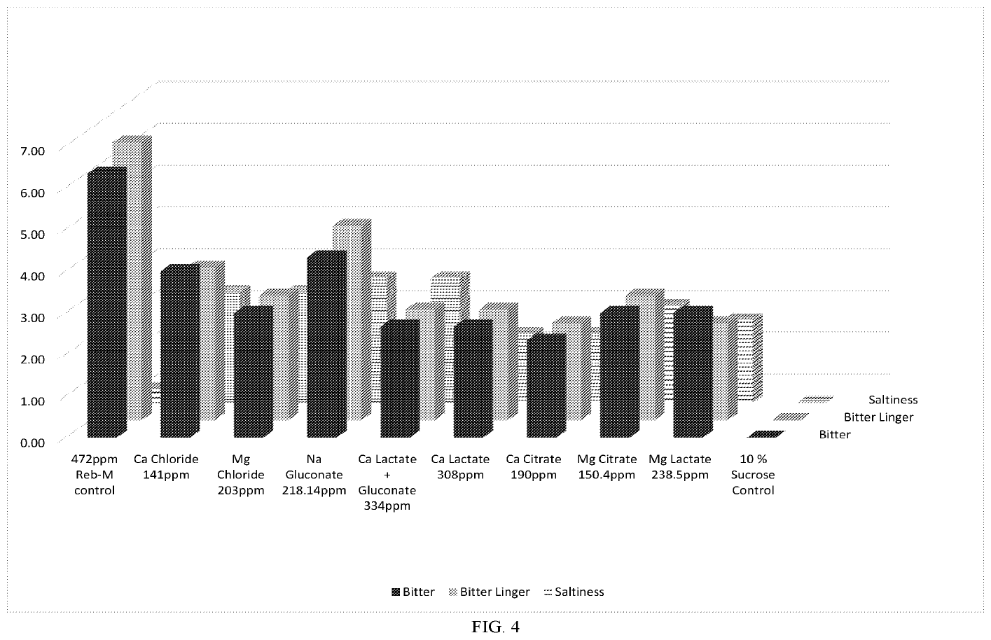

The results are shown in FIG. 3 and FIG. 4. The MgCl₂, CaCl₂ and sodium gluconate-containing samples had increased bitter linger, and bitterness than the samples containing magnesium citrate, calcium citrate, magnesium lactate, calcium lactate, and calcium lactate+calcium gluconate.

### Example 4: Concentration Effects

Optimal concentrations of C2-C9 organic acids salts of the present invention were evaluated in both zero-calorie and mid-calorie beverages sweetened with rebaudioside M in a CAB-K buffer system.

Mid-calorie beverages were prepared with the ingredients and amounts in the following table:

TABLE 4

| | | 4.6 BRIX | 425 ppm | 351 ppm | 475 ppm | | | |
|---|---|---|---|---|---|---|---|---|
| | Full | 145 ppm | Ca | Ca | Ca | | | |
| Ingredients | Sugar | Reb M | Lactate, | Lactate, | Lactate, | | | |
| g/liter | 10BRIX | Control | Gluconate | Gluconate | Gluconate | ppm | mM | mOsmoles |
| Tripotassium | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Sucrose | 100 | 46 | 46 | 46 | 46 | | | |
| Reb M | | 0.145 | 0.145 | 0.145 | 0.145 | | | |
| Calcium | | | 0.425 | | | 425 | 1.3 | 7.86 |
| lactate + | | | | | | | | |
| calcium | | | | | | | | |
| gluconate | | | | | | | | |
| Calcium | | | | 0.351 | | 351 | 1.08 | 6 |
| lactate + | | | | | | | | |
| calcium | | | | | | | | |
| gluconate | | | | | | | | |
| Calcium | | | | | 0.475 | 475 | 1.46 | 8.78 |
| lactate + | | | | | | | | |
| calcium | | | | | | | | |
| gluconate | | | | | | | | |

Zero-Calorie Beverages were Prepared with the Ingredients and Amounts in the Following Table:

TABLE 5

| | | | | | 70 ppm | | | |
|---|---|---|---|---|---|---|---|---|
| | | | | | Ca | | | |
| | | | | | Citrate + | | | |
| | 472 | 425ppm | 351 ppm | 295 ppm | 203 | | | |
| | ppm | Ca | Ca | Ca | ppm | | | |
| Ingredients | Reb M | Lactate, | Lactate, | Lactate, | Mg | | | |
| g/liter | Control | Gluconate | Gluconate | Gluconate | Lactate | ppm | mM | mOsmoles |
| Tripotassium | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Reb M | 0.145 | 0.145 | 0.145 | 0.145 | 0.145 | | | |
| Calcium | | 0.425 | | | | 425 | 1.3 | 7.86 |
| lactate + | | | | | | | | |
| calcium | | | | | | | | |
| gluconate | | | | | | | | |
| Calcium | | | 0.351 | | | 351 | 1.08 | 6 |
| lactate + | | | | | | | | |
| calcium | | | | | | | | |
| gluconate | | | | | | | | |
| Calcium | | | | 0.475 | | 475 | 1.46 | 8.78 |
| lactate + | | | | | | | | |
| calcium | | | | | | | | |
| gluconate | | | | | | | | |

For both the mid-calorie and zero-calorie beverages, the ingredients were dissolved in filtered water to constitute a beverage. Final beverages were filled in 300 ml glass bottles they were cooled and served cold (4° C.). The beverages were evaluated blindly by six panelists. Samples were coded and randomly presented to the panelists. Panelists were instructed to eat an unsalted cracker and rinse the mouth with water before and in between the samples. For each sample, panelists were instructed to taste, then write down their evaluation comments for ranking each attribute (sweet intensity, sweet linger, bitter, saltiness, astringency and overall flavor preference) on a 6-point scale with 1 as “best” and 6 as “worst”.

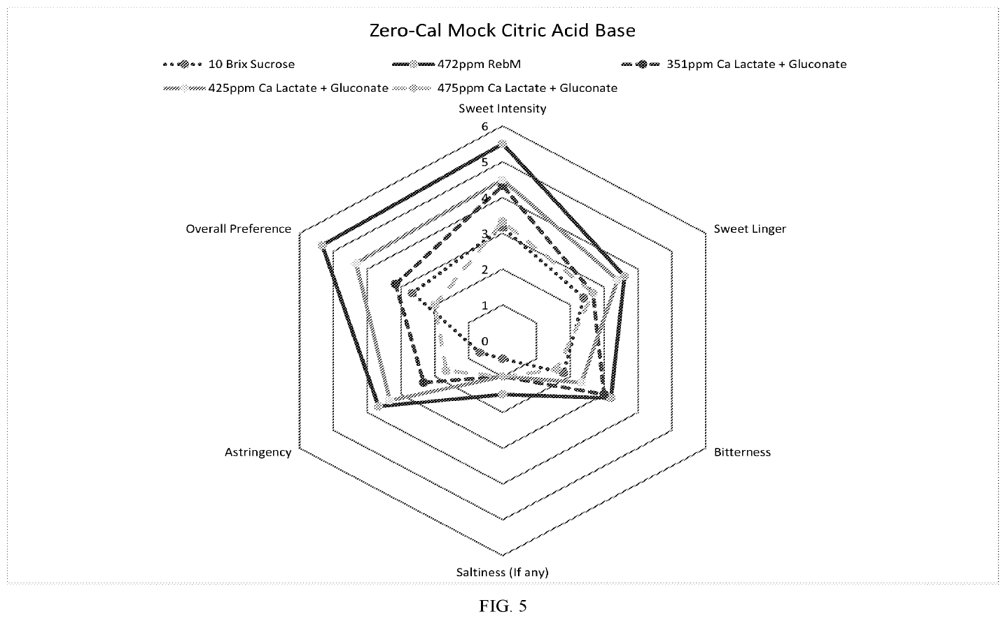

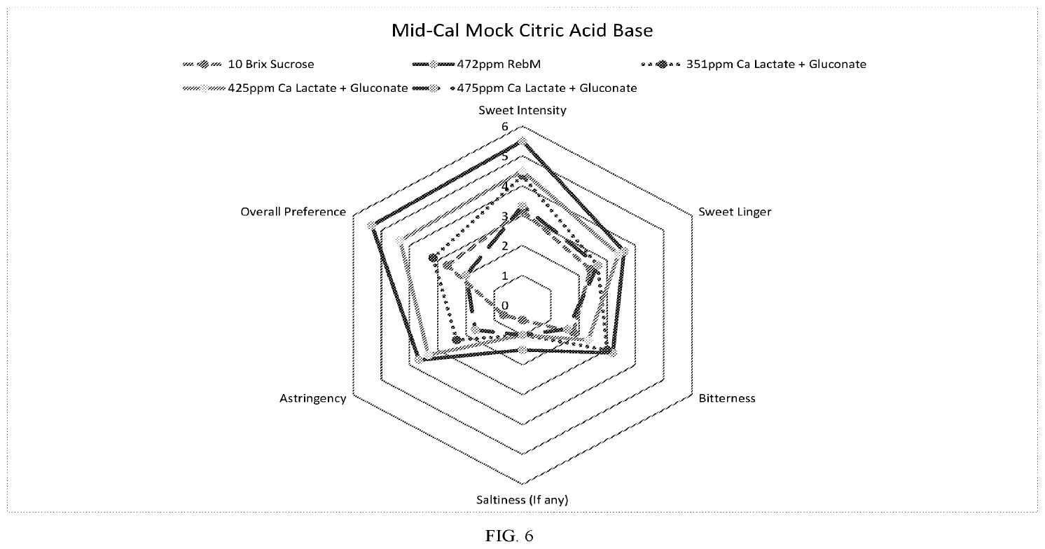

The results are shown in FIG. 5. (zero-calorie beverages) and FIG. 6 (mid-calorie beverages). For zero-calorie beverages, calcium lactate+calcium gluconate performed best at 475 ppm for overall preference and sweetness intensity. For mid-calorie beverages, 475 ppm calcium lactate+calcium gluconate provided the best result for sweetness intensity. All calcium gluconate+calcium lactate samples provided improvement over rebaudioside M alone.

### Example 5: Concentration Effects

Higher concentrations of C2-C9 organic acid salts than those described in Example 4 were evaluated in zero-calorie beverages with CAB-K matrices sweetened with rebaudioside M. Beverages were prepared with the ingredients and amounts in the following table:

TABLE 6

| | 500 ppm | 1000 ppm | | | |
|---|---|---|---|---|---|
| Ingredients | Ca Lactate, | Ca Lactate, | | | |
| g/liter | Gluconate | Gluconate | ppm | mM | mOsmoles |
| Tripotassium | 0.3 | 0.3 | 0.3 | 0.98 | 3.9 |
| Citrate | | | | | |
| Sodium | 0.185 | 0.185 | | | |
| Benzoate | | | | | |
| Citric acid | 1.5 | 1.5 | | | |
| Reb M | 0.472 | 0.472 | | | |
| Calcium | 0.5 | | 500 | 1.54 | 4.63 |
| lactate + | | | | | |
| calcium | | | | | |
| gluconate | | | | | |
| Calcium | | 1 | 1000 | 3.08 | 18.5 |
| lactate + | | | | | |
| calcium | | | | | |
| gluconate | | | | | |

The ingredients were dissolved in filtered water to constitute a beverage. Final beverages were filled in 300 ml glass bottles they were cooled and served cold (4° C.). The beverages were evaluated blindly by six panelists. Samples were coded and randomly presented to the panelists. Panelists were instructed to eat an unsalted cracker and rinse the mouth with water before and in between the samples. For each sample, panelists were instructed to taste, then write down their evaluation comments for paired comparison (sweet intensity, sweet linger, bitter, saltiness, mouthfeel sugar like and overall liking) with 1 as high and 2 as low.

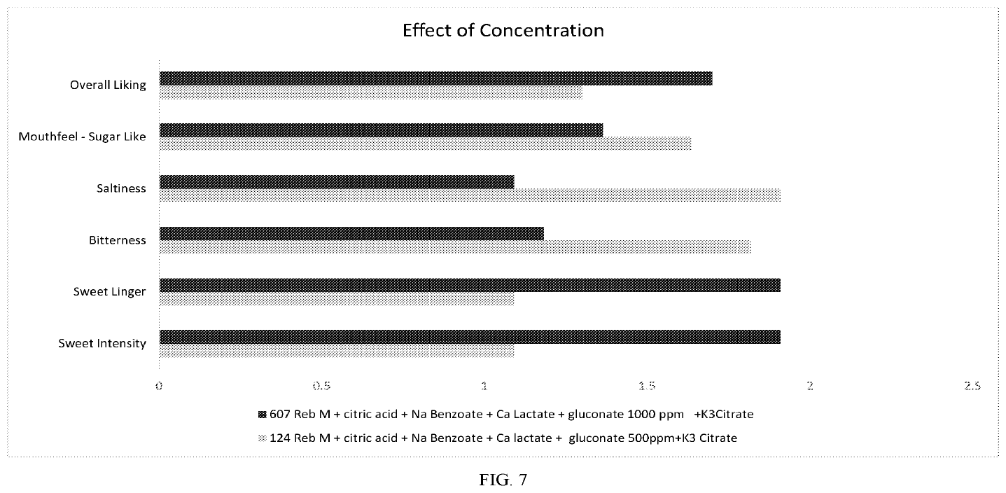

The results are shown in FIG. 7. Samples with higher C2-C9 organic acid salt concentration had more mouthfeel were also higher in saltiness and bitterness. The sample containing 500 ppm calcium lactate+calcium gluconate (1.5 mM) was ranked higher in overall liking than the sample containing 1000 ppm calcium lactate+calcium gluconate (3.0 mM).

### Example 6: Salts with Single, Double and Triple Anions

The effect of C2-C9 organic acids salts (i) calcium lactate, (ii) calcium gluconate, (iii) calcium citrate, (iv) calcium lactate+calcium gluconate, and (v) calcium citrate+calcium lactate+calcium gluconate were evaluated in zero-calorie beverages sweetened with rebaudioside M in a CAB-K matrix. A full sugar control was also evaluated. Beverages were prepared with the ingredients and amounts in the following table:

TABLE 7A

| | | | | | Test 1 | Test 2 | | | |
|---|---|---|---|---|---|---|---|---|---|
| | | | | | Reb M | Reb M | | | |
| | | | | | with Mg | with Ca | | | |
| | | | | | Citrate, | Citrate, | | | |
| Ingredients | Full | Reb M | Reb M | Reb M | Lactate, | Lactate, | | | |
| g/liter | Sugar | Control | Ex 7 | Ex10.2 | Gluconate | Gluconate | ppm | mM | mOsm. |
| Tripotassium | 0.3 | 0.3 | 0.3 | 0.3 | 0.3 | 0.3 | 300 | 0.98 | 3.9 |
| Citrate | | | | | | | | | |
| Sodium | 0.185 | 0.185 | 0.185 | 0.185 | 0.185 | 0.185 | | | |
| Benzoate | | | | | | | | | |
| Citric acid | 1.5 | 1.5 | 1.5 | 1.5 | 1.5 | 1.5 | | | |
| Sucrose | 100 g | | | | | | | | |
| Reb M | | 0.5 | 0.5 | 0.5 | 0.5 | 0.5 | | | |
| KCl | | | 0.7467 | | | | 746.7 | 10 | 20 |
| MgCl₂ | | | 0.6067 | 2.54 | | | 606.7/2540 | 3/12.5 | 8.96/37.5 |
| Hexahydrate | | | | | | | | | |
| CaCI2 | | | 0.333 | 1.385 | | | 333.3/1385 | 3/12.5 | 9/37.4 |
| Tri- | | | | | 0.45 | | 451.113 | 1 | 5 |
| magnesium | | | | | | | | | |
| citrate | | | | | | | | | |
| Mg Lactate | | | | | 0.202 | | 202.45 | 1 | 3 |
| dihydrate | | | | | | | | | |
| Mg | | | | | 0.653 | | 653 | 1 | 3 |
| (Gluconate)₂ | | | | | | | | | |

TABLE 7B

| | Test 3 | | | | | | | |
|---|---|---|---|---|---|---|---|---|
| | Reb M | Test 5 | Test 6 | Test 6 | Test 7 | | | |
| | with Ca | Reb M | Reb M | Reb M | Reb M | | | |
| Ingredients | Lactate, | with Mg | with Ca | with Ca | with Ca | | | |
| g/liter | Gluconate | Lactate | Lactate | Gluconate | Citrate | ppm | mM | mOsm. |
| Tripotassium | 0.3 | 0.3 | 0.3 | 0.3 | 0.3 | 300 | 0.98 | 3.9 |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Sucrose | | | | | | | | |
| Reb M | 0.5 | 0.5 | 0.5 | 0.5 | 0.5 | | | |
| Calcium | 0.973 | | | | | 973 | 3 | 18 |
| lactate + | | | | | | | | |
| calcium | | | | | | | | |
| gluconate | | | | | | | | |
| Mg Lactate | | 0.60735 | | | | 607 | 3 | 9 |
| dihydrate | | | | | | | | |
| Calcium | | | 0.6545 | | | 655 | 3 | 9 |
| lactate | | | | | | | | |
| pentahydrate | | | | | | | | |
| Calcium | | | | 1.29 | | 1291 | 3 | 9 |
| gluconate | | | | | | | | |
| monohydrate | | | | | | | | |
| Tri-calcium | | | | | 1.495 | 1495.38 | 3 | 15 |
| citrate | | | | | | | | |
| tetrahydrate | | | | | | | | |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, mouthfeel-body syrupiness, mouthfeel body-viscosity, sugar like mouthfeel, astringency, sourness, saltiness, overall sugar like and overall flavor) on a 10-point scale with 1 as low and 10 as high.

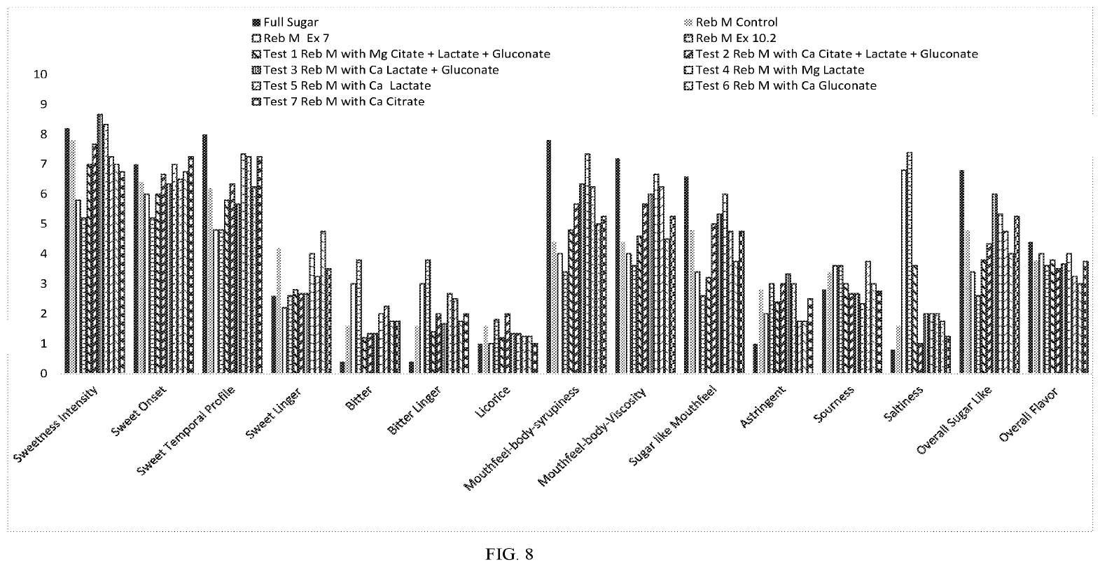

The results are show in FIG. 8. In some instances, beverages containing salts having two or three salts perform better.

### Example 7: Calcium Salts with Two or Three Different Anions

The effect of a mixture of calcium C2-C9 organic acid salts with two different anions (lactate and gluconate) or three different anions (lactate, gluconate, and citrate) in zero-calorie CAB-K beverages sweetened with rebaudioside M was evaluated. The beverages were prepared with the ingredients and amounts in the following table:

TABLE 8

| Ingredients | | | | | |
|---|---|---|---|---|---|
| g/liter | Test 1 | Test 2 | ppm | mM | mOsm. |
| Tripotassium | 0.3 | 0.3 | 0.3 | 0.98 | 3.9 |
| Citrate | | | | | |
| Sodium | 0.185 | 0.185 | | | |
| Benzoate | | | | | |
| Citric acid | 1.5 | 1.5 | | | |
| Reb M | 0.472 | 0.472 | | | |
| Calcium | 0.972 | | 972 | 3 | 8 |
| lactate + | | | | | |
| calcium | | | | | |
| gluconate | | | | | |
| Tri-calcium | | 0.4986 | 498.46 | 1 | 5 |
| citrate | | | | | |
| tetrahydrate | | | | | |
| Calcium | | 0.21822 | 218.22 | 1 | 3 |
| lactate | | | | | |
| pentahydrate | | | | | |
| Calcium | | 0.43 | 430.373 | 1 | 3 |
| gluconate | | | | | |
| monohydrate | | | | | |

The ingredients were dissolved in filtered water to constitute a beverage. Final beverages were filled in 300 ml glass bottles they were cooled and served cold (4° C.). The beverages were evaluated blindly by six panelists. Samples were coded and randomly presented to the panelists. Panelists were instructed to eat an unsalted cracker and rinse the mouth with water before and in between the samples. For each sample, panelists were instructed to taste, then write down their evaluation comments for paired comparison for (Sweet intensity, sweet linger, bitter, saltiness, mouthfeel sugar like and overall liking) 1 as high and 2 as low.

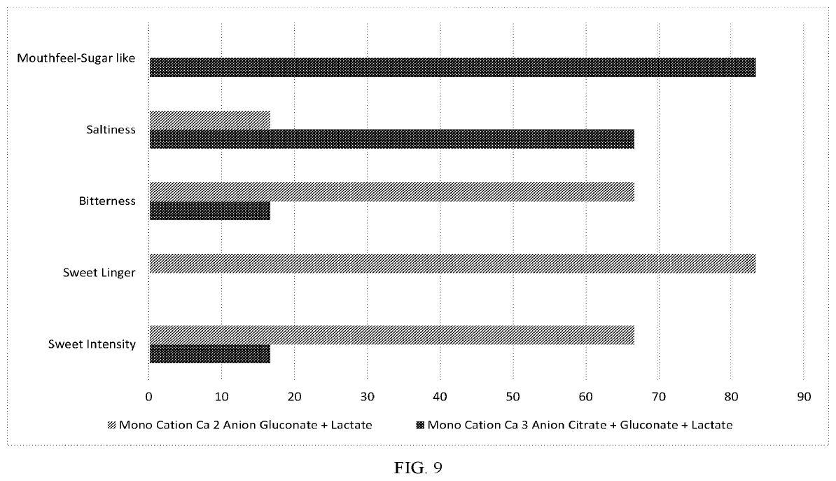

The results are shown in FIG. 9. The samples with calcium lactate+calcium gluconate showed higher sweet intensity compared to samples with calcium lactate+calcium gluconate+calcium citrate. The latter was higher in mouthfeel.

### Example 8: Magnesium Salts Vs Calcium Salts

The relative effect of calcium or magnesium C2-C9 organic acid salt mixtures with three different anions (lactate, gluconate, and citrate) in zero-calorie CAB-K beverages sweetened with rebaudioside M were evaluated. The relative effect of calcium or magnesium C2-C9 organic acid salts with a single anion (lactate) in zero-calorie CAB-K beverages sweetened with rebaudioside M were also evaluated. The beverages were prepared with the ingredients and amounts in the following table:

TABLE 9

| Ingredients | | | | | | | |
|---|---|---|---|---|---|---|---|
| g/liter | Test 1 | Test 2 | Test 5 | Test 6 | ppm | mM | mOsmoles |
| Tripotassium | 0.3 | 0.3 | 0.3 | 0.3 | 300 | 0.98 | 3.9 |
| Citrate | | | | | | | |
| Sodium | 0.185 | 0.185 | 0.185 | 0.185 | | | |
| Benzoate | | | | | | | |
| Citric acid | 1.5 | 1.5 | 1.5 | 1.5 | | | |
| Sucrose | | | | | | | |
| Reb M | 0.5 | 0.5 | 0.5 | 0.5 | | | |
| Tri-magnesium | 0.45 | | | | 451 | 1 | 5 |
| citrate | | | | | | | |
| Mg Lactate | 0.202 | | 0.6075 | | 202/608 | 1/3 | 3/9 |
| dihydrate | | | | | | | |
| Mg | 0.653 | | | | 653 | 1 | 3 |
| (Gluconate)₂ | | | | | | | |
| Tri-calcium | | 0.4986 | | | 498 | 1 | 5 |
| citrate | | | | | | | |
| tetrahydrate | | | | | | | |
| Calcium | | 0.21822 | | 0.655 | 218/655 | 0.67/2 | 4.2/12 |
| lactate | | | | | | | |
| pentahydrate | | | | | | | |
| Calcium | | 0.43 | | | 430 | 1 | 3 |
| gluconate | | | | | | | |
| monohydrate | | | | | | | |

The ingredients were dissolved in filtered water to constitute a beverage. Final beverages were filled in 300 ml glass bottles they were cooled and served cold (4° C.). The beverages were evaluated blindly by six panelists. Samples were coded and randomly presented to the panelists. Panelists were instructed to eat an unsalted cracker and rinse the mouth with water before and in between the samples. For each sample, panelists were instructed to taste, then write down their evaluation comments for paired comparison for (sweet intensity, sweet linger, bitter, saltiness, mouthfeel sugar like and overall liking) 1 as high and 2 as low.

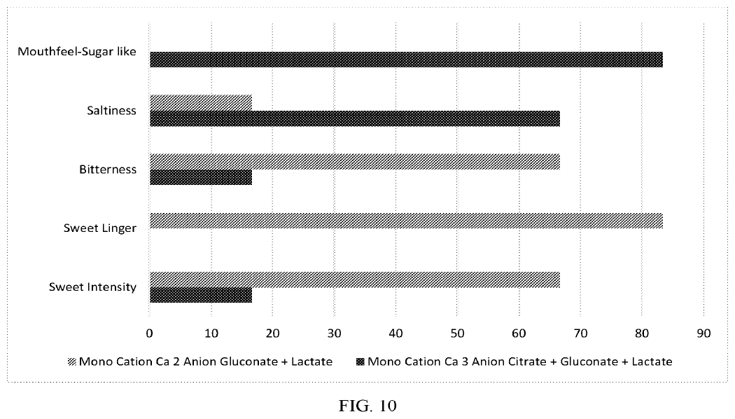

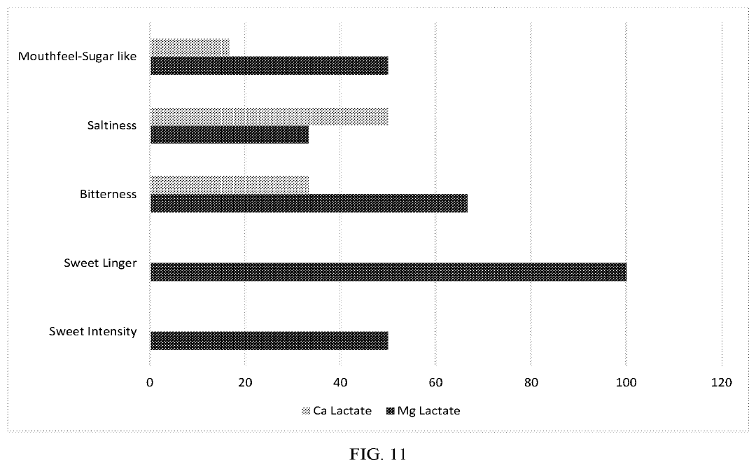

The results are shown in FIG. 10-14. For the beverages contain salt mixtures containing three different anions, the magnesium salts were higher in bitterness and sweetness linger. Samples containing calcium salts were higher in mouthfeel. For the beverages containing single salts, magnesium lactate had higher mouthfeel than calcium lactate.

### Example 9: Calcium Vs. Magnesium Salts (Single Salts)

The effect of changing the anion of calcium and magnesium salts was evaluated in zero-calorie beverages with CAB-K matrix systems sweetened with rebaudioside M. Citrate, lactate and chloride salts were compared. The beverages were prepared with the ingredients and amounts in the following table:

TABLE 10

| | | Mg | Mg | Mg | Ca | Ca | Ca | | | |
|---|---|---|---|---|---|---|---|---|---|---|
| Ingredients | Reb M | Citrate | Lactate | Chloride | Chloride | Citrate | Lactate | | | |
| g/liter | Control | 150.4 ppm | 238.5 ppm | 203 ppm | 141 ppm | 190 ppm | 308 ppm | ppm | mM | mOsm. |
| Tripotassium | 0.3/0.27 | 0.3/0.27 | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | | | |
| Citrate | | | | | | | | | | |
| Sodium | 0.185 | 0.185 | 0.185 | 0.185 | 0.185 | 0.185 | 0.185 | | | |
| Benzoate | | | | | | | | | | |
| Citric acid | 1.5 | 1.5 | 1.5 | 1.5 | 1.5 | 1.5 | 1.5 | | | |
| Reb M | 0.472 | 0.472 | 0.472 | 0.472 | 0.472 | 0.472 | 0.472 | | | |
| MgCl₂ | | | | 0.203 | | | | 203 | 1 | 3 |
| Hexahydrate | | | | | | | | | | |
| CaCl₂ | | | | | 0.141 | | | 141 | 1.27 | 3 |
| Tri-magnesium | | 0.1504 | | | | | | 150.4 | 0.33 | 1.7 |
| citrate | | | | | | | | | | |
| Mg Lactate | | | 0.2385 | | | | | 238.5 | 1.17 | 3.5 |
| dihydrate | | | | | | | | | | |
| Tri-calcium | | | | | | 0.19 | | 190 | 0.38 | 1.91 |
| citrate | | | | | | | | | | |
| tetrahydrate | | | | | | | | | | |
| Calcium | | | | | | | 0.308 | 308 | 1.4 | 4.2 |
| lactate | | | | | | | | | | |
| pentahydrate | | | | | | | | | | |

The ingredients were dissolved in filtered water to constitute a beverage. Final beverages were filled in 300 ml glass bottles they were cooled and served cold (4° C.). The beverages were evaluated blindly by three expert panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, mouthfeel, saltiness, astringent and overall flavor) on a 10-point scale with 1 as low and 10 as high.

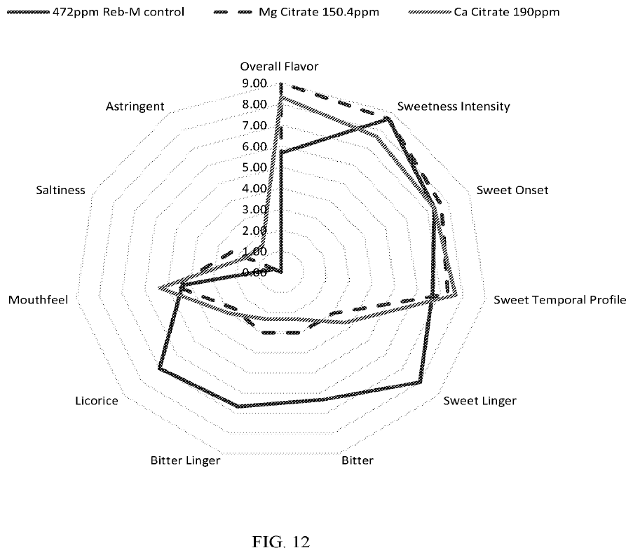

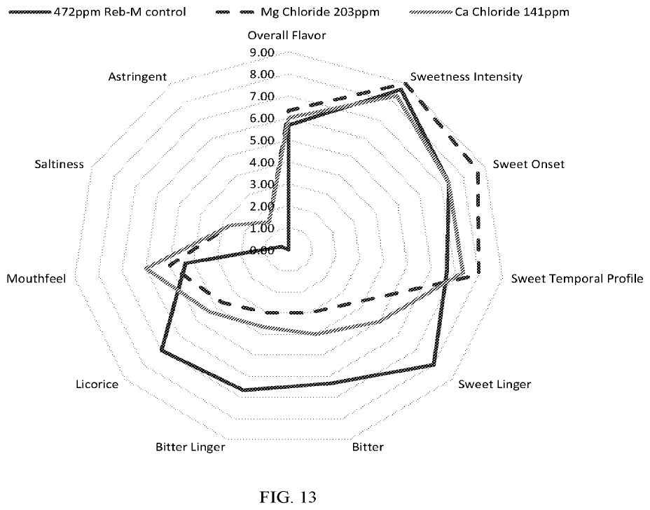

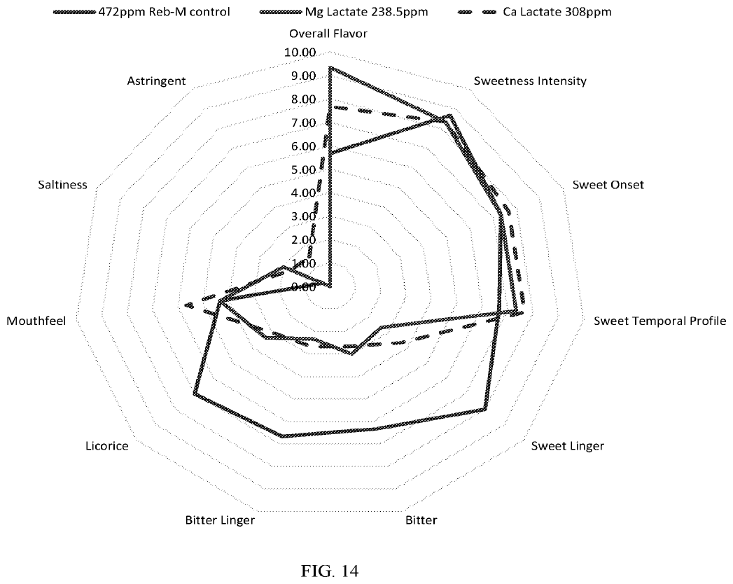

The results are shown in FIG. 2, FIG. 12, FIG. 13, FIG. 14. All samples performed better than the rebaudioside M control with no salt added. The calcium and magnesium salts performed similar although the calcium salts provided better mouthfeel than the magnesium salts depending on concentration.

### Example 10: Magnesium vs. Calcium Gluconate

Magnesium salts were evaluated for sensory modification in zero-calorie beverages with CAB-K matrix systems sweetened with rebaudioside M. A full-sugar control and rebaudioside M control were used. The beverages were prepared with the ingredients and amounts in the following table:

TABLE 11A

| | | | | | Test 1 Reb | Test 2 Reb | | | |
|---|---|---|---|---|---|---|---|---|---|
| | | | | | M with Mg | M with Ca | | | |
| | | | | | Citrate, | Citrate, | | | |
| Ingredients | Full | Reb M | Reb M | Reb M | Lactate, | Lactate, | | | |
| g/liter | Sugar | Control | Ex 7 | Ex 10.2 | Gluconate | Gluconate | ppm | mM | mOs. |
| Tripotassium | 0.3 | 0.3 | 0.3 | 0.3 | 0.3 | 0.3 | 300 | 0.98 | 3.9 |
| Citrate | | | | | | | | | |
| Sodium | 0.185 | 0.185 | 0.185 | 0.185 | 0.185 | 0.185 | | | |
| Benzoate | | | | | | | | | |
| Citric acid | 1.5 | 1.5 | 1.5 | 1.5 | 1.5 | 1.5 | | | |
| Sucrose | 100 g | | | | | | | | |
| Reb M | | 0.5 | 0.5 | 0.5 | 0.5 | 0.5 | | | |
| KCl | | | 0.7467 | | | | 747 | 10 | 20 |
| MgCl₂ | | | 0.6067 | 2.54 | | | 607/2540 | 3/12.5 | 9.0/37.5 |
| Hexahydrate | | | | | | | | | |
| CaCl₂ | | | 0.333 | 1.385 | | | 333/1385 | 3/12.5 | 9/37.4 |
| Tri- | | | | | 0.45 | | 451 | 1 | 5 |
| magnesium | | | | | | | | | |
| citrate | | | | | | | | | |
| Mg Lactate | | | | | 0.202 | | 202 | 1 | 3 |
| dihydrate | | | | | | | | | |
| Mg | | | | | 0.653 | | 653 | 1 | 3 |
| (Gluconate)₂ | | | | | | | | | |
| Tri-calcium | | | | | | 0.4986 | 499 | 1 | 5 |
| citrate | | | | | | | | | |
| tetrahydrate | | | | | | | | | |
| Calcium | | | | | | 0.21822 | 218 | 1 | 3 |
| lactate | | | | | | | | | |
| pentahydrate | | | | | | | | | |
| Calcium | | | | | | 0.43 | 430 | 1 | 3 |
| gluconate | | | | | | | | | |
| monohydrate | | | | | | | | | |

TABLE 11B

| | Test 3 | | | | | | | |
|---|---|---|---|---|---|---|---|---|
| | Reb M with | | | Test 6 | | | | |
| | Ca | Test 5 | Test 6 | Reb M | Test 7 | | | |
| Ingredients | Lactate, | Reb M with | Reb M with | with Ca | Reb M with | | | |
| g/liter | Gluconate | Mg Lactate | Ca Lactate | Gluconate | Ca Citrate | ppm | mM | mOsmoles |
| Tripotassium | 0.3 | 0.3 | 0.3 | 0.3 | 0.3 | 300 | 0.98 | 3.9 |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Sucrose | | | | | | | | |
| Reb M | 0.5 | 0.5 | 0.5 | 0.5 | 0.5 | | | |
| Calcium | 0.973 | | | | | 973 | 3 | 18 |
| lactate + | | | | | | | | |
| calcium | | | | | | | | |
| gluconate | | | | | | | | |
| Mg Lactate | | 0.60735 | | | | 607 | 3 | 9 |
| dihydrate | | | | | | | | |
| Calcium | | | 0.6545 | | | 655 | 3 | 9 |
| lactate | | | | | | | | |
| pentahydrate | | | | | | | | |
| Calcium | | | | 1.29 | | 1291 | 3 | 9 |
| gluconate | | | | | | | | |
| monohydrate | | | | | | | | |
| Tri-calcium | | | | | 1.495 | 1495 | 3 | 15 |
| citrate | | | | | | | | |
| tetrahydrate | | | | | | | | |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, mouthfeel-body syrupiness, mouthfeel body-viscosity, sugar like mouthfeel, astringency, sourness, saltiness, overall sugar like and overall flavor) on a 10-point scale with 1 as low and 10 as high.

The results are shown in FIG. 2. The samples with the magnesium salts had higher bitterness, bitter lingering and saltiness than the control samples.

### Example 11: Magnesium Vs Calcium Salts

Magnesium gluconate and calcium gluconate were compared in zero-calorie beverages with CAB-K matrix systems sweetened with rebaudioside M. Beverages were prepared with the following ingredients and amounts:

TABLE 12

| | Mock Diet | Mg | Ca |
|---|---|---|---|
| Ingredients | control | gluconate | gluconate |
| Filtered water | 99.81 | 99.785 | 99.775 |
| Sugar | — | — | — |
| Citric acid | 0.117 | 0.117 | 0.117 |
| Sodium citrate | 0.027 | 0.027 | 0.027 |
| Reb-M | 0.0472 | 0.0472 | 0.0472 |
| Magnesium | | 0.095 | |
| gluconate | | | |
| Calcium | | | 0.055 |
| gluconate | | | |
| TOTAL (grams) | 100 | 100 | 100 |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, mouthfeel-body syrupiness, mouthfeel body-viscosity, sugar like mouthfeel, astringency, sourness, saltiness, overall sugar like and overall flavor) on a 10-point scale with 1 as low and 10 as high.

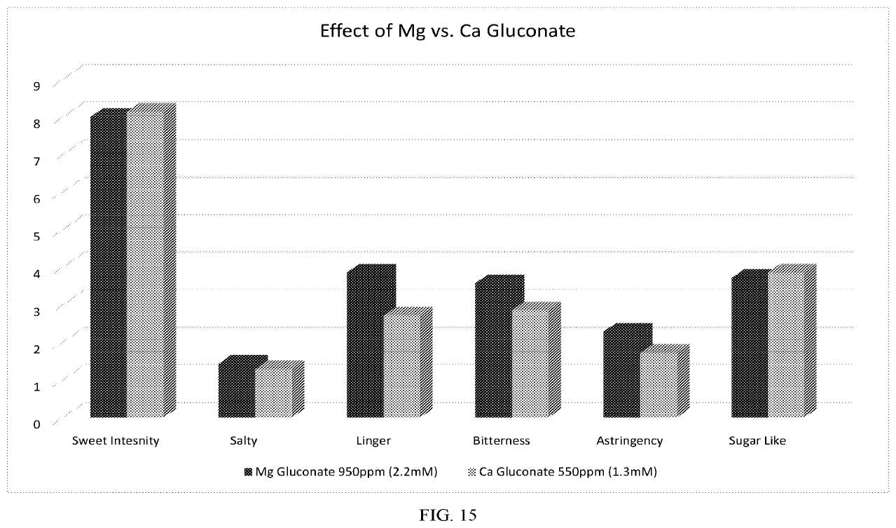

The results are shown in FIG. 15. The sample containing magnesium gluconate had higher saltiness, linger, bitterness and astringency than the sample containing calcium gluconate.

In another experiment, magnesium and calcium salts of citrate and lactate were compared in zero-calorie beverages with CAB-K matrix systems sweetened with rebaudioside M. Beverages were prepared with the following ingredients and amounts:

TABLE 13

| | | Test 1 | Test 2 | Test 3 | Test 4 | | | |
|---|---|---|---|---|---|---|---|---|
| | 472 ppm | Mg | Mg | Ca | Ca | | | |
| Ingredients | Reb M | Citrate | Lactate | Citrate | Lactate | | | |
| g/liter | Control | 150 ppm | 239 ppm | 190 ppm | 308 ppm | ppm | mM | mOsm. |
| Tripotassium | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Reb M | 0.472 | 0.472 | 0.472 | 0.472 | 0.472 | | | |
| Tri- | | 0.1504 | | | | 150.4 | 0.33 | 1.7 |
| magnesium | | | | | | | | |
| citrate | | | | | | | | |
| Mg Lactate | | | 0.2385 | | | 238.5 | 1.17 | 3.5 |
| dihydrate | | | | | | | | |
| Tri-calcium | | | | 0.19 | | 190 | 0.38 | 1.91 |
| citrate | | | | | | | | |
| tetrahydrate | | | | | | | | |
| Calcium | | | | | 0.308 | 308 | 1.4 | 4.2 |
| lactate | | | | | | | | |
| pentahydrate | | | | | | | | |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attributes (sweet intensity, sweet onset, sweet temporal profile, sweet linger, bitter, bitter linger, licorice, mouthfeel-body syrupiness, mouthfeel body-viscosity, sugar like mouthfeel, astringency, sourness, saltiness, overall sugar like and overall flavor) on a 10-point scale with 1 as low and 10 as high.

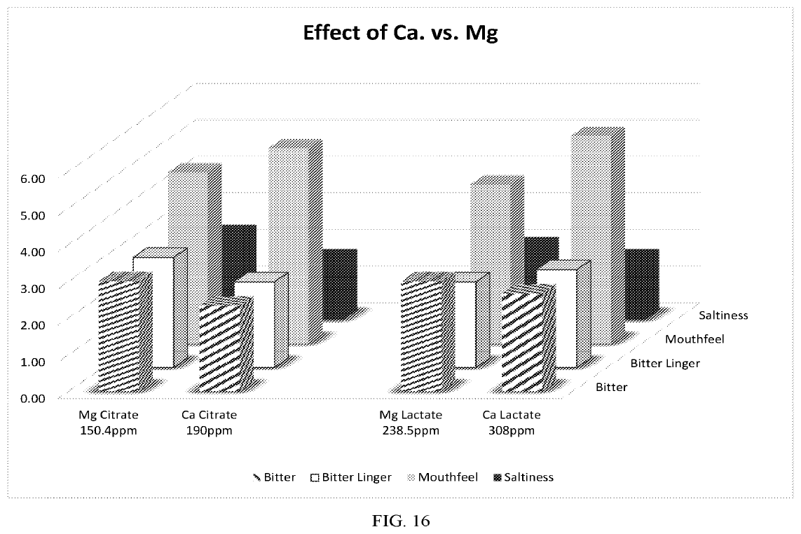

The results are shown in FIG. 16. For both the citrate and lactate salts, the magnesium salts tended to be saltier, more bitter and higher in bitter linger. The calcium salts had better mouthfeel.

### Example 12: Identity of the Cation (Sodium, Potassium, Magnesium, and Calcium)

Chloride salts of sodium, potassium, magnesium and calcium were compared with each other and with gluconate salts of sodium, potassium, magnesium and calcium. The salts were used in zero-calorie beverages with CAB-K buffer systems sweetened with rebaudioside M. Beverages were prepared with the following ingredients and amounts:

TABLE 14

| | Mock | | | | | | | | |
|---|---|---|---|---|---|---|---|---|---|
| | Diet | Test 1 | Test 2 | Test 3 | Test 4 | Test 5 | Test 6 | Test 7 | Test 8 |
| Ingredients | control | Na gluc. | Mg gluc. | Ca gluc. | K gluc. | NaCl | MgCl₂ | CaCl₂ | KCl |
| Filtered | 99.81 | 99.787 | 99.785 | 99.775 | 99.79 | 99.778 | 99.778 | 99.778 | 99.778 |
| water | | | | | | | | | |
| Sugar | — | — | — | — | — | — | — | — | — |
| Citric acid | 0.117 | 0.117 | 0.117 | 0.117 | 0.117 | 0.117 | 0.117 | 0.117 | 0.117 |
| Sodium | 0.027 | 0.027 | 0.027 | 0.027 | 0.027 | 0.027 | 0.027 | 0.027 | 0.027 |
| citrate | | | | | | | | | |
| Reb-M | 0.0472 | 0.0472 | 0.0472 | 0.0472 | 0.0472 | 0.0472 | 0.0472 | 0.0472 | 0.0472 |
| Sodium | — | 0.049 | — | — | — | — | | | |
| gluconate | | | | | | | | | |
| Magnesium | — | — | 0.095 | — | — | — | | | |
| gluconate | | | | | | | | | |
| Calcium | — | — | — | 0.055 | — | — | | | |
| gluconate | | | | | | | | | |
| Potassium | — | — | — | — | 0.031 | — | | | |
| gluconate | | | | | | | | | |
| Sodium | | | | | | 0.013 | | | |
| chloride | | | | | | | | | |
| Magnesium | | | | | | | 0.02 | | |
| chloride | | | | | | | | | |
| Calcium | | | | | | | | 0.0142 | |
| chloride | | | | | | | | | |
| Potassium | | | | | | | | | 0.0098 |
| chloride | | | | | | | | | |
| TOTAL | 100 | 100 | 100 | 100 | 100 | 100 | 100 | 100 | 100 |
| (grams) | | | | | | | | | |

The ingredients were dissolved in filtered water to constitute a beverage. Final beverages were filled in 300 ml glass bottles they were cooled and served cold (4° C.). The beverages were evaluated blindly by seven panelists. Samples were coded and randomly presented to the panelists. Panelists were instructed to eat an unsalted cracker and rinse the mouth with water before and in between the samples. For each sample, panelists were instructed to taste, then write down their evaluation comments for ranking each attributes (sweet intensity, sweet linger, bitter, sugar like mouthfeel, astringency, saltiness) on a 10-point scale with 1 as low and 10 as high.

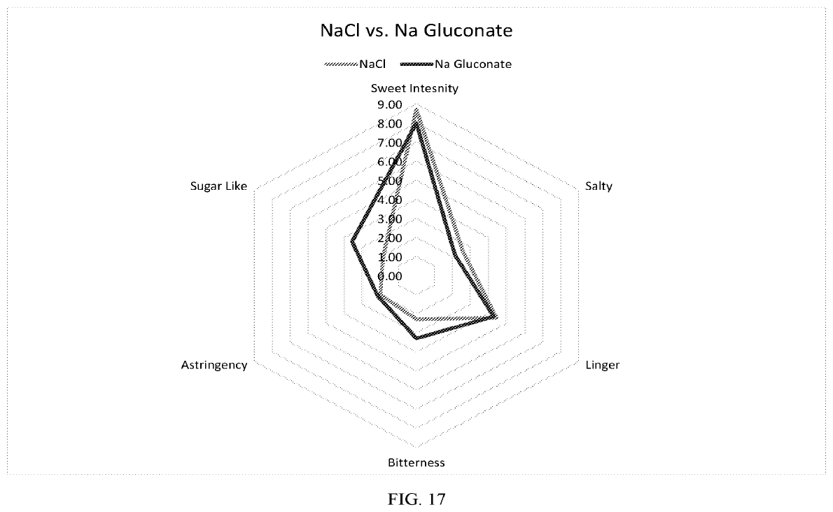

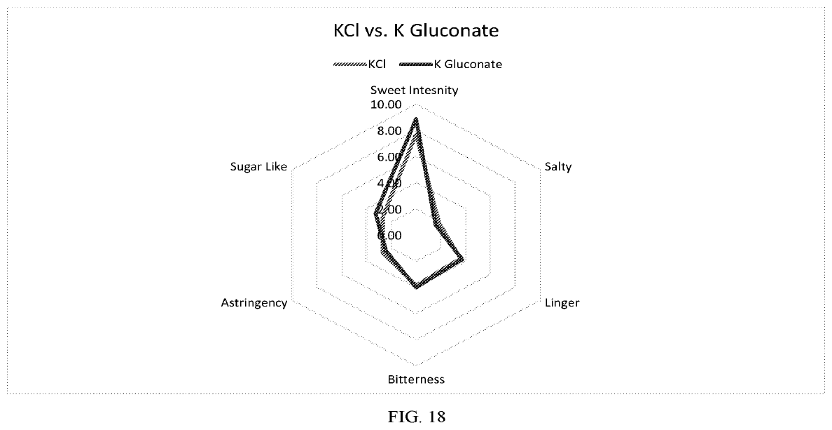

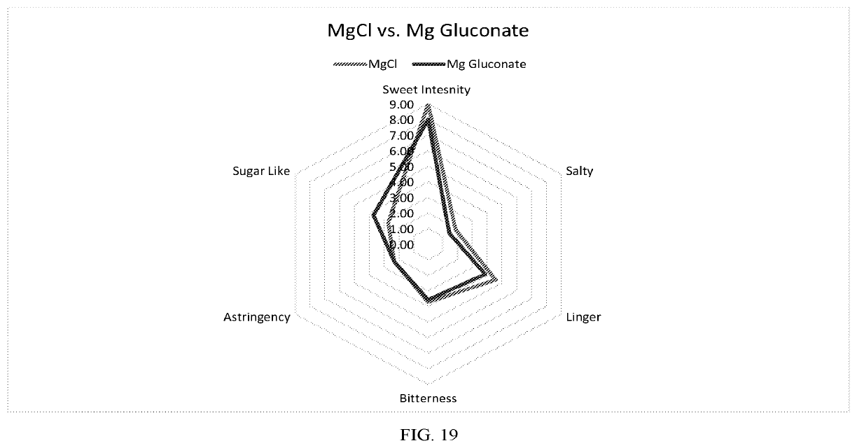

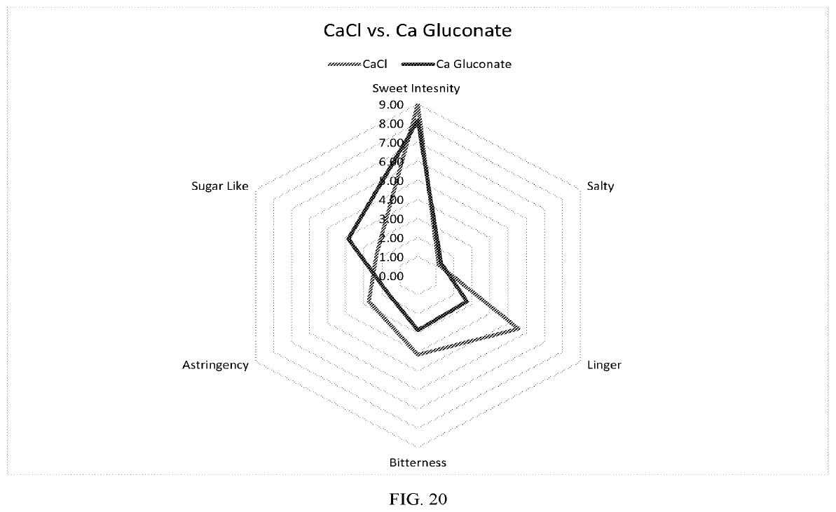

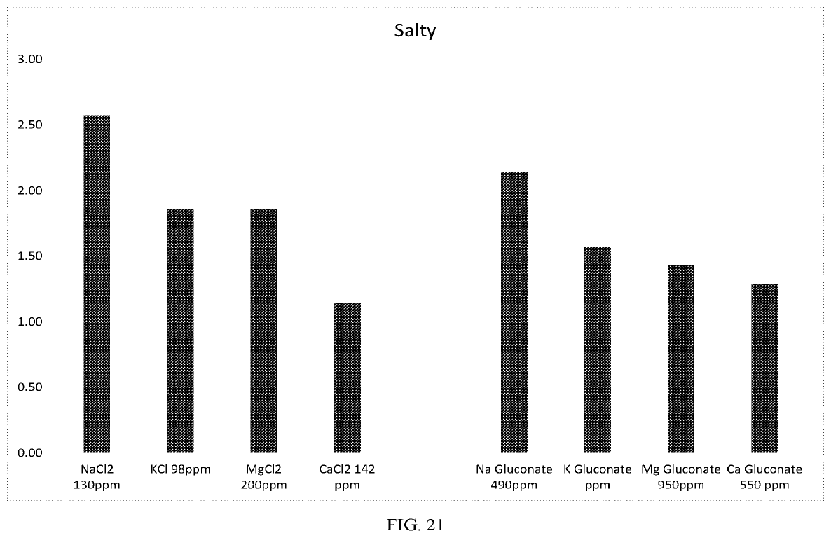

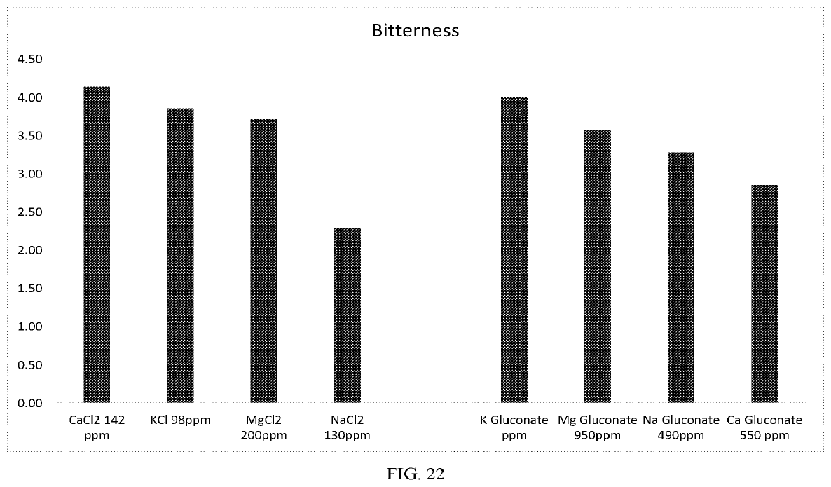

The results are shown in FIG. 17-22. The gluconate salts, overall, were less salty and bitter compared to the chloride salts. Sodium salts were the saltiest among the chloride and gluconate salts, followed by potassium, magnesium and calcium. Potassium was the most bitter gluconate salt, followed by magnesium, sodium and calcium.

### Example 13: Identity of the Anion

Calcium salts of chloride, citrate, lactate and gluconate were compared in zero-calorie beverages with CAB-K matrix systems sweetened with rebaudioside M. A control without salts was used. Beverages were prepared with the following ingredients and amounts:

TABLE 15A

| | | | | | | Test 5 | | | |
|---|---|---|---|---|---|---|---|---|---|
| | 472 | Test 1 | Test 2 | Test 3 | Test 4 | Ca | | | |
| | ppm | Na | Mg | Mg | Mg | Lactate, | | | |
| Ingredients | Reb M | Gluconate | Citrate | Lactate | Chloride | Gluconate | | | |
| g/liter | Control | 218.14 ppm | 150.4 ppm | 238.5 ppm | 203 ppm | 334 ppm | ppm | mM | mOsm. |
| Tripotassium | 0.3/0.27 | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | | |
| Citrate | | | | | | | | | |
| Sodium | 0.185 | 0.185 | 0.185 | 0.185 | 0.185 | 0.185 | | | |
| Benzoate | | | | | | | | | |
| Citric acid | 1.5 | 1.5 | 1.5 | 1.5 | 1.5 | 1.5 | | | |
| Reb M | 0.472 | 0.472 | 0.472 | 0.472 | 0.472 | 0.472 | | | |
| MgCl₂ | | | | | 0.203 | | 203 | 1 | 3 |
| Hexahydrate | | | | | | | | | |
| Tri- | | | 0.1504 | | | | 150.4 | 0.33 | 1.7 |
| magnesium | | | | | | | | | |
| citrate | | | | | | | | | |
| Mg Lactate | | | | 0.2385 | | | 238.5 | 1.17 | 3.5 |
| dihydrate | | | | | | | | | |
| Calcium | | | | | | 0.334 | 334 | 1 | 6 |
| lactate + | | | | | | | | | |
| calcium | | | | | | | | | |
| gluconate | | | | | | | | | |

TABLE 15B

| | Test 6 | Test 7 | Test 8 | | | |
|---|---|---|---|---|---|---|
| Ingredients | Ca Chloride | Ca Citrate | Ca Lactate | | | |
| g/liter | 141 ppm | 190 ppm | 308 ppm | ppm | mM | mOsmoles |
| Tripotassium | 0.3/0.27 | 0.3/0.27 | 0.3/0.27 | 300/270 | 0.98/1 | 3.9/4.2 |
| Citrate/Sodium | | | | | | |
| Citrate | | | | | | |
| Sodium Benzoate | 0.185 | 0.185 | 0.185 | | | |
| Citric acid | 1.5 | 1.5 | 1.5 | | | |
| Reb M | 0.472 | 0.472 | 0.472 | | | |
| CaCl₂ | 0.141 | | | 141 | 1.27 | 3 |
| Tri-calcium | | 0.19 | | 190 | 0.38 | 1.91 |
| citrate tetrahydrate | | | | | | |
| Calcium | | | 0.308 | 308 | 1.4 | 4.2 |
| lactate pentahydrate | | | | | | |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to taste, then write down their evaluation comments for rating each attribute (sweet intensity, sweet onset, sweet temporal profile, sweet linger, bitter, bitter linger, licorice, mouthfeel, saltiness, astringent and overall flavor) on a 10-point scale with 1 as low and 10 as high.

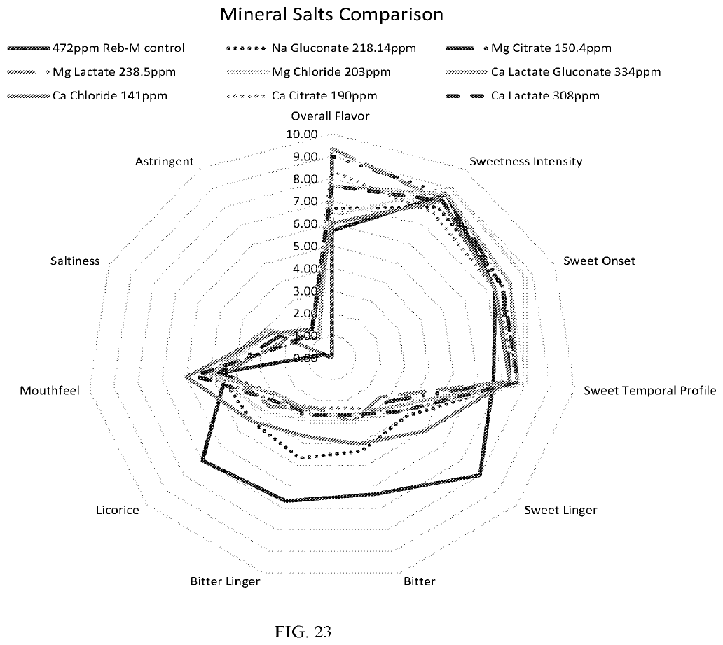

The results are shown in FIG. 23. The samples containing calcium salts with organic ions outperformed the samples containing calcium chloride (overall flavor and mouthfeel). Calcium chloride was found to be higher in licorice, bitterness and bitter linger.

### Example 14: Calcium Salts of Organic Anions

The effect of various calcium salts was evaluated in zero-calorie beverages with CAB-K matrix systems sweetened with rebaudioside M. A full-sugar control and rebaudioside M control (without salts) were used. Beverages were prepared with the following ingredients and amounts:

TABLE 16A

| | | | Test 2 | | | | | |
|---|---|---|---|---|---|---|---|---|
| | | | Reb M | Test 3 | Test 6 | | | |
| | | | with Ca | Reb M | Reb M | | | |
| | | | Citrate, | with Ca | with | | | |
| Ingredients | Full | Reb M | Lactate, | Lactate, | Ca | | | |
| g/liter | Sugar | Control | Gluconate | Gluconate | Lactate | ppm | mM | mOsm. |
| Tripotassium | 0.3 | 0.3 | 0.3 | 0.3 | 0.3 | 300 | 0.97913 | 3.92 |
| Citrate | | | | | | | | |
| Sodium | 0.185 | 0.185 | 0.185 | 0.185 | 0.185 | | | |
| Benzoate | | | | | | | | |
| Citric acid | 1.5 | 1.5 | 1.5 | 1.5 | 1.5 | | | |
| Sucrose | 100 g | | | | | | | |
| Reb M | | 0.5 | 0.5 | 0.5 | 0.5 | | | |
| Tri-calcium | | | 0.4986 | | | 498.46 | 1 | 5 |
| citrate | | | | | | | | |
| tetrahydrate | | | | | | | | |
| Calcium | | | 0.21822 | | | 218.22 | 1 | 3 |
| lactate | | | | | | | | |
| pentahydrate | | | | | | | | |
| Calcium | | | 0.43 | | | 430.373 | 1 | 3 |
| gluconate | | | | | | | | |
| monohydrate | | | | | | | | |
| Calcium | | | | 0.973 | | 972.9 | 3 | 18 |
| lactate + | | | | | | | | |
| calcium | | | | | | | | |
| gluconate | | | | | | | | |
| Calcium | | | | | 0.6545 | 654.66 | 3 | 9 |
| lactate | | | | | | | | |
| pentahydrate | | | | | | | | |
| Calcium | | | | | | 1291.119 | 3 | 9 |
| gluconate | | | | | | | | |
| monohydrate | | | | | | | | |
| Tri-calcium | | | | | | 1495.38 | 3 | 15 |
| citrate | | | | | | | | |
| tetrahydrate | | | | | | | | |

TABLE 16B

| | Test 6 | Test 7 | | | |
|---|---|---|---|---|---|
| | Reb M | Reb M | | | |
| Ingredients | with Ca | with Ca | | | |
| g/liter | Gluconate | Citrate | ppm | mM | mOsm. |
| Tripotassium | 0.3 | 0.3 | 300 | 0.98 | 3.9 |
| Citrate | | | | | |
| Sodium | 0.185 | 0.185 | | | |
| Benzoate | | | | | |
| Citric acid | 1.5 | 1.5 | | | |
| Sucrose | | | | | |
| Reb M | 0.5 | 0.5 | | | |
| Tri-calcium | | | 498.46 | 1 | 5 |
| citrate | | | | | |
| tetrahydrate | | | | | |
| Calcium lactate | | | 218.22 | 1 | 3 |
| pentahydrate | | | | | |
| Calcium | | | 430.373 | 1 | 3 |
| gluconate | | | | | |
| monohydrate | | | | | |
| Calcium | | | 972.9 | 3 | 18 |
| lactate + | | | | | |
| calcium | | | | | |
| gluconate | | | | | |
| Calcium lactate | | | 654.66 | 3 | 9 |
| pentahydrate | | | | | |
| Calcium | 1.29 | | 1291.119 | 3 | 9 |
| gluconate | | | | | |
| monohydrate | | | | | |
| Tri-calcium | | 1.495 | 1495.38 | 3 | 15 |
| citrate | | | | | |
| tetrahydrate | | | | | |

The ingredients were dissolved in filtered water to constitute a beverage. Final beverages were filled in 300 ml glass bottles they were cooled and served cold (4° C.). The beverages were evaluated blindly by three panelists. Samples were coded and randomly presented to the panelists. Panelists were instructed to eat an unsalted cracker and rinse the mouth with water before and in between the samples. For each sample, panelists were instructed to take 3 sips, then write down their evaluation comments for rating each attribute (sweet intensity, sweet linger, overall sugar like and overall liking) on a 10-point scale with 1 as low and 10 as high.

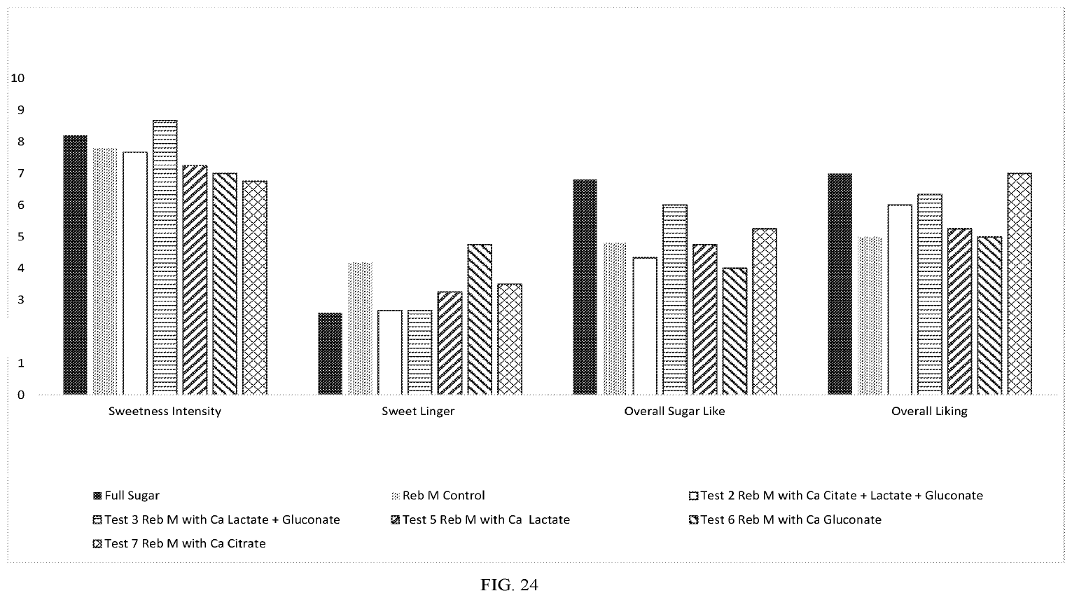

The results are shown in FIG. 24. The sample with calcium lactate+calcium gluconate provided higher sweetness intensity, less sweetness linger, best overall sugar like taste and best overall liking compared to the other salts.

### Example 15: Buffer Effects

The impact of CAB-K, commonly used in beverages, on various sensory properties was evaluated in zero-calorie beverages sweetened with rebaudioside M. Beverages were prepared with the following ingredients and amounts:

TABLE 17

| | | Reb M + | | | |
|---|---|---|---|---|---|
| | | Citric | | | |
| | Reb M + | acid + Na | | | |
| | Citric | Benzoate + | | | |
| Ingredients | acid + Na | Tripotassium | | | |
| g/liter | Benzoate | Citrate | ppm | mM | mOsmoles |
| Tripotassium | | 0.3 | 300 | 0.98 | 3.92 |
| Citrate | | | | | |
| Sodium | 0.185 | 0.185 | | | |
| Benzoate | | | | | |
| Citric acid | 1.5 | 1.5 | | | |
| Reb M | 0.472 | 0.472 | | | |

The ingredients were dissolved in filtered water to constitute a beverage. Final beverages were filled in 300 ml glass bottles they were cooled and served cold (4° C.). The beverages were evaluated blindly by eleven panelists. Samples were coded and randomly presented to the panelists. Panelists were instructed to eat an unsalted cracker and rinse the mouth with water before and in between the samples. For each sample, panelists were instructed to take 3 sips, then write down their evaluation comments for paired comparison for (sweet intensity, sweet linger, bitter, saltiness, mouthfeel sugar like and overall liking) 1 as high and 2 as low.

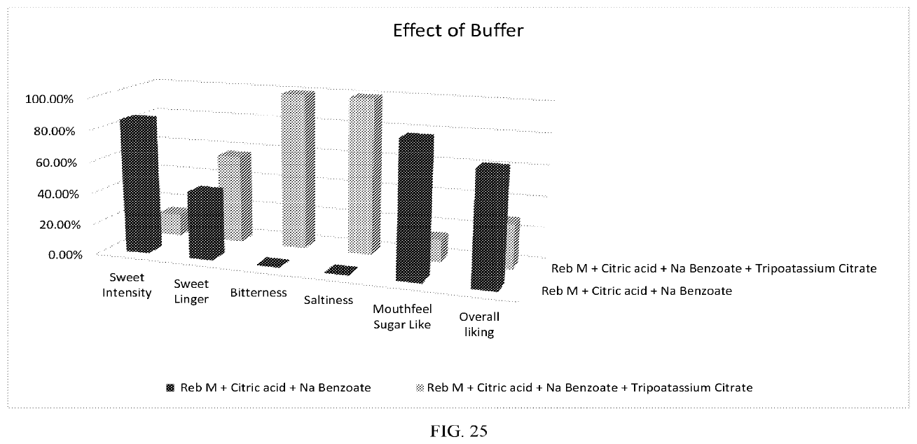

The results are shown in FIG. 25. CAB-K contributes to saltiness and bitterness but does not provide significant mouthfeel at 300 ppm (˜1 mM).

### Example 16: pH Effects

The impact of various salts on pH of beverages with CAB-K matrix systems sweetened with rebaudioside M was evaluated. A rebaudioside M control was used. Beverages were prepared with the following ingredients and amounts:

TABLE 18A

| | 472 ppm | | | | | | | | |
|---|---|---|---|---|---|---|---|---|---|
| Ingredients | Reb M | | | | | | | | |
| g/liter | Control | Test 1 | Test 2 | Test 3 | Test 4 | Test 5 | ppm | mM | mOsm. |
| Tripotassium | 0.3/0.27 | 0.3/0.27 | 0.3/0.27 | 0.3/0.27 | 0.3/0.27 | 0.3/0.27 | 300/270 | 0.98/1 | 3.9/4.2 |
| Citrate/Sodium | | | | | | | | | |
| Citrate | | | | | | | | | |
| Sodium | 0.185 | 0.185 | 0.185 | 0.185 | 0.185 | 0.185 | | | |
| Benzoate | | | | | | | | | |
| Citric acid | 1.5 | 1.5 | 1.5 | 1.5 | 1.5 | 1.5 | | | |
| Reb M | 0.472 | 0.472 | 0.472 | 0.472 | 0.472 | 0.472 | | | |
| Na gluconate | | 0.21814 | | | | | 218.14 | 1 | 2 |
| MgCl₂ | | | | | 0.203 | | 203 | 1 | 3 |
| Hexahydrate | | | | | | | | | |
| Tri-magnesium | | | 0.1504 | | | | 150.4 | 0.33 | 1.7 |
| citrate | | | | | | | | | |
| Mg Lactate | | | | 0.2385 | | | 238.5 | 1.17 | 3.5 |
| dihydrate | | | | | | | | | |
| Calcium lactate + | | | | | | 0.334 | 334 | 1 | 6 |
| calcium | | | | | | | | | |
| gluconate | | | | | | | | | |

Test 1 = Na Gluconate 218.14 ppm
Test 2 = Mg Citrate 150.4 ppm
Test 3 = Mg lactate 238.5 ppm
Test 4 = Mg chloride 203 ppm
Test 5 = Ca Lactate, Gluconate 334 ppm

TABLE 18B

| | Test 6 | Test 7 | Test 8 | | | |
|---|---|---|---|---|---|---|
| Ingredients | Ca Chloride | Ca Citrate | Ca Lactate | | | |
| g/liter | 141 ppm | 190 ppm | 308 ppm | ppm | mM | mOsmoles |
| Tripotassium | 0.3/0.27 | 0.3/0.27 | 0.3/0.27 | 300/270 | 0.98/1 | 3.9/4.2 |
| Citrate/Sodium | | | | | | |
| Citrate | | | | | | |
| Sodium Benzoate | 0.185 | 0.185 | 0.185 | | | |
| Citric acid | 1.5 | 1.5 | 1.5 | | | |
| Reb M | 0.472 | 0.472 | 0.472 | | | |
| CaCl₂ | 0.141 | | | 141 | 1.27 | 3 |
| Tri-calcium | | 0.19 | | 190 | 0.38 | 1.91 |
| citrate tetrahydrate | | | | | | |
| Calcium lactate | | | 0.308 | 308 | 1.4 | 4.2 |
| pentahydrate | | | | | | |
| Calcium lactate + | | | | 334 | 1 | 6 |
| calcium gluconate | | | | | | |

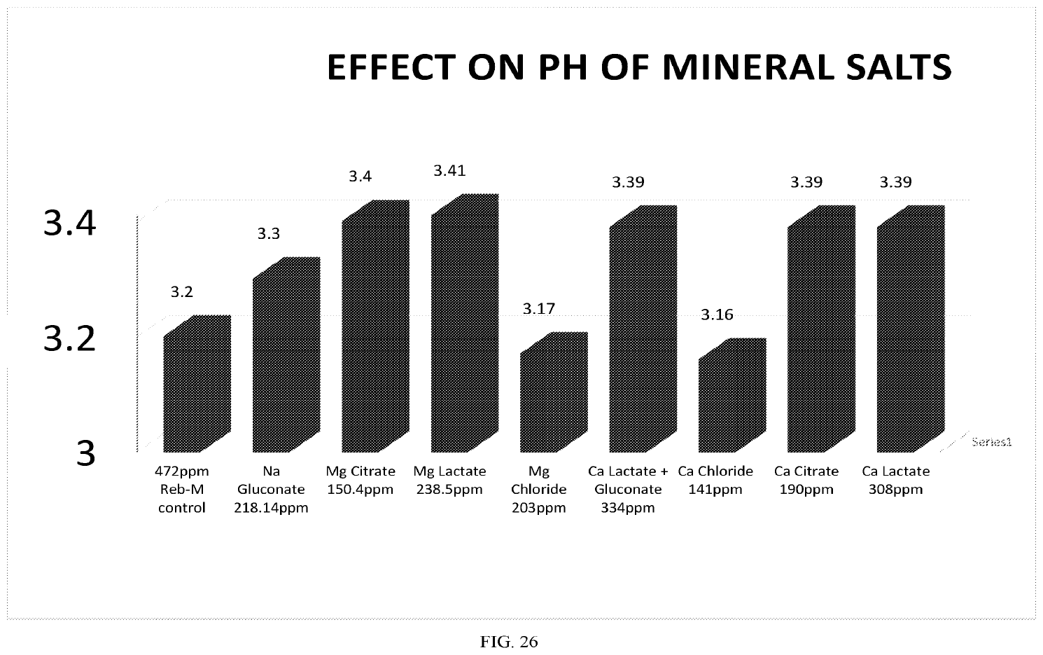

The pH was then measured. The results are shown in FIG. 26. While the magnesium chloride and calcium chloride salts slightly reduced the pH compared to the control, the sodium, magnesium, and calcium organic salts exhibited higher pHs compared to the control (0.1-0.21).

### Example 17: Improvement with TagTatose

A commercial Fanta® beverage sweetened with sugar was compared to three 68% sugar reduction formulations sweetened with sucrose (4.6 Brix), sucralose, and acesulfame K. Formulation 2 contained no additional carbohydrate. Formula 3 contained allulose and erythritol (both at 1 wt %), and Formulation 4 contained 2 wt % tagatose. Beverages were prepared with the following ingredients and amounts:

TABLE 19

| | | Test | Test | Test | Test |
|---|---|---|---|---|---|
| | | Sample | Sample | Sample | Sample |
| INGRE- | Control | 1 | 2 | 3 | 4 |
| DIENTS | (g/100 g) | (g/100 g) | (g/100 g) | (g/100 g) | (g/100 g) |
| Water | 85.048 | 94.84 | 92.84 | 92.84 | 91.84 |
| Sucrose | 14.47 | 4.6 | 4.6 | 4.6 | 4.6 |
| Citric acid | 0.1515 | 0.1515 | 0.1515 | 0.1515 | 0.1515 |
| Ascorbic acid | 0.01 | 0.01 | 0.01 | 0.01 | 0.01 |
| Calcium | 0.004 | 0.004 | 0.004 | 0.004 | 0.004 |
| disodium | | | | | |
| EDTA | | | | | |
| Sodium | 0.0225 | 0.0225 | 0.0225 | 0.0225 | 0.0225 |
| benzoate | | | | | |
| FD&C | 0.0048 | 0.0048 | 0.0048 | 0.0048 | 0.0048 |
| Yellow #6 | | | | | |
| Magnesium | — | 0.0435 | 0.0435 | 0.0435 | 0.0435 |
| lactate | | | | | |
| dihydrate | | | | | |
| Tri-calcium | — | 0.015 | 0.015 | 0.015 | 0.015 |
| citrate | | | | | |
| tetrahydrate | | | | | |
| Sucralose | — | 0.0182 | 0.0182 | 0.0182 | 0.0182 |
| Acesulfame | — | 0.0018 | 0.0018 | 0.0018 | 0.0018 |
| potassium | | | | | |
| Orange flavor | 0.289 | 0.289 | 0.289 | 0.289 | 0.289 |
| Allulose(1%)/ | | | 2% | — | |
| Erythritol(1%) | | | (1% + 1%) | | |
| Tagatose | | | — | | 2 |
| TOTAL | 100 | 100 | 100 | 100 | 100 |

The ingredients were dissolved in filtered water to constitute a syrup, then the final beverage was made by weighing the appropriate syrup amount and adding carbonated water using a ratio of 1-part syrup+4.4 parts carbonated water to target a carbonation of 2.8 volumes of CO2. Final beverages were filled in 300 ml glass bottles then aged for 3 days at 35° C. before they were cooled and served cold (4° C.). Titratable acidity was 0.15% w/v as citric acid. The beverages were evaluated blindly by six panelists. Samples were coded and randomly presented to the panelists. Panelists were instructed to eat an unsalted cracker and rinse the mouth with water before and in between the samples. For each sample, panelists were instructed to take 3 sips, then write down their evaluation comments for ranking each attribute (sugar like taste) on a 4-point scale with 1 as low and 4 as high.

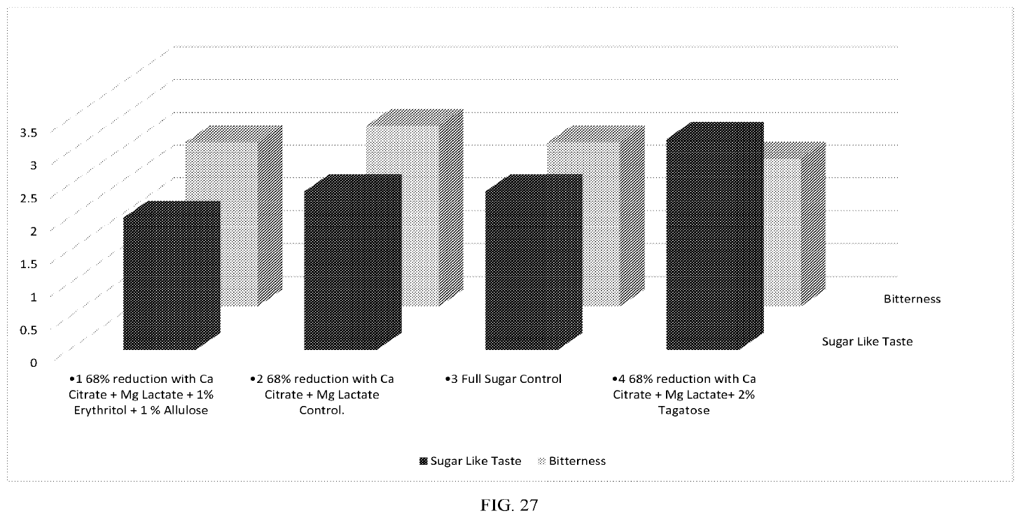

The results are shown in FIG. 27. The formulation with 2 wt % tagatose had the highest ranking for sugar-like taste.

### Example 18: Naringin Dihydrochalcone and Salts

The effects of the additional taste modifying substance naringin dihydrochalcone (NDC) was also evaluated. Reduced calorie 5 Brix beverages were prepared with the following ingredients and amounts:

TABLE 20

| | | Test | | Test Sample 3 | Test Sample 3 |
|---|---|---|---|---|---|
| | 5BRIX | Sample 1 | | 5 ppm Naringin | 2.5 ppm Naringin |
| | Orange | 500 ppm | Test | Dihydrochalcone + | Dihydrochalcone + |
| | Carbonated | Calcium | Sample 2 | 500 ppm | 500 ppm |
| | Beverage | Lactate, | 5 ppm Naringin | Calcium Lactate, | Calcium Lactate, |
| | Control | Gluconate | Dihydrochalcone | Gluconate | Gluconate |
| INGREDIENTS | (g/100 g) | (g/100 g) | (g/100 g) | (g/100 g) | (g/100 g) |
| Water | 94.95 | 94.92 | 94.97 | 94.92 | 94.92 |
| Sucrose | 4.6 | 4.6 | 4.6 | 4.6 | 4.6 |
| Citric acid S-651 | 0.197 | 0.197 | 0.197 | 0.197 | 0.197 |
| Tri-Sodium Citrate | 0.012 | 0.012 | 0.012 | 0.012 | 0.012 |
| Dihydrate S-826 | | | | | |
| Ascorbic acid S-827 | 0.01 | 0.01 | 0.01 | 0.01 | 0.01 |
| Sodium | 0.046 | 0.046 | 0.046 | 0.046 | 0.046 |
| Hexametaphoisphate | | | | | |
| SHMP S-8093 | | | | | |
| Calcium disodium | 0.003 | 0.003 | 0.003 | 0.003 | 0.003 |
| EDTA S-837 | | | | | |
| Potassium benzoate | 0.021 | 0.021 | 0.021 | 0.021 | 0.021 |
| S-813 | | | | | |
| FD&C Yellow #54 | 0.001 | 0.001 | 0.001 | 0.001 | 0.001 |
| S-735 | | | | | |
| FD&C Yellow #6 | 0.004 | 0.004 | 0.004 | 0.004 | 0.004 |
| S-736 | | | | | |
| fd&c Red No 40 | 0.0002 | 0.0002 | 0.0002 | 0.0002 | 0.0002 |
| S-740 | | | | | |
| Naringin | — | — | 0.005 | 0.005 | 0.0025 |
| Dihydrochalcone | | | | | |
| Calcium Lactate + | — | 0.5 | — | 0.5 | 0.5 |
| Calcium Gluconate | | | | | |
| Orange flavor | 0.289 | 0.289 | 0.289 | 0.289 | 0.289 |
| TOTAL | 100 | 100 | 100 | 100 | 100 |

The ingredients were dissolved in filtered water to constitute a syrup, then the final beverage was made by weighing the appropriate syrup amount and adding carbonated water using a ratio of 1-part syrup+4.4 parts carbonated water to target a carbonation of 2.8 volumes of CO2. Final beverages were filled in 300 ml glass bottles then aged for 3 days at 35° C. before they were cooled and served cold (4° C.). The beverages were evaluated blindly by three expert panelists. Panelists were instructed to eat an unsalted cracker and rinse the mouth with water before and in between the samples. For each sample, panelists were instructed to taste, then write down their evaluation comments for ranking for overall best performance on a 5-point scale with 1 as best and 5 as worst.

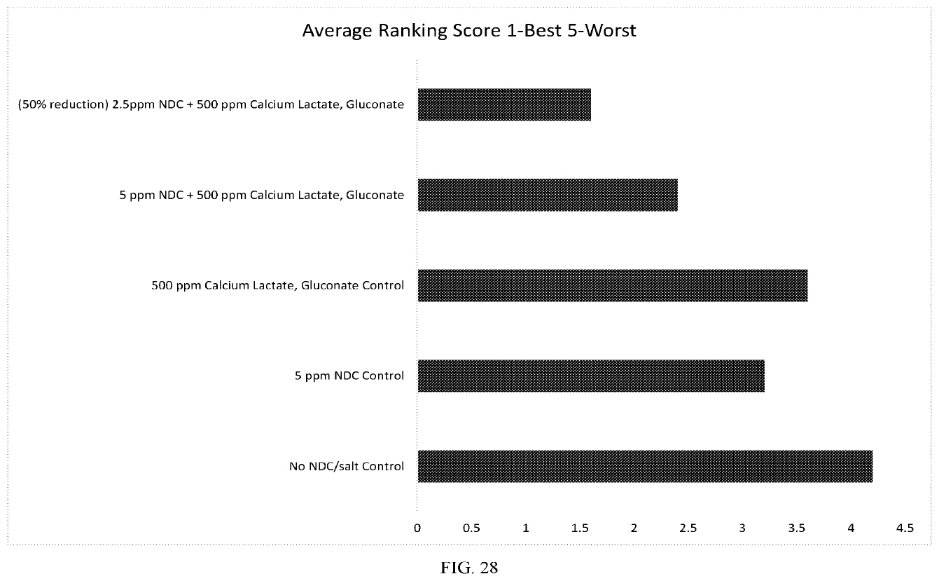

The results are shown in FIG. 28. The beverage containing 2.5 ppm naringin dihydrochalcone and 500 ppm calcium lactate+calcium gluconate was ranked “best” by panelists, followed by the beverage containing 500 ppm calcium lactate+calcium gluconate.

### Example 19: Phloretin and Salts

The effect of the additional taste modifying substance phloretin was evaluated. Zero-calorie, orange-flavored carbonated beverages sweetened with a mixture of Reb M80 (a steviol glycoside mixture comprising 80% rebaudioside M by weight) and RA95 were prepared with the following ingredients and amounts:

TABLE 21

| | | | | Test | Test |
|---|---|---|---|---|---|
| | | | | Sample 3 | Sample 3 |
| | Orange | | Test | 5 ppm | 2.5 ppm |
| | Carbonated | Test | Sample 1 | Phloretin + | Phloretin + |
| | Beverage | Sample | 500 ppm | 500 ppm | 500 ppm |
| | Zero Cal | 2 | Calcium | Calcium | Calcium |
| | Stevia | 5 ppm | Lactate | Lactate | Lactate |
| | Control | Phloretin | Gluconate | Gluconate | Gluconate |
| INGREDIENTS | (g/100 g) | (g/100 g) | (g/100 g) | (g/100 g) | (g/100 g) |
| Water | 99.5 | 99.5 | 99.5 | 99.5 | 99.5 |
| Citric acid S-651 | 0.158 | 0.158 | 0.158 | 0.158 | 0.158 |
| Tri-Sodium Citrate | 0.01 | 0.01 | 0.01 | 0.01 | 0.01 |
| Dihydrate S-826 | | | | | |
| Ascorbic acid S-827 | 0.0074 | 0.0074 | 0.0074 | 0.0074 | 0.0074 |
| Sodium | 0.037 | 0.037 | 0.037 | 0.037 | 0.037 |
| Hexametaphosphate | | | | | |
| SHMP S-8093 | | | | | |
| Calcium disodium | 0.0022 | 0.0022 | 0.0022 | 0.0022 | 0.0022 |
| EDTA S-837 | | | | | |
| Potassium benzoate | 0.0166 | 0.0166 | 0.0166 | 0.0166 | 0.0166 |
| S-813 | | | | | |
| FD&C Yellow #54 | 0.00074 | 0.00074 | 0.00074 | 0.00074 | 0.00074 |
| S-735 | | | | | |
| FD&C Yellow #6 | 0.0033 | 0.0033 | 0.0033 | 0.0033 | 0.0033 |
| S-736 | | | | | |
| fd&c Red No 40 | 0.0002 | 0.0002 | 0.0002 | 0.0002 | 0.0002 |
| S-740 | | | | | |
| Phloretin | 0 | 0.005 | 0 | 0.005 | 0.0025 |
| Calcium Lactate | 0 | 0 | 0.5 | 0.5 | 0.5 |
| Gluconate | | | | | |
| Orange flavor | 0.39 | 0.39 | 0.39 | 0.39 | 0.39 |
| FMP | 0.019 | 0.019 | 0.019 | 0.019 | 0.019 |
| SG95 Stevia Extract | 0.413 | 0.413 | 0.413 | 0.413 | 0.413 |
| RM80 RD8 | | | | | |
| Stevia SG95 RA95 | 0.83 | 0.83 | 0.83 | 0.83 | 0.83 |
| TOTAL | 100 | 100 | 100 | 100 | 100 |

The ingredients were dissolved in filtered water to constitute a syrup, then the final beverage was made by weighing the appropriate syrup amount and adding carbonated water using a ratio of 1-part syrup+4.4 parts carbonated water to target a carbonation of 2.8 volumes of CO2. Final beverages were filled in 300 ml glass bottles then aged for 3 days at 35° C. before they were cooled and served cold (4° C.). The beverages were evaluated blindly by three expert panelists. Panelists were instructed to eat an unsalted cracker and rinse the mouth with water before and in between the samples. For each sample, panelists were instructed to taste, then write down their evaluation comments for ranking for overall best performance on a 5-point scale with 1 as best and 5 as worst and rating for sucrose equivalence 1-Low and 10-High.

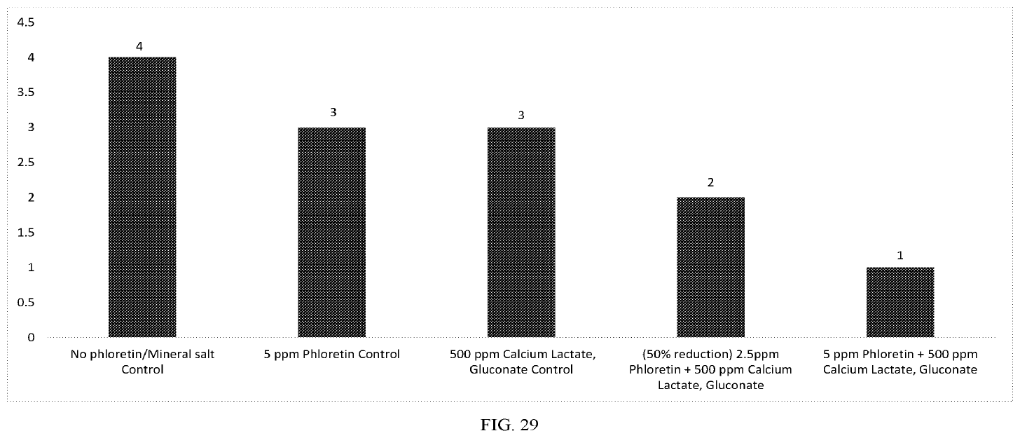

The results are shown in FIG. 29. The beverage containing 5 ppm phloretin and 500 ppm calcium lactate+calcium gluconate was best for overall performance and showed increased sucrose equivalence compared to the 5 ppm phloretin control beverage and the 500 ppm calcium lactate+calcium gluconate control, suggestive of synergism.

### Example 20: Mid-Calorie Zero-Calorie Carbonated Soft Drink

A commercial lemon-lime carbonated soft drink formulation was modified to include one of the following salts or salt mixtures (i) 175 ppm calcium lactate+175 ppm calcium gluconate; (ii) 350 ppm calcium lactate+calcium gluconate; (iii) 70 ppm calcium citrate+203 ppm magnesium lactate; and (iv) 317 ppm magnesium citrate. The beverages were prepared with the ingredients and amounts in the following table:

TABLE 22

| | Control | Test | Test | Test | Test | Test |
|---|---|---|---|---|---|---|
| | Reduced | Reduced | Reduced | Reduced | Reduced | Reduced |
| Ingredients | Sugar | Sugar 1 | Sugar 2 | Sugar 3 | Sugar 4 | Sugar 5 |
| Filtered water | 96.631 | 96.6 | 96.613 | 96.6013 | 96.596 | 96.599 |
| Granulated sugar | 3.1 | 3.1 | 3.1 | 3.1 | 3.1 | 3.1 |
| Citric acid | 0.149 | 0.149 | 0.149 | 0.149 | 0.149 | 0.149 |
| Sodium citrate | 0.027 | 0.027 | 0.027 | 0.027 | 0.027 | 0.027 |
| Sodium benzoate | 0.017 | 0.017 | 0.017 | 0.017 | 0.017 | 0.017 |
| Lemon lime flavor | 0.05 | 0.05 | 0.05 | 0.05 | 0.05 | 0.05 |
| Aspartame | 0.012 | 0.012 | 0.012 | 0.012 | 0.012 | 0.012 |
| Acesulfame | 0.0144 | 0.0144 | 0.0144 | 0.0144 | 0.0144 | 0.0144 |
| potassium (Ace- | | | | | | |
| K) | | | | | | |
| Tri-calcium citrate | — | 0.007 | — | — | — | — |
| tetrahydrate | | | | | | |
| Magnesium | — | 0.0203 | — | — | — | — |
| lactate dihydrate | | | | | | |
| Calcium lactate | — | — | 0.0175 | — | — | — |
| pentahydrate | | | | | | |
| Calcium | — | — | — | 0.0175 | — | — |
| gluconate | | | | | | |
| monohydrate | | | | | | |
| Calcium lactate | | | | | 0.035 | |
| gluconate | | | | | | |
| Tri-magnesium | — | — | — | — | — | 0.0317 |
| citrate | | | | | | |
| | — | — | — | — | — | |
| TOTAL (grams) | 100 | 100 | 100 | 100 | 100 | 100 |

The ingredients were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO2. Final beverages were filled in 300 ml glass bottles then aged for 3 days at 35° C. before they were cooled and served cold (4° C.). Beverage brix was 3.32° and titratable acidity was 0.15% w/v as citric acid.

The beverages were evaluated blindly by 5 panelists. Samples were coded and randomly presented to the panelists. Panelists were instructed to eat an unsalted cracker and rinse the mouth with water before and in between the samples. For each sample, panelists were instructed to take 3 sips, then write down their evaluation comments for ranking for overall liking 1 as high and 4 as low. Panelists liked the sample with (iii) the most, followed by the sample with (ii).

Samples with (i) and (ii) tasted similar.

### Example 22: Organic Acids

### Materials and Methods

Food grade salts with high purity (>95%) were purchased from different ingredient suppliers: tri-calcium citrate tetrahydrate, magnesium lactate dihydrate. In these examples, a combination of tri-calcium citrate tetrahydrate (MW 570.5 g/mol) and magnesium lactate dihydrate (MW 238.48 g/mol) was used in the carbonated beverages at 70 ppm for tri-calcium citrate tetrahydrate and 203 for magnesium lactate dihydrate. Citric acid, malic acid and tartaric acid food grade were used in paired combinations (4:1; 3:2; 2:3; 1:4) to equal total weight of citric acid in the formulation.

### Beverage Production

### Reduced Sugar Lemon Lime Flavored Carbonated Beverage

The ingredients were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO₂. Final beverages were filled in 300 ml glass bottles then aged for 3 days at 35° C. before they were cooled and served cold (4° C.). Beverage brix was 3.31° and titratable acidity was 0.15% w/v as citric acid.

TABLE 23
Reduced Sugar Lemon Lime Flavored Carbonated
Beverage Composition

| | | Reduced |
|---|---|---|
| | Reduced | Sugar |
| Ingredients | Sugar | with Salts |
| Filtered water | 96.63 | 96.6 |
| Granulated sugar | 3.1 | 3.1 |
| Citric acid | 0.149 | 0.149 |
| Sodium citrate | 0.0274 | 0.0274 |
| Sodium benzoate | 0.017 | 0.017 |
| Lemon lime flavor | 0.05 | 0.05 |
| Aspartame | 0.0144 | 0.0144 |
| Acesulfame potassium (Ace-K) | 0.012 | 0.012 |
| Tri-calcium citrate tetrahydrate | — | 0.007 |
| Magnesium lactate dihydrate | — | 0.0232 |
| TOTAL (grams) | 100 | 100 |

pH reduced sugar sample: 3.2
pH reduced sugar sample with salts: 3.4

### Sensory Evaluation

The beverages were evaluated blindly by five expert panelists. Samples were coded and randomly presented to the panelists. Panelists were instructed to eat an unsalted cracker and rinse the mouth with water before and in between samples. The maximum number of samples for each session was set at 6 samples to avoid fatigue. For each sample, panelists were instructed to take 3 sips, then write down their evaluation comments.

### Sensory Results

TABLE 24
Reduced Sugar Lemon Lime Carbonated Beverages - Without Salts

| Different Acid Ratios | Panelists Comments |
|---|---|
| Control | Too sour taste, less flavor, not preferred |
| Citric acid (100%) | |
| 4:1 | Overall sweetness is good, sweeter than |
| Citric acid:Malic acid | control, some sweetness lingering and |
| | off notes. 2^{nd} choice from panelists |
| 3:2 | Overall nice sweetness, some bitterness, |
| Citric acid:Malic acid | smoother mouthfeel. 1^{st} choice |
| | from panelists |
| 2:3 | Nice mouthfeel, different tartness, clean |
| Citric acid:Malic acid | flavor. 3^{rd} choice from panelists |
| 1:4 | Good mouthfeel, tartness is different, |
| Citric acid:Malic acid | but clean sample no off notes, |
| | some bitterness. 4^{th} choice from panelists |

TABLE 25
Reduced Sugar Lemon Lime Carbonated Beverages - With Salts

| Different Acid | | |
|---|---|---|
| Ratios | Salts | Panelists Comments |
| Control | 70 ppm TriCa citrate | Salty taste, flavor is |
| Citric acid | tetrahydrate (0.1 mM | suppressed, not |
| (100%) | 0.7 mOsm.) | preferred by panelists |
| | 203 ppm Mg lactate | |
| | dihydrate (1 mM, | |
| | 3 mOsm.) | |
| 4:1 | 70 ppm TriCa citrate | More mouthfeel, flavor |
| Citric acid:Malic acid | tetrahydrate | is well rounded and |
| | 203 ppm Mg lactate | fresh, no off notes, no |
| | dihydrate | linger. Tastes much |
| | | better compared to |
| | | similar sample without |
| | | salts. 1^{st} choice from |
| | | panelists |
| 4:1 | 70 ppm TriCa citrate | Overall nice sweetness, |
| Citric acid:Tartaric acid | tetrahydrate | some bitterness, smoother |
| | 203 ppm Mg lactate | mouthfeel. Equally |
| | dihydrate | chosen as 1^{st} choice from |
| | | panelists |
| 3:2 | 70 ppm TriCa citrate | Nice overall sweetness, |
| Citric acid:Malic acid | tetrahydrate | no sweetness lingering or |
| | 203 ppm Mg lactate | off-notes. Flavor is |
| | dihydrate | rounded and fresh, clean |
| | | taste. Tastes much better |
| | | compared to similar |
| | | sample without salts. 2^{nd} |
| | | choice from panelists |
| 3:2 | 70 ppm TriCa citrate | No sweetness lingering, |
| Citric acid:Tartaric acid | tetrahydrate | flavor rounded and fresh, |
| | 203 ppm Mg lactate | carbonation is less, clean |
| | dihydrate | flavor, no sweetness |
| | | lingering or aftertaste. |
| | | Equally chosen as 2^{nd} |
| | | choice from panelists |
| 2:3 | 70 ppm TriCa citrate | Flavor changed and it is |
| Citric acid:Malic acid | tetrahydrate | different from control. |
| | 203 ppm Mg lactate | Some bitter notes. It |
| | dihydrate | tastes better than control |
| | | but different flavor, |
| | | leafy green off notes. |
| | | 3^{rd} choice from panelists |
| 1:4 | 70 ppm TriCa citrate | Sticky mouthfeel, some |
| Citric acid:Malic acid | tetrahydrate | bitter notes, tartness |
| | 203 ppm Mg lactate | different, better than |
| | dihydrate | control. 4^{th} choice |
| | | from panelists |

The acid blends provided taste improvement compared to citric acid alone, particularly in the range of 4:1 to 3:2 citric: malic acid or citric: tartaric acid. The taste was further improved once the salts were added and taste improvement followed similar pattern, with preferred range of 4:1 to 3:2 citric: malic acid or citric: tartaric acid.

### Example 23: Stability

### Materials and Methods

Food grade salts with high purity (>95%) were purchased from different ingredient suppliers: tri-calcium citrate tetrahydrate, magnesium lactate dihydrate. A combination of tri-calcium citrate tetrahydrate (MW 570.5 g/mol) and magnesium lactate dihydrate (MW 238.48 g/mol) was used in the carbonated beverages in the range of 80 ppm to 100 ppm for tri-calcium citrate tetrahydrate and 232 ppm to 290 ppm for magnesium lactate dihydrate, which delivered 16.7 to 21.1 ppm Ca²⁺ cation and 23.6 to 29.6 ppm Mg²⁺ cation. Aspartame was food grade.

### Beverage Production

### Diet Lemon Lime Flavored Carbonated Beverage

The ingredients were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO2. Final beverages were filled in 300 ml glass bottles. Beverage brix was 0.3° and titratable acidity was 0.183% w/v as citric acid. Test samples contained salt combinations and the targeted amount was added to syrup water in similar manner to the other ingredients to target a final beverage weight of 100 grams. The table below shows the ingredients list.

TABLE 26
Diet Lemon Lime Carbonated Beverage Composition

| | Control | Test |
|---|---|---|
| | Sample | Sample |
| Ingredients | (grams) | (grams) |
| Filtered water | 99.65 | 99.62 |
| Aspartame | 0.021 | 0.021 |
| Acesulfame Potassium | 0.014 | 0.014 |
| Citric acid | 0.18 | 0.18 |
| Potassium citrate | 0.06 | 0.06 |
| Potassium benzoate | 0.025 | 0.025 |
| Lemon lime flavor | 0.052 | 0.052 |
| Tri-Calcium citrate tetrahydrate | — | 0.008 |
| (80 ppm, 0.16 mM, 0.8 mOsm.) | | |
| Magnesium lactate dihydrate | — | 0.0232 |
| (232 ppm, 1.15 mM, 3.4 mOsm.) | | |
| TOTAL (grams) | 100 | 100 |

pH control sample: 3.3
pH test sample: 3.5

### Stability Study Protocol

The diet lemon-lime beverages were stored under different temperatures (4° C., 20° C., 30° C., and 40° C.) and samples were taken at different time points for analysis: 0, 2 weeks, 4 weeks, 6 weeks, 8 weeks, 10 weeks, and 12 weeks for 4° C. and 20° C. storage, and 0, 3 weeks and 4 weeks for 30° C. and 40° C. storage. All samples were analyzed for residual aspartame by H PLC.

### Results

TABLE 27
Diet Lemon Lime CSD—Aspartame Stability (ppm)

| Temperature/ | Weeks | | | | | | | |
|---|---|---|---|---|---|---|---|---|
| Sample | 0 Week | 2 Week | 3 Week | 4 Week | 6 Week | 8 Week | 10 Week | 12 Week |
| 4° C./Control | 215.181 | 216.314 | — | 217.496 | 219.209 | 219.519 | 223.406 | 216.873 |
| 4° C./Test | 214.239 | 221.773 | — | 223.161 | 219.209 | 223.771 | 205.549 | 215.157 |
| 20° C./Control | 215.181 | 216.466 | — | 212.51 | 203.88 | 201.299 | 197.539 | 184.639 |
| 20° C./Test | 214.239 | 219.921 | — | 220.212 | 213.946 | 208.729 | 204.917 | 198.015 |
| 30° C./Control | 215.181 | 206.682 | 194.605 | 182.571 | — | — | — | — |
| 30° C./Test | 214.239 | 206.635 | 203.957 | 192.453 | — | — | — | — |
| 40° C./Control | 215.181 | — | 175.046 | 162.427 | — | — | — | — |
| 40° C./Test | 214.239 | — | 184.765 | 173.577 | — | — | — | — |

The diet lemon lime carbonated soft drink with the salts (calcium citrate and magnesium lactate) showed improved stability of aspartame over time compared to the control without salts. At 4 weeks storage at 40° C., aspartame loss was about 24.6% in the control sample and about 18.6% in the test sample, while at 30° C., the loss was about 15.8% in the control sample and about 10.2% in the test sample.

### Example 24: Neotame Beverages with C2-C9 Organic Acid Salts

### Diet Lemon Lime Flavored Carbonated Beverage

The ingredients in Table 28 were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO₂. Final beverages were filled in 300 ml glass bottles then aged for 3 days at 35° C. before they were cooled and served cold (4° C.). Beverage brix was 0.33° and titratable acidity was 0.183% w/v as citric acid.

TABLE 28
Diet Lemon Lime Flavored Carbonated Beverage Composition

| | Diet | Diet | Diet | Diet |
|---|---|---|---|---|
| Ingredients | Control | Test 1 | Test 2 | Test 3 |
| Filtered water | 99.67 | 99.641 | 99.637 | 99.633 |
| Citric acid | 0.18 | 0.18 | 0.18 | 0.18 |
| Potassium citrate | 0.06 | 0.06 | 0.06 | 0.06 |
| Potassium benzoate | 0.0253 | 0.0253 | 0.0253 | 0.0253 |
| Lemon lime flavor | 0.052 | 0.052 | 0.052 | 0.052 |
| Acesulfame potassium | 0.014 | 0.014 | 0.014 | 0.014 |
| (Ace-K) | | | | |
| Neotame | 0.0008 | 0.0008 | 0.0008 | 0.0008 |
| Tri-calcium citrate | — | 0.007 | 0.008 | 0.009 |
| tetrahydrate | | | | |
| Magnesium lactate | — | 0.0203 | 0.0232 | 0.0261 |
| dihydrate | | | | |
| TOTAL (grams) | 100 | 100 | 100 | 100 |

pH diet control: 3.3
pH diet test: 3.4-3.6

### Sensory Evaluation

The beverages were evaluated blindly by five expert panelists. Samples were coded and randomly presented to the panelists. Panelists were instructed to eat an unsalted cracker and rinse the mouth with water before and in between samples. For each sample, panelists were instructed to take 3 sips, then write down their evaluation comments. The results are shown in the following table.

TABLE 29
Diet Lemon Lime Carbonated Beverages

| Sample | Panelists Comments |
|---|---|
| Diet Control | Disliked by all panelists. Extremely bitter and |
| | lingering aftertaste. |
| Diet Test 1 | Most preferred by panelists. Sweetness lingering is |
| | significantly reduced, flavor is more balanced. |
| Diet Test 2 | #2 choice by panelists. Some bitter aftertaste, |
| | some sweetness linger. |
| Diet Test 3 | #3 choice by panelists. Slow sweetness onset, |
| | flavor is suppressed |

The salts significantly improved the taste of the test beverages compared to the control beverages control sample without salts. Lower levels of salts were much preferred over higher levels.

### Example 25: Orange Flavored Carbonated Beverages

Food grade salts with high purity (>95%) were acquired from different ingredient suppliers as shown in the table below.

TABLE 30
Maximum Use Level in Beverages and Supplier Information

| | MAX | |
|---|---|---|
| | USE | |
| Ingredients | (ppm) | SUPPLIER |
| Magnesium lactate dihydrate | 600 | Jungbunzlauer; |
| | | Corbion |
| Tri-magnesium citrate anhydrous | 350 | Jungbunzlauer |
| Tri-calcium citrate tetrahydrate | 250 | Jungbunzlauer |
| Calcium lactate gluconate monohydrate | 400 | Jungbunzlauer; |
| | | Corbion |
| Calcium lactate pentahydrate | 300 | Corbion |

### Beverage Production

### Reduced Sugar Orange Flavored Carbonated Beverage

To make the control sample, the ingredients were dissolved in filtered water to constitute a syrup, then the final beverage was made by weighing the appropriate syrup amount and adding carbonated water using a ratio of 1-part syrup+4.4 parts carbonated water to target a carbonation of 3 volumes of CO₂. Final beverages were filled in 300 ml glass bottles then aged for 3 days at 35° C. before they were cooled and served cold (4° C.). Brix was 4.8° while titratable acidity for the beverages was 0.147% w/v expressed as citric acid.

Test samples contained individual salts or salt combinations and the targeted amount was added to syrup water in similar manner to the other ingredients to target a final beverage weight of 100 grams.

TABLE 31
Control Reduced Sugar Orange Flavored
Carbonated Beverage Composition

| | Control |
|---|---|
| | Beverage |
| Ingredients | (grams) |
| Filtered water | 96.41 |
| Granulated sugar | 4.6 |
| Acesulfame potassium | 0.015 |
| Sucralose | 0.007 |
| Citric acid | 0.143 |
| Sodium citrate | 0.009 |
| Potassium citrate | 0.026 |
| Ascorbic acid | 0.01 |
| Sodium benzoate | 0.023 |
| Yellow 6 | 0.005 |
| Red 40 | 0.0003 |
| Orange flavor | 0.29 |
| TOTAL (grams) | 100 |

### Zero-Calorie Orange Flavored Carbonated Beverage

To make the control sample, the ingredients were dissolved in filtered water to constitute a syrup, then the final beverage was made by weighing the appropriate syrup amount and adding carbonated water using a ratio of 1-part syrup+5.5 parts carbonated water to target a carbonation of 3 volumes of CO₂. Final beverages were filled in 300 ml glass bottles then aged for 3 days at 35° C. before they were cooled and served cold (4° C.). Brix was 0.3° while titratable acidity for the beverages was 0.178% w/v expressed as citric acid.

Test samples contained individual salts or salt combinations and the targeted amount was added to syrup water in similar manner to the other ingredients to target a final beverage weight of 100 grams.

TABLE 32
Zero-Calorie Orange Flavored
Carbonated Beverage Composition

| | Control |
|---|---|
| | Beverage |
| Ingredients | (grams) |
| Filtered water | 99.37 |
| Aspartame | 0.0234 |
| Acesulfame potassium | 0.0156 |
| Citric acid | 0.174 |
| Potassium citrate | 0.034 |
| Potassium benzoate | 0.02 |
| Yellow 6 | 0.005 |
| Red 40 | 0.0003 |
| Orange flavor | 0.19 |
| TOTAL (grams) | 100 |

### Sensory Evaluation

The beverages were evaluated blindly by six expert panelists. Samples were coded and randomly presented to the panelists. Panelists were instructed to eat an unsalted cracker and rinse the mouth with water before and in between samples. The maximum samples for each session was set at 6 samples to avoid fatigue. For each sample, panelists were instructed to take 3 sips, then write down their evaluation comments.

### Sensory Results

TABLE 33
Reduced Sugar Orange Flavored Carbonated Beverage

| Beverages with Salts | |
|---|---|
| and ppm levels | Panelists Comments |
| Control (no added salts) | Too harsh, more sweetness |
| | lingering and bitter aftertaste |
| Magnesium lactate | Sweet pleasant orange, slightly |
| dihydrate 580 ppm | harsh, heavy mouthfeel |
| Magnesium lactate | Sweet full candy orange, |
| dihydrate 503 ppm | pleasant taste |
| Tri-magnesium citrate | Preferred level, good orange |
| anhydrous 317 ppm | flavor, no burnt note, good body |
| Calcium lactate gluconate | Smooth, good body, bright |
| monohydrate 351 ppm | fresh orange |
| Tri-calcium citrate | Smoother than control, less harsh |
| tetrahydrate 200 ppm | than control, missing some |
| | fruitiness |
| Tri-calcium citrate | Best sample: good flavor and |
| tetrahydrate 200 ppm | sweetness, clean taste |
| Magnesium lactate | |
| dihydrate 580 ppm | |
| Tri-magnesium citrate | Good flavor and sweetness, |
| anhydrous 317 ppm | more balance and nice |
| Calcium lactate gluconate | flavor release |
| monohydrate 351 ppm | |

TABLE 34
Zero-Calorie Orange Flavored Carbonated Beverage

| Beverages with Salts | |
|---|---|
| and ppm levels | Panelists Comments |
| Control (no | Good flavor, bitter note at |
| added salts) | end, less clean taste |
| Magnesium | Very sweet, more orange flavor, |
| lactate dihydrate | much sweeter than control, cleaner |
| 290 ppm | than control, fresher, less bitter than |
| Tri-calcium | control, crisper, better than control |
| citrate tetrahydrate | |
| 100 ppm | |
| Calcium lactate | Best sample: very good, sweeter |
| gluconate | than Control, better than control, |
| monohydrate | less linger, more orange notes, |
| 351 ppm | balanced, smoother than control, |
| | more juicy notes |

Sensory test results for both the reduced sugar and zero-calorie beverages showed that the salts improved the taste and flavor profile of control samples with no salts.

### Example 26: Lemon Lime Flavored Carbonated Soft Drinks

The same food grade salts as used in Example 25 were used in this Example. The ingredients were dissolved in filtered water to constitute a syrup, then the final beverage was made by weighing the appropriate syrup amount and adding carbonated water using a ratio of 1-part syrup+5.5 parts carbonated water to target a carbonation of 3.8 volumes of CO₂. Final beverages were filled in 300 ml glass bottles then aged for 3 days at 35° C. before they were cooled and served cold (4° C.). Beverage brix was 4.73° and titratable acidity was 0.117% w/v as citric acid.

Test samples contained salt combinations and the targeted amount was added to syrup water in similar manner to the other ingredients to target a final beverage weight of 100 grams.

The table below shows the ingredients list with the flavor compounds ppm levels.

TABLE 35
Reduced and Full Sugar Lemon Lime Flavored Carbonated
Beverage Composition

| | Full Sugar | Reduced |
|---|---|---|
| | Control | Sugar (Test |
| Ingredients | (grams) | Sample 3) |
| Filtered water | 89.8 | 95.15 |
| Granulated sugar | 10 | 4.6 |
| Citric acid | 0.117 | 0.117 |
| Sodium citrate | 0.027 | 0.027 |
| Sodium benzoate | 0.018 | 0.018 |
| Lemon lime flavor | 0.043 | 0.043 |
| Rebaudioside-M | — | 0.0145 |
| Tri-calcium citrate tetrahydrate | — | 0.008 |
| Magnesium lactate dihydrate | — | 0.0232 |
| TOTAL (grams) | 100 | 100 |

Zero-Calorie Lemon Lime Flavored Carbonated Beverage with Artificial Sweeteners

The ingredients were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO₂. Final beverages were filled in 300 ml glass bottles then aged for 3 days at 35° C. before they were cooled and served cold (4° C.). Beverage brix was 0.3° and titratable acidity was 0.183% w/v as citric acid.

Test samples contained individual salts or salt combinations and the targeted amount was added to syrup water in similar manner to the other ingredients to target a final beverage weight of 100 grams.

The table below shows the ingredients list with the flavor compounds ppm levels as pure compounds.

TABLE 36
Zero-Calorie Lemon Lime Flavored
Carbonated Beverage Composition

| Ingredients | (grams) |
|---|---|
| Filtered water | 99.65 |
| Aspartame | 0.021 |
| Acesulfame Potassium | 0.014 |
| Citric acid | 0.18 |
| Potassium citrate | 0.06 |
| Potassium benzoate | 0.025 |
| Lemon lime flavor | 0.052 |
| TOTAL (grams) | 100 |

Zero-Calorie Lemon Lime Flavored Carbonated Beverage with Rebaudioside M

The ingredients were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO₂. Final beverages were filled in 300 ml glass bottles then aged for 3 days at 35° C. before they were cooled and served cold (4° C.). Beverage brix was 0.3° and titratable acidity was 0.183% w/v as citric acid.

Test samples contained individual salts or salt combinations and the targeted amount was added to syrup water in similar manner to the other ingredients to target a final beverage weight of 100 grams.

The table below shows the ingredients list with the flavor compounds ppm levels as pure compounds.

TABLE 37
Zero-Calorie Lemon Lime Flavored
Carbonated Beverage Composition

| Ingredients | (grams) |
|---|---|
| Filtered water | 99.63 |
| Rebaudioside-M | 0.0472 |
| Citric acid | 0.18 |
| Potassium citrate | 0.06 |
| Potassium benzoate | 0.025 |
| Lemon lime flavor | 0.052 |
| TOTAL (grams) | 100 |

### Sensory Evaluation

The beverages were evaluated blindly by six expert panelists. Samples were coded and randomly presented to the panelists. Panelists were instructed to eat an unsalted cracker and rinse the mouth with water before and in between samples. The maximum samples for each session was set at 6 samples to avoid fatigue. For each sample, panelists were instructed to take 3 sips, then write down their evaluation comments.

### Sensory Results

TABLE 38
Reduced Sugar Lemon Lime Carbonated Beverages

| Beverages with Salts and ppm levels | Panelists Comments |
|---|---|
| Control full sugar | Pleasant sweetness and flavor balance, thick mouthfeel |
| Test sample 1 with: | No off-notes, nice mouthfeel, nice flavor balance, |
| Tri-calcium citrate tetrahydrate 100 ppm | liked by many panelists, no bitterness aftertaste |
| Magnesium lactate dihydrate 290 ppm | |
| Test sample 2 with: | Equally best sample: good flavor and |
| Tri-calcium citrate tetrahydrate 90 ppm | sweetness balance, no off-notes, no bitterness |
| Magnesium lactate dihydrate 261 ppm | aftertaste, preferred over full sugar control |
| Test sample 3 with: | Equally best sample: nice flavor balance, good |
| Tri-calcium citrate tetrahydrate 80 ppm | mouthfeel, preferred over full sugar control, no |
| Magnesium lactate dihydrate 232 ppm | bitterness aftertaste |
| Test sample 4 with: | Smooth, good body, bright fresh lemon flavor, no |
| Tri-calcium citrate tetrahydrate 70 ppm | bitter aftertaste |
| Magnesium lactate dihydrate 203 ppm | |
| Test sample 5 with: | Sharp flavor, no bitterness and sweetness lingering |
| Calcium lactate gluconate monohydrate | associated with stevia |
| 351 ppm | |
| Test sample 6 with: | Good flavor, no sweetness lingering, no bitterness |
| Calcium lactate pentahydrate 200 ppm | aftertaste, balanced |
| Test sample 7 with: | Good flavor, strong flavor, fresh flavor, no bitterness |
| Calcium lactate pentahydrate 250 ppm | or sweet lingering |
| Test sample 8 with: | Flavor was close to control, bitterness was reduced |
| Calcium lactate pentahydrate 300 ppm | |
| Test sample 9 with: | Overall sweetness is good, no sweetness lingering |
| Tri-magnesium citrate anhydrous 200 ppm | or bitterness aftertaste |

TABLE 39
Zero-Calorie Lemon Lime Carbonated Beverages with Artificial Sweetener

| Beverages with Salts and ppm levels | Panelists Comments |
|---|---|
| Control (no added salts) | Artificial sweetness off-notes, too sweet |
| Magnesium lactate dihydrate 580 ppm | More balanced flavors than control |
| Tri-calcium citrate tetrahydrate 200 ppm | More balanced flavors than control, more body |
| Tri-calcium citrate tetrahydrate 100 ppm | Better flavors than control |
| Magnesium lactate dihydrate 290 ppm | |
| Tri-calcium citrate tetrahydrate 80 ppm | Equally Best Sample: more balanced flavor, |
| Magnesium lactate dihydrate 232 ppm | better taste than control, more mouthfeel, no |
| | bitter aftertaste |
| Calcium lactate gluconate monohydrate | Equally Best Sample: slight tart, most balanced, |
| 351 ppm | better than control, no bitterness, no sweetness |
| | lingering |
| Tri-magnesium citrate anhydrous 317 ppm | Nice flavor balance, slight sweeter than control. |
| Calcium lactate gluconate monohydrate | |
| 351 ppm | |

TABLE 40
Zero-Calorie Lemon Lime Carbonated Beverages with Rebaudioside M

| Beverages with Salts and ppm levels | Panelists Comments |
|---|---|
| Control (no added salts) | More sweetness lingering, some bitterness |
| | aftertaste |
| Tri-calcium citrate tetrahydrate 80 ppm | Good flavor balance, no sweetness lingering |
| Magnesium lactate dihydrate 232 ppm | and bitterness aftertaste |
| Tri-magnesium citrate anhydrous 160 ppm | Flavor and overall sweetness is good |
| Calcium lactate gluconate monohydrate | |
| 176 ppm | |
| Calcium lactate gluconate monohydrate | Much less sour than control, nice flavor and |
| 351 ppm | sweetness balance |
| Tri-magnesium citrate anhydrous | Best Sample: much cleaner than control, more |
| 317 ppm | balanced flavor, no aftertaste |

The above sensory test results showed that the salts improved the taste and flavor profile of test samples compared to control sample without salts.

### Example 27: Zero-Calorie Lemon Lime Flavored Carbonated Beverages

Commercial sweeteners (sucralose, rebaudioside-A ≥295% purity and ≥99% purity) were used. Food grade salts with high purity (>95%) were purchased from different ingredient suppliers as shown in the table below.

TABLE 41
Compounds Used and Maximum
Levels in Beverages

| | MAX |
|---|---|
| | USE |
| Ingredients | (ppm) |
| Tri-calcium citrate tetrahydrate | 70 |
| Calcium lactate pentahydrate | 203 |
| Magnesium lactate dihydrate | 203 |

### Beverage Production

The ingredients were dissolved in filtered water to constitute a syrup, then the final beverage was made by weighing the appropriate syrup amount and adding carbonated water using a ratio of 1-part syrup+5.4 parts carbonated water to target a carbonation of 3.8 volumes of CO₂. Final beverages were filled in 300 ml glass bottles then aged for 3 days at 35° C. before they were cooled and served cold (4° C.). Beverage brix was 0.230 and titratable acidity was 0.156% w/v as citric acid.

Test samples contained individual salts or salt combinations and the targeted amount was added to syrup water in similar manner to the other ingredients to target a final beverage weight of 100 grams. The table below shows the ingredients list.

TABLE 42
Diet Lemon Lime Flavored Carbonated Beverage Composition

| | Control | Control | Sample | Sample | Sample | Sample | Sample |
|---|---|---|---|---|---|---|---|
| | 1 | 2 | 1 | 2 | 3 | 4 | 5 |
| Ingredients | (grams) | (grams) | (grams) | (grams) | (grams) | (grams) | (grams) |
| Filtered water | 99.74 | 99.74 | 99.72 | 99.73 | 99.73 | 99.72 | 99.72 |
| Sodium benzoate | 0.017 | 0.017 | 0.017 | 0.017 | 0.017 | 0.017 | 0.017 |
| Citric acid | 0.156 | 0.156 | 0.156 | 0.156 | 0.156 | 0.156 | 0.156 |
| Sodium citrate | 0.0125 | 0.0125 | 0.0125 | 0.0125 | 0.0125 | 0.0125 | 0.0125 |
| Sucralose | 0.0136 | 0.0136 | 0.0136 | 0.0136 | 0.0136 | 0.0136 | 0.0136 |
| Rebaudioside-A | 0.005 | — | — | — | 0.005 | — | — |
| 95% | | | | | | | |
| Rebaudioside-A | — | 0.005 | 0.005 | 0.005 | — | 0.005 | 0.005 |
| 99% | | | | | | | |
| Lemon lime flavor | 0.0525 | 0.0525 | 0.0525 | 0.0525 | 0.0525 | 0.0525 | 0.0525 |
| Tri-calcium citrate | — | — | 0.007 | 0.007 | 0.007 | 0.007 | 0.007 |
| tetrahydrate | | | | | | | |
| Calcium lactate | — | — | — | 0.007 | 0.007 | 0.015 | 0.0203 |
| pentahydrate | | | | | | | |
| Magnesium lactate | — | — | 0.0203 | — | — | — | — |
| dihydrate | | | | | | | |
| TOTAL (grams) | 100 | 100 | 100 | 100 | 100 | 100 | 100 |

### Sensory Evaluation

The beverages were evaluated blindly by six expert panelists. Samples were coded and randomly presented to the panelists. Panelists were instructed to eat an unsalted cracker and rinse the mouth with water before and in between samples. The maximum samples for each session was set at 6 samples to avoid fatigue. For each sample, panelists were instructed to take 3 sips, then write down their evaluation comments.

### Sensory Results

TABLE 43
Diet Lemon Lime Carbonated Beverages

| Beverages with Salts and | |
|---|---|
| ppm levels | Panelists Comments |
| Control 1 | More sweetness lingering, more bitter and licorice |
| (no added mineral salts) | aftertaste |
| Control 2 (no added | Sweeter compared to control 1, cleaner flavor, some |
| mineral salts) | sweet lingering aftertaste |
| Sample 1 | 5^{th} preferred sample, clean flavor, slightly acidic, slightly |
| | salty aftertaste |
| Sample 2 | 1^{st} preference, very refreshing, brighter lemon lime flavor |
| | and good mouthfeel |
| Sample 3 | 2^{nd} preference, very refreshing, nice and balanced lemon |
| | lime flavor |
| Sample 4 | 3^{rd} preferred sample, refreshing, bright flavor |
| Sample 5 | 4^{th} preferred sample, nice flavor, good mouthfeel |

1. A diet, lemon lime-flavored carbonated beverage comprising: at least one high potency sweetener and at least one salt having a cation selected from Ca²⁺ and Mg²⁺.

2. The beverage of claim 1, wherein the beverage is a reduced-calorie, lemon lime-flavored carbonated beverage comprising:
(i) at least one caloric sweetener,
(ii) the at least one high potency sweetener, and
(iii) the at least one salt having a cation selected from Ca²⁺ and Mg²⁺.

3. The beverage of claim 1, wherein the at least one salt is selected from magnesium lactate, magnesium citrate, calcium citrate, calcium lactate, calcium gluconate, calcium lactate gluconate, anhydrous and/or hydrate forms thereof, and combinations thereof.

4. The beverage of claim 2, wherein the at least one salt is calcium lactate gluconate or an anhydrous or hydrate form thereof.

5. The beverage of claim 2, wherein the at least one salt comprises:
(i) calcium citrate or an anhydrous or hydrate form thereof, and
(ii) magnesium lactate or an anhydrous or hydrate form thereof.

6. The beverage of claim 2, wherein the at least one caloric sweetener is sugar and the at least one high potency sweetener is sucralose.

7. The beverage of claim 2, wherein the at least one caloric sweetener is sugar and the at least one high potency sweetener is rebaudioside M.

8. The beverage of claim 2, wherein the at least one caloric sweetener is sugar and the at least one high potency sweetener comprises mogroside V, siamenoside I or a combination thereof.

9. The beverage of claim 2, wherein:
(i) the at least one caloric sweetener is sugar,
(ii) the at least one high potency sweetener is selected from acesulfame K, aspartame, saccharin, cyclamate, sucralose, neotame, advantame and a combination thereof, and
(iii) the at least one salt having a cation selected from Ca²⁺ and Mg²⁺ has an anion selected from lactate, citrate, gluconate, lactate gluconate, anhydrous and/or hydrate forms thereof, and combinations thereof.

10. The beverage of claim 2, wherein the beverage is a zero-calorie, lemon lime-flavored carbonated beverage comprising:
(i) the at least one high potency sweetener, and
(ii) the at least one salt having a cation selected from Ca²⁺ and Mg²⁺.

11. The beverage of claim 10, wherein:
(i) the at least one high potency sweetener is selected from acesulfame K, aspartame and a combination thereof, and
(ii) the at least one salt having a cation selected from Ca²⁺ and Mg²⁺ has an anion selected from lactate, citrate, gluconate, lactate gluconate, anhydrous and/or hydrate forms thereof, and combinations thereof.

12. The beverage of claim 10, wherein (ii) comprises a mixture of calcium lactate or an anhydrous or hydrate form thereof and calcium gluconate or an anhydrous or hydrate form thereof.

13. The beverage of claim 10, wherein (ii) comprises calcium lactate or an anhydrous or hydrate form thereof.

14. The beverage of claim 1, wherein the at least one salt having a cation is selected from Ca²⁺ and Mg²⁺ comprises at least one C2-C9 organic acid salt and at least one anion of the C2-C9 organic acid salt.

15. The beverage of claim 14, wherein the C2-C9 organic acid salt is a salt of a monocarboxylic acid or an alpha hydroxy acid.
